(19) United States
(12) Patent Application Publication
(10) Pub. No.: US 2026/0311376 A1
(43) Pub. Date: Oct. 8, 2026

(54) ENCODING DEVICE, DECODING DEVICE, ENCODING METHOD, AND DECODING METHOD

(71) Applicant: Panasonic Intellectual Property Corporation of America, Torrance, CA (US)

(72) Inventors: Takahiro NISHI, Nara (JP); Toshiyasu SUGIO, Osaka (JP); Noritaka IGUCHI, Osaka (JP); Atsushi ITO, Osaka (JP)

(21) Appl. No.: 19/697,785

(22) Filed: Jun. 4, 2026

Related U.S. Application Data
(63) Continuation of application No. PCT/JP2024/044633, filed on Dec. 17, 2024.
(60) Provisional application No. 63/614,726, filed on Dec. 26, 2023.
(60) Provisional application No. 63/624,462, filed on Jan. 24, 2024.

(51) Int. Cl. G06T 9/00

(52) U.S. Cl. CPC G06T 9/001

(57) ABSTRACT

An encoding device includes memory and a circuit having access to the memory. In operation, the circuit: for each of faces forming a three-dimensional mesh, encodes a connection type regarding a connection relationship between the face to be processed and a face not yet processed, in reverse order of processing order in which the connection type is defined; and encodes relevant information for detecting a border of a connected component in a plurality of connection types each of which is encoded as the connection type in the reverse order. The connected component corresponds to at least a portion of the three-dimensional mesh.

### CROSS REFERENCE TO RELATED APPLICATIONS

This is a continuation application of PCT International Application No. PCT/JP2024/044633 filed on Dec. 17, 2024, designating the United States of America, which is based on and claims priority of U.S. Provisional Patent Application No. 63/614,726 filed on Dec. 26, 2023 and U.S. Provisional Patent Application No. 63/624,462 filed on Jan. 24, 2024. The entire disclosures of the above-identified applications, including the specifications, drawings and claims are incorporated herein by reference in their entirety.

### FIELD

The present disclosure relates to, for example, an encoding device.

### BACKGROUND

PTL 1 proposes a method and a device for encoding and decoding three-dimensional mesh data. Moreover, NPL1 discloses a technique related to encoding and decoding three-dimensional mesh data.

### CITATION LIST

### Patent Literature

PTL 1: Japanese Unexamined Patent Application Publication No. 2006-187015

### Non Patent Literature

NPL 1: Jarek Rossignac et al., “3D Compression Made Simple: Edgebreaker on a Corner-Table”, [online], [searched on Jan. 27, 2024],
<URL: https://www.cs.cmu.edu/~alla/edgebreaker_simple.pdf>

### SUMMARY

### Technical Problem

There are demands for further improvement in processing of encoding three-dimensional data and the like. The present disclosure improves processing of encoding three-dimensional data and the like.

### Solution to Problem

An encoding device according to one aspect of the present disclosure includes memory and a circuit having access to the memory. I In operation, the circuit: for each of faces forming a three-dimensional mesh, encodes a connection type regarding a connection relationship between the face to be processed and a face not yet processed, in reverse order of processing order in which the connection type is defined; and encodes relevant information for detecting a border of a connected component in a plurality of connection types each of which is encoded as the connection type in the reverse order. The connected component corresponds to at least a portion of the three-dimensional mesh.

Noted that these general or specific aspects may be implemented using a system, a device, a method, an integrated circuit, a computer program, or a non-transitory computer-readable recording medium such as a CD-ROM, or any combination of systems, devices, methods, integrated circuits, computer programs, and recording media.

### Advantageous Effects

The present disclosure can contribute toward improving processing of encoding three-dimensional data and the like.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a conceptual diagram illustrating a three-dimensional mesh according to an embodiment.

FIG. 2 is a conceptual diagram illustrating basic elements of the three-dimensional mesh according to the embodiment.

FIG. 3 is a conceptual diagram illustrating mapping according to the embodiment.

FIG. 4 is a block diagram illustrating a configuration example of an encoding/decoding system according to the embodiment.

FIG. 5 is a block diagram illustrating a configuration example of an encoding device according to the embodiment.

FIG. 6 is a block diagram illustrating another configuration example of the encoding device according to the embodiment.

FIG. 7 is a block diagram illustrating a configuration example of a decoding device according to the embodiment.

FIG. 8 is a block diagram illustrating another configuration example of the decoding device according to the embodiment.

FIG. 9 is a conceptual diagram illustrating a configuration example of a bitstream according to the embodiment.

FIG. 10 is a conceptual diagram illustrating another configuration example of the bitstream according to the embodiment.

FIG. 11 is a conceptual diagram illustrating yet another configuration example of the bitstream according to the embodiment.

FIG. 12 is a block diagram illustrating a specific example of the encoding/decoding system according to the embodiment.

FIG. 13 is a conceptual diagram illustrating a configuration example of point cloud data according to the embodiment.

FIG. 14 is a conceptual diagram illustrating a data file example of the point cloud data according to the embodiment.

FIG. 15 is a conceptual diagram illustrating a configuration example of mesh data according to the embodiment.

FIG. 16 is a conceptual diagram illustrating a data file example of the mesh data according to the embodiment.

FIG. 17 is a conceptual diagram illustrating a type of three-dimensional data according to the embodiment.

FIG. 18 is a block diagram illustrating a configuration example of a three-dimensional data encoder according to the embodiment.

FIG. 19 is a block diagram illustrating a configuration example of a three-dimensional data decoder according to the embodiment.

FIG. 20 is a block diagram illustrating another configuration example of the three-dimensional data encoder according to the embodiment.

FIG. 21 is a block diagram illustrating another configuration example of the three-dimensional data decoder according to the embodiment.

FIG. 22 is a conceptual diagram illustrating a specific example of encoding processing according to the embodiment.

FIG. 23 is a conceptual diagram illustrating a specific example of decoding processing according to the embodiment.

FIG. 24 is a block diagram illustrating an implementation example of the encoding device according to the embodiment.

FIG. 25 is a block diagram illustrating an implementation example of the decoding device according to the embodiment.

FIG. 26 is a block diagram illustrating another configuration example of the encoding/decoding system according to the embodiment.

FIG. 27 is a block diagram illustrating yet another configuration example of the encoding device according to the embodiment.

FIG. 28 is a block diagram illustrating yet another configuration example of the decoding device according to the embodiment.

FIG. 29 is a conceptual diagram illustrating five connection types according to the embodiment.

FIG. 30 is a conceptual diagram illustrating an example of connection types sequentially determined according to the embodiment.

FIG. 31 is a flowchart illustrating encoding processing and decoding processing for a connection type according to the embodiment.

FIG. 32 is a flowchart illustrating a first specific example of the encoding of the connection type according to the embodiment.

FIG. 33 is a flowchart illustrating a first specific example of the decoding of the connection type according to the embodiment.

FIG. 34 is a flowchart illustrating a second specific example of the encoding of the connection type according to the embodiment.

FIG. 35 is a flowchart illustrating a second specific example of the decoding of the connection type according to the embodiment.

FIG. 36 is a flowchart illustrating another example of encoding processing and decoding processing for a connection type according to the embodiment.

FIG. 37 is a relationship diagram illustrating an example of a correspondence between an immediately previous connection type and values used to determine a context according to the embodiment.

FIG. 38 is a relationship diagram illustrating an example of a correspondence between a second previous connection type and values used to determine a context according to the embodiment.

FIG. 39 is a flowchart illustrating a third specific example of encoding of the connection type according to the embodiment.

FIG. 40 is a flowchart illustrating a third specific example of decoding of the connection type according to the embodiment.

FIG. 41 is a flowchart illustrating a fourth specific example of encoding of the connection type according to the embodiment.

FIG. 42 is a flowchart illustrating a fourth specific example of decoding of the connection type according to the embodiment.

FIG. 43 is a relationship diagram illustrating another example of the correspondence between a second previous connection type and values used to determine a context according to the embodiment.

FIG. 44 is a flowchart illustrating yet another example of encoding processing and decoding processing for a connection type according to the embodiment.

FIG. 45 is a relationship diagram illustrating an example of a correspondence between at least one of a second previous connection type or the run count of type C and values used to determine a context according to the embodiment.

FIG. 46 is a flowchart illustrating a fifth specific example of encoding of the connection type according to the embodiment.

FIG. 47 is a flowchart illustrating a fifth specific example of decoding of the connection type according to the embodiment.

FIG. 48 is a conceptual diagram illustrating an example of changes in stack occupancy according to the embodiment.

FIG. 49 is a syntax diagram illustrating a first syntax example of a symbol string including connected components according to the embodiment.

FIG. 50 is a flowchart illustrating a first decoding example of a symbol string including connected components according to the embodiment.

FIG. 51 is a flowchart illustrating a process of restoring a mesh structure in accordance with a symbol according to the embodiment.

FIG. 52 is a conceptual diagram illustrating a process of restoring a mesh structure in accordance with a symbol of type C according to the embodiment.

FIG. 53 is a conceptual diagram illustrating a process of restoring a mesh structure in accordance with a symbol of type L according to the embodiment.

FIG. 54 is a conceptual diagram illustrating a process of restoring a mesh structure in accordance with a symbol of type S according to the embodiment.

FIG. 55 is a conceptual diagram illustrating a process of restoring a mesh structure in accordance with a symbol of type R according to the embodiment.

FIG. 56 is a conceptual diagram illustrating a process of restoring a mesh structure in accordance with a symbol of type E according to the embodiment.

FIG. 57 is a syntax diagram illustrating a second syntax example of a symbol string including connected components according to the embodiment.

FIG. 58 is a flowchart illustrating a second decoding example of a symbol string including connected components according to the embodiment.

FIG. 59 is a flowchart illustrating a sixth specific example of encoding of the connection type according to the embodiment.

FIG. 60 is a flowchart illustrating a sixth specific example of decoding of the connection type according to the embodiment.

FIG. 61 is a flowchart illustrating an example of basic encoding processing according to the embodiment.

FIG. 62 is a flowchart illustrating an example of basic decoding processing according to the embodiment.

### DESCRIPTION OF EMBODIMENT

### Introduction

A three-dimensional (3D) mesh is used for a computer graphics video, for example. For example, the computer graphics video is formed by a plurality of frames that temporally differs from each other, and each frame may be represented by a three-dimensional mesh.

In addition, the three-dimensional mesh is formed by vertex information that indicates a position of each of a plurality of vertexes (vertices) in a three-dimensional space, connection information that indicates a connection relationship between the plurality of vertexes, and attribute information that indicates an attribute of each vertex or each face. Each face is constructed according to a connection relationship between a plurality of vertexes. Such a three-dimensional mesh can represent various computer graphics videos.

Furthermore, for transmission and storage of a three-dimensional mesh, a three-dimensional mesh is encoded. In encoding a three-dimensional mesh, for each of faces forming the three-dimensional mesh, a connection type regarding a connection relationship between the face to be processed and a face not yet processed may be encoded. A connection type of each face is effective as information for expressing a relationship with another face and is also effective as information for sequentially processing a plurality of faces.

However, a three-dimensional mesh may be divided into a plurality of connected components. In such a case, when it is not possible to appropriately detect the border of a connected component in a plurality of connection types of a plurality of faces in the three-dimensional mesh, it may be difficult to efficiently identify a connection relationship among the plurality of faces. Additionally, when it is not possible to efficiently identify the connection relationship among the plurality of faces, processing delay may increase.

In view of this, an encoding device according to Example 1 includes memory and a circuit having access to the memory. In operation, the circuit: for each of faces forming a three-dimensional mesh, encodes a connection type regarding a connection relationship between the face to be processed and a face not yet processed, in reverse order of processing order in which the connection type is defined; and encodes relevant information for detecting a border of a connected component in a plurality of connection types each of which is encoded as the connection type in the reverse order. The connected component corresponds to at least a portion of the three-dimensional mesh.

As a result, it may be possible to appropriately detect the border of the connected component in the plurality of connection types encoded in the reverse order. Accordingly, it may be possible to efficiently identify the connected component and the connection relationship among the plurality of faces. In consequence, it may be possible to reduce processing delay in reconstructing the three-dimensional mesh.

Note that a plurality of exemplary connection types regarding the connection relationship between the face to be processed and a face not yet processed may include a type in which the face to be processed is not connected to any face not yet processed (type E described later, for example).

Moreover, an encoding device according to Example 2 is the encoding device according to Example 1, and the relevant information may indicate whether a current connection type corresponds to an end of the connected component in the processing order, the current connection type being the connection type to be encoded.

As a result, it may be possible to appropriately detect the connection type corresponding to the end of the connected component in the plurality of connection types encoded in the reverse order. Accordingly, it may be possible to efficiently identify the connected component and the connection relationship among the plurality of faces.

Furthermore, an encoding device according to Example 3 is the encoding device according to Example 2, and the circuit may: determine whether a condition that the current connection type is capable of corresponding to the end is satisfied; and encode the relevant information when the condition is determined to be satisfied.

As a result, when the current connection type is not capable of corresponding to the end of the connected component, it may be possible to omit the encoding of the relevant information. Accordingly, it may be possible to suppress the increase in coding amount.

Moreover, an encoding device according to Example 4 is the encoding device according to Example 3, the condition may include a condition that the current connection type is an end type, and the end type may be a type in which, along a path to the face to be processed in the processing order, a face not yet processed is connected to neither a left side nor a right side of the face to be processed.

As a result, when the current connection type is not the end type, it may be possible to omit the encoding of the relevant information. Accordingly, it may be possible to suppress the increase in coding amount.

Furthermore, an encoding device according to Example 5 is the encoding device according to Example 3 or 4, and the condition may include a condition that a stack on which push or pop is performed according to the connection type is empty.

As a result, when the stack is not empty, it may be possible to omit the encoding of the relevant information. Accordingly, it may be possible to suppress the increase in coding amount.

Moreover, an encoding device according to Example 6 is the encoding device according to any one of Examples 3 to 5, and the condition may include a condition that the connection type of a face at an end of at least one connected component is not encoded, the at least one connected component being included in one or more connected components each of which is defined as the connected component.

As a result, when the connection type of the face at the end is already encoded for each of the connected components, it may be possible to omit the encoding of the relevant information. Accordingly, it may be possible to suppress the increase in coding amount.

Furthermore, an encoding device according to Example 7 is the encoding device according to Example 1, and the relevant information may indicate a total number of connection types that is a total number of one or more connection types each of which is encoded for a corresponding one of one or more connected components each of which is defined as the connected component.

As a result, it may be possible to efficiently identify each connected component according to the number of connection types, and identify the connection relationship among the plurality of faces. In consequence, it may be possible to reduce processing delay in reconstructing the three-dimensional mesh.

Moreover, an encoding device according to Example 8 is the encoding device according to Example 7, and the border may be indicated according to the total number of the connection types indicated by the relevant information, and a total number of one or more connection types encoded.

As a result, it may be possible to appropriately indicate the border of the connected component in the plurality of connection types encoded in the reverse order, according to a relationship between the number of the connection types indicated by the relevant information and the number of the one or more connection types encoded. Accordingly, it may be possible to efficiently identify each connected component and the connection relationship among the plurality of faces.

A decoding device according to Example 9 includes memory and a circuit having access to the memory. In operation, the circuit: for each of faces forming a three-dimensional mesh, decodes a connection type regarding a connection relationship between the face to be processed and a face not yet processed, in reverse order of processing order in which the connection type is defined; and decodes relevant information for detecting a border of a connected component in a plurality of connection types each of which is decoded as the connection type in the reverse order. The connected component corresponds to at least a portion of the three-dimensional mesh.

As a result, it may be possible to appropriately detect the border of the connected component in the plurality of connection types decoded in the reverse order. Accordingly, it may be possible to efficiently identify the connected component and the connection relationship among the plurality of faces. In consequence, it may be possible to reduce processing delay in reconstructing the three-dimensional mesh.

Note that a plurality of exemplary connection types regarding the connection relationship between the face to be processed and a face not yet processed may include a type in which the face to be processed is not connected to any face not yet processed (type E described later, for example).

Moreover, a decoding device according to Example 10 is the decoding device according to Example 9, and the relevant information may indicate whether a current connection type corresponds to an end of the connected component in the processing order, the current connection type being the connection type to be decoded.

As a result, it may be possible to appropriately detect the connection type corresponding to the end of the connected component in the plurality of connection types decoded in the reverse order. Accordingly, it may be possible to efficiently identify the connected component and the connection relationship among the plurality of faces.

Furthermore, a decoding device according to Example 11 is the decoding device according to Example 10, and the circuit may: determine whether a condition that the current connection type is capable of corresponding to the end is satisfied; and decode the relevant information when the condition is determined to be satisfied.

As a result, when the current connection type is not capable of corresponding to the end of the connected component, it may be possible to omit the decoding of the relevant information. Accordingly, it may be possible to suppress the increase in coding amount.

Moreover, a decoding device according to Example 12 is the decoding device according to Example 11, the condition may include a condition that the current connection type is an end type, and the end type may be a type in which, along a path to the face to be processed in the processing order, a face not yet processed is connected to neither a left side nor a right side of the face to be processed.

As a result, when the current connection type is not the end type, it may be possible to omit the decoding of the relevant information. Accordingly, it may be possible to suppress the increase in coding amount.

Furthermore, a decoding device according to Example 13 is the decoding device according to Example 11 or 12, and the condition may include a condition that a stack on which push or pop is performed according to the connection type is empty.

As a result, when the stack is not empty, it may be possible to omit the decoding of the relevant information. Accordingly, it may be possible to suppress the increase in coding amount.

Moreover, a decoding device according to Example 14 is the decoding device according to any one of Examples 11 to 13, and the condition may include a condition that the connection type of a face at an end of at least one connected component is not decoded, the at least one connected component being included in one or more connected components each of which is defined as the connected component.

As a result, when the connection type of the face at the end is already decoded for each of the connected components, it may be possible to omit the decoding of the relevant information. Accordingly, it may be possible to suppress the increase in coding amount.

Furthermore, a decoding device according to Example 15 is the decoding device according to Example 9, and the relevant information may indicate a total number of connection types that is a total number of one or more connection types each of which is decoded for a corresponding one of one or more connected components each of which is defined as the connected component.

As a result, it may be possible to efficiently identify each connected component according to the number of connection types, and identify the connection relationship among the plurality of faces. In consequence, it may be possible to reduce processing delay in reconstructing the three-dimensional mesh.

Moreover, a decoding device according to Example 16 is the decoding device according to Example 15, and the border may be indicated according to the total number of the connection types indicated by the relevant information, and a total number of one or more connection types decoded.

As a result, it may be possible to appropriately indicate the border of the connected component in the plurality of connection types decoded in the reverse order, according to a relationship between the number of the connection types indicated by the relevant information and the number of the one or more connection types decoded. Accordingly, it may be possible to efficiently identify each connected component and the connection relationship among the plurality of faces.

An encoding method according to Example 17 includes: for each of faces forming a three-dimensional mesh, encoding a connection type regarding a connection relationship between the face to be processed and a face not yet processed, in reverse order of processing order in which the connection type is defined; and encoding relevant information for detecting a border of a connected component in a plurality of connection types each of which is encoded as the connection type in the reverse order. The connected component corresponds to at least a portion of the three-dimensional mesh.

As a result, it may be possible to appropriately detect the border of the connected component in the plurality of connection types encoded in the reverse order. Accordingly, it may be possible to efficiently identify each connected component and the connection relationship among the plurality of faces. In consequence, it may be possible to reduce processing delay in reconstructing the three-dimensional mesh.

A decoding method according to Example 18 includes: for each of faces forming a three-dimensional mesh, decoding a connection type regarding a connection relationship between the face to be processed and a face not yet processed, in reverse order of processing order in which the connection type is defined; and decoding relevant information for detecting a border of a connected component in a plurality of connection types each of which is decoded as the connection type in the reverse order. The connected component corresponds to at least a portion of the three-dimensional mesh.

As a result, it may be possible to appropriately detect the border of the connected component in the plurality of connection types decoded in the reverse order. Accordingly, it may be possible to efficiently identify each connected component and the connection relationship among the plurality of faces. In consequence, it may be possible to reduce processing delay in reconstructing the three-dimensional mesh.

Moreover, these general or specific aspects may be implemented using a system, a device, a method, an integrated circuit, a computer program, or a non-transitory computer-readable recording medium such as a CD-ROM, or any combination of systems, devices, methods, integrated circuits, computer programs, and recording media.

### <Expressions and Terms>

The following expressions and terms will be used herein.

### (1) Three-Dimensional Mesh

A three-dimensional mesh is a set of a plurality of faces and indicates, for example, a three-dimensional object. In addition, a three-dimensional mesh is mainly constituted of vertex information, connection information, and attribute information. A three-dimensional mesh may be expressed as a polygon mesh or a mesh. In addition, a three-dimensional mesh may have a temporal change. A three-dimensional mesh may include metadata related to vertex information, connection information, and attribute information or other additional information.

### (2) Vertex Information

Vertex information is information indicating a vertex. For example, vertex information indicates a position of a vertex in a three-dimensional space. In addition, a vertex corresponds to a vertex of a face that constitutes a three-dimensional mesh. Vertex information may be expressed as “geometry”. In addition, vertex information may also be expressed as position information.

### (3) Connection Information

Connection information is information indicating a connection between vertexes. For example, connection information indicates a connection for constructing a face or an edge of a three-dimensional mesh. Connection information may be expressed as “connectivity”. In addition, connection information may also be expressed as face information.

### (4) Attribute Information

Attribute information is information indicating an attribute of a vertex or a face. For example, attribute information indicates an attribute such as a color, an image, a normal vector, and the like associated with a vertex or a face. Attribute information may be expressed as “texture”.

### (5) Face

A face is an element that constitutes a three-dimensional mesh. Specifically, a face is a polygon on a plane in a three-dimensional space. For example, a face can be determined as a triangle in the three-dimensional space.

### (6) Plane

A plane is a two-dimensional plane in a three-dimensional space. For example, a polygon is formed on a plane and a plurality of polygons are formed on a plurality of planes.

### (7) Bitstream

A bitstream corresponds to encoded information. A bitstream can also be expressed as a stream, an encoded bitstream, a compressed bitstream, or an encoded signal.

### (8) Encoding and Decoding

The expression “encode” may be replaced with expressions such as store, include, write, describe, signalize, send out, notify, save, or compress and such expressions may be interchangeably used. For example, encoding information may mean including information in a bitstream. In addition, encoding information in a bitstream may mean encoding the information and generating a bitstream that includes the encoded information.

In addition, the expression “decode” may be replaced with expressions such as read, interpret, scan, load, derive, acquire, receive, extract, restore, reconstruct, decompress, or expand and such expressions may be interchangeably used. For example, decoding information may mean acquiring information from a bitstream. In addition, decoding information from a bitstream may mean decoding the bitstream and acquiring information included in the bitstream.

### (9) Ordinal Numbers

In the description, an ordinal number such as first, second, or the like may be affixed to a constituent element or the like. Such ordinal numbers may be replaced as necessary. In addition, an ordinal number may be newly affixed to or removed from a constituent element or the like. Furthermore, the ordinal numbers may be affixed to elements in order to identify the elements and may not correspond to any meaningful order.

### <Three-Dimensional Mesh>

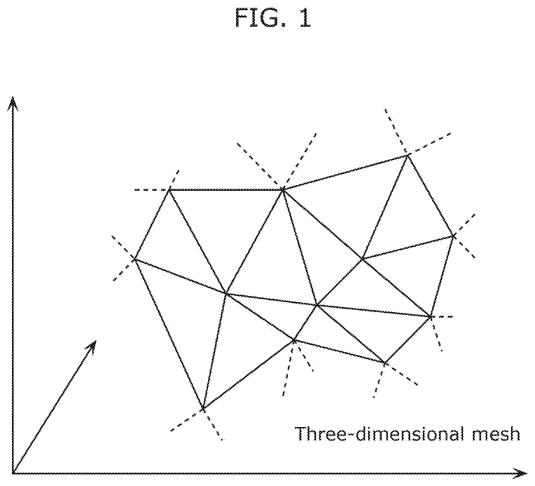

FIG. 1 is a conceptual diagram illustrating a three-dimensional mesh according to the present embodiment. The three-dimensional mesh is constituted of a plurality of faces. For example, each face is a triangle. Vertexes of the triangles are determined in a three-dimensional space. In addition, a three-dimensional mesh indicates a three-dimensional object. Each face may have a color or an image.

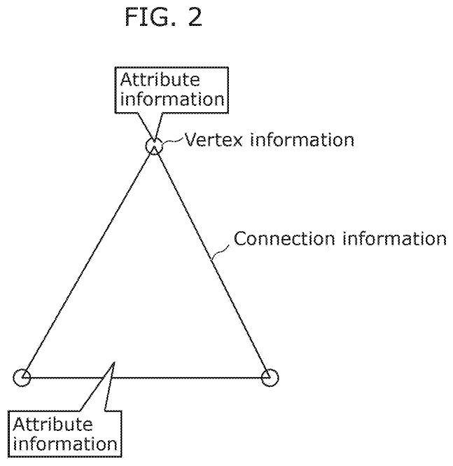

FIG. 2 is a conceptual diagram illustrating basic elements of a three-dimensional mesh according to the present embodiment. The three-dimensional mesh is constituted of vertex information, connection information, and attribute information. Vertex information indicates a position of a vertex of a face in a three-dimensional space. Connection information indicates a connection between vertexes. A face can be identified based on vertex information and connection information. In other words, an uncolored three-dimensional object is formed in a three-dimensional space based on vertex information and connection information.

Attribute information may be associated with a vertex or associated with a face. Attribute information associated with a vertex may be expressed as “attribute per point”. Attribute information associated with a vertex may indicate an attribute of the vertex itself or indicate an attribute of a face connected to the vertex.

For example, a color may be associated with a vertex as attribute information. The color associated with the vertex may be the color of the vertex or the color of a face connected to the vertex. The color of the face may be an average of a plurality of colors associated with a plurality of vertexes of the face. In addition, a normal vector may be associated with a vertex or a face as attribute information. Such a normal vector can express a front and a rear of a face.

In addition, a two-dimensional image may be associated with a face as attribute information. The two-dimensional image associated with a face is also expressed as a texture image or an “attribute map”. In addition, information indicating mapping between a face and a two-dimensional image may be associated with the face as attribute information. Such information indicating mapping may be expressed as mapping information, vertex information of a texture image, or an “attribute UV coordinate”.

Furthermore, information on a color, an image, a moving image, and the like to be used as attribute information may be expressed as “parametric space”.

A texture is reflected in a three-dimensional object based on such attribute information. In other words, a colored three-dimensional object is formed in a three-dimensional space based on vertex information, connection information, and attribute information.

Note that while attribute information is associated with a vertex or a face in the description given above, alternatively, attribute information may be associated with an edge.

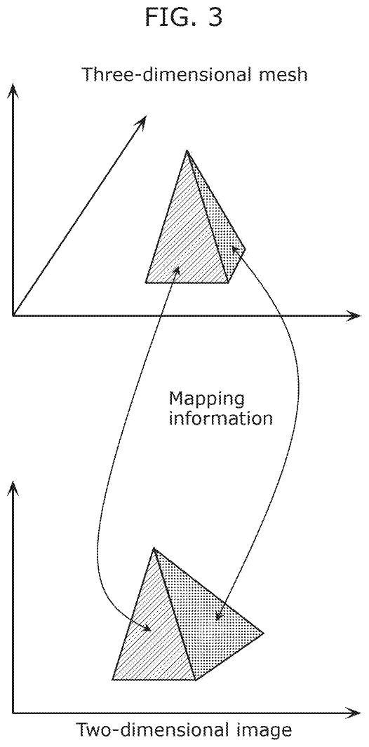

FIG. 3 is a conceptual diagram illustrating mapping according to the present embodiment. For example, a region of a two-dimensional image on a two-dimensional plane can be mapped to a face of a three-dimensional mesh in a three-dimensional space. Specifically, coordinate information of a region in the two-dimensional image is associated with a face of the three-dimensional mesh. Accordingly, an image of the mapped region in the two-dimensional image is reflected in the face of the three-dimensional mesh.

The use of mapping enables a two-dimensional image to be used as attribute information to be separated from the three-dimensional mesh. For example, in encoding of the three-dimensional mesh, the two-dimensional image may be encoded based on an image encoding system or a video encoding system.

### <System Configuration>

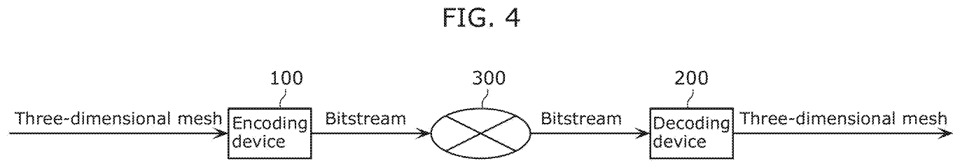

FIG. 4 is a block diagram illustrating a configuration example of an encoding/decoding system according to the present embodiment. In FIG. 4, the encoding/decoding system includes encoding device 100 and decoding device 200.

For example, encoding device 100 acquires a three-dimensional mesh and encodes the three-dimensional mesh into a bitstream. In addition, encoding device 100 outputs the bitstream to network 300. For example, the bitstream includes an encoded three-dimensional mesh and control information for decoding the encoded three-dimensional mesh. Encoding of the three-dimensional mesh causes information of the three-dimensional mesh to be compressed.

Network 300 transmits the bitstream from encoding device 100 to decoding device 200. Network 300 may be the Internet, a wide area network (WAN), a local area network (LAN), or a combination thereof. Network 300 is not necessarily limited to two-way communication and may be a unidirectional communication network for terrestrial digital broadcasting, satellite broadcasting, or the like.

In addition, network 300 may be replaced with a recording medium such as a DVD (digital versatile disc), a BD (Blu-Ray Disc (registered trademark)), or the like.

Decoding device 200 acquires a bitstream and decodes a three-dimensional mesh from the bitstream. Decoding of the three-dimensional mesh causes information of the three-dimensional mesh to be expanded. For example, decoding device 200 decodes a three-dimensional mesh according to a decoding method corresponding to an encoding method used by encoding device 100 to encode the three-dimensional mesh. In other words, encoding device 100 and decoding device 200 perform encoding and decoding according to an encoding method and a decoding method which correspond to each other.

Note that the three-dimensional mesh before encoding can also be expressed as an original three-dimensional mesh. In addition, the three-dimensional mesh after decoding is also expressed as a reconstructed three-dimensional mesh.

### <Encoding Device>

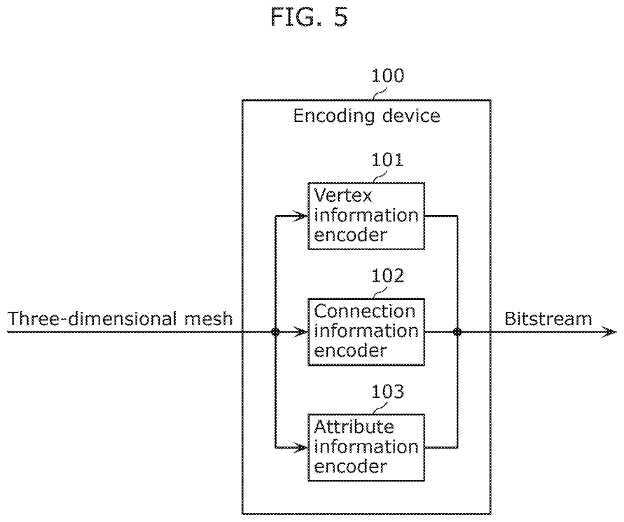

FIG. 5 is a block diagram illustrating a configuration example of encoding device 100 according to the present embodiment. For example, encoding device 100 includes vertex information encoder 101, connection information encoder 102, and attribute information encoder 103.

Vertex information encoder 101 is an electric circuit which encodes vertex information. For example, vertex information encoder 101 encodes vertex information into a bitstream according to a format defined with respect to the vertex information.

Connection information encoder 102 is an electric circuit which encodes connection information. For example, connection information encoder 102 encodes connection information into a bitstream according to a format defined with respect to the connection information.

Attribute information encoder 103 is an electric circuit which encodes attribute information. For example, attribute information encoder 103 encodes attribute information into a bitstream according to a format defined with respect to the attribute information.

Variable-length coding or fixed length coding may be used for encoding vertex information, connection information, and attribute information. The variable-length coding may accommodate Huffman coding, context-adaptive binary arithmetic coding (CABAC), or the like.

Vertex information encoder 101, connection information encoder 102, and attribute information encoder 103 may be integrated. Alternatively, each of vertex information encoder 101, connection information encoder 102, and attribute information encoder 103 may be more finely segmentalized into a plurality of constituent elements.

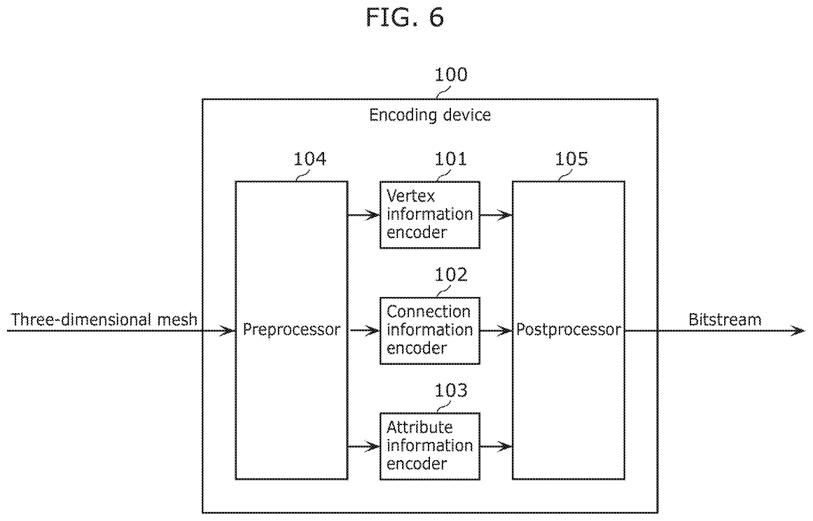

FIG. 6 is a block diagram illustrating another configuration example of encoding device 100 according to the present embodiment. For example, in addition to the components illustrated in FIG. 5, encoding device 100 includes preprocessor 104 and postprocessor 105.

Preprocessor 104 is an electric circuit which performs processing before encoding of vertex information, connection information, and attribute information. For example, preprocessor 104 may perform transformation processing, demultiplexing, multiplexing, or the like with respect to a three-dimensional mesh before encoding. More specifically, for example, preprocessor 104 may demultiplex vertex information, connection information, and attribute information from the three-dimensional mesh before encoding.

Postprocessor 105 is an electric circuit which performs processing after the encoding of vertex information, connection information, and attribute information. For example, postprocessor 105 may perform transformation processing, demultiplexing, multiplexing, or the like with respect to vertex information, connection information, and attribute information after encoding. More specifically, for example, postprocessor 105 may multiplex vertex information, connection information, and attribute information after encoding into a bitstream. In addition, for example, postprocessor 105 may further perform variable-length coding with respect to vertex information, connection information, and attribute information after the encoding.

### <Decoding Device>

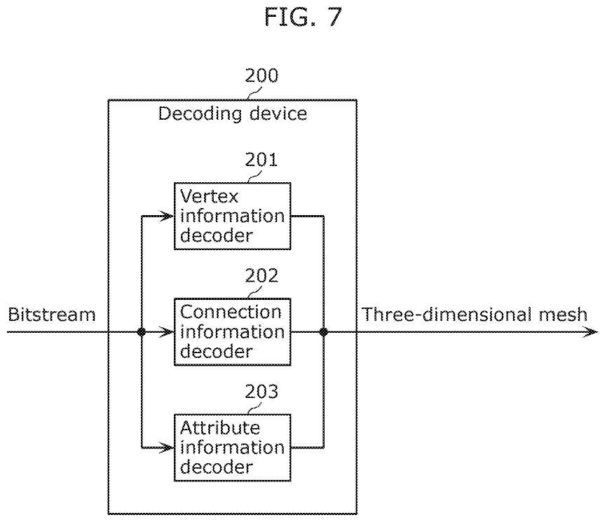

FIG. 7 is a block diagram illustrating a configuration example of decoding device 200 according to the present embodiment. For example, decoding device 200 includes vertex information decoder 201, connection information decoder 202, and attribute information decoder 203.

Vertex information decoder 201 is an electric circuit which decodes vertex information. For example, vertex information decoder 201 decodes vertex information from a bitstream according to a format defined with respect to the vertex information.

Connection information decoder 202 is an electric circuit which decodes connection information. For example, connection information decoder 202 decodes connection information from a bitstream according to a format defined with respect to the connection information.

Attribute information decoder 203 is an electric circuit which decodes attribute information. For example, attribute information decoder 203 decodes attribute information from a bitstream according to a format defined with respect to the attribute information.

Variable-length decoding or fixed length decoding may be used for decoding vertex information, connection information, and attribute information. The variable-length decoding may accommodate Huffman coding, context-adaptive binary arithmetic coding (CABAC), or the like.

Vertex information decoder 201, connection information decoder 202, and attribute information decoder 203 may be integrated. Alternatively, each of vertex information decoder 201, connection information decoder 202, and attribute information decoder 203 may be more finely segmentalized into a plurality of constituent elements.

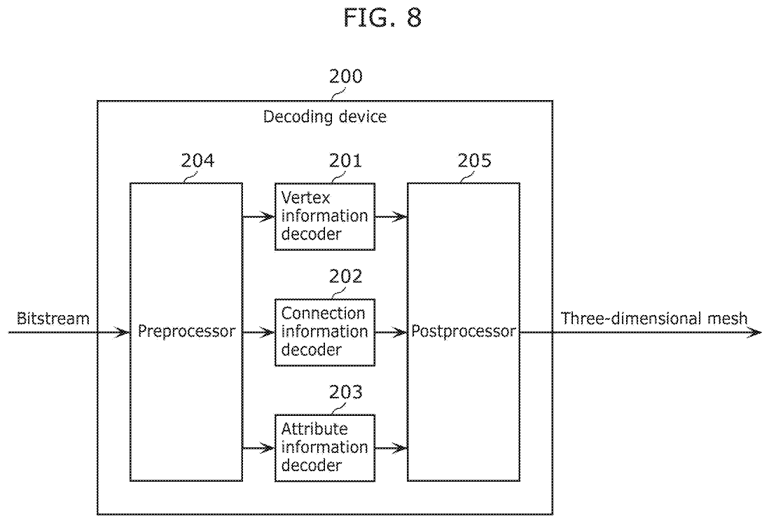

FIG. 8 is a block diagram illustrating another configuration example of decoding device 200 according to the present embodiment. For example, in addition to the components illustrated in FIG. 7, decoding device 200 includes preprocessor 204 and postprocessor 205.

Preprocessor 204 is an electric circuit which performs processing before decoding of vertex information, connection information, and attribute information. For example, preprocessor 204 may perform transformation processing, demultiplexing, multiplexing, or the like with respect to a bitstream before decoding of vertex information, connection information, and attribute information.

More specifically, for example, preprocessor 204 may demultiplex, from a bitstream, a sub-bitstream corresponding to vertex information, a sub-bitstream corresponding to connection information, and a sub-bitstream corresponding to attribute information. In addition, for example, preprocessor 204 may perform variable-length decoding with respect to the bitstream in advance before decoding of vertex information, connection information, and attribute information.

Postprocessor 205 is an electric circuit which performs processing after the decoding of vertex information, connection information, and attribute information. For example, postprocessor 205 may perform transformation processing, demultiplexing, multiplexing, or the like with respect to vertex information, connection information, and attribute information after decoding. More specifically, for example, postprocessor 205 may multiplex vertex information, connection information, and attribute information after decoding into a three-dimensional mesh.

### <Bitstream>

Vertex information, connection information, and attribute information are encoded and stored in a bitstream. A relationship between these pieces of information and the bitstream will be described below.

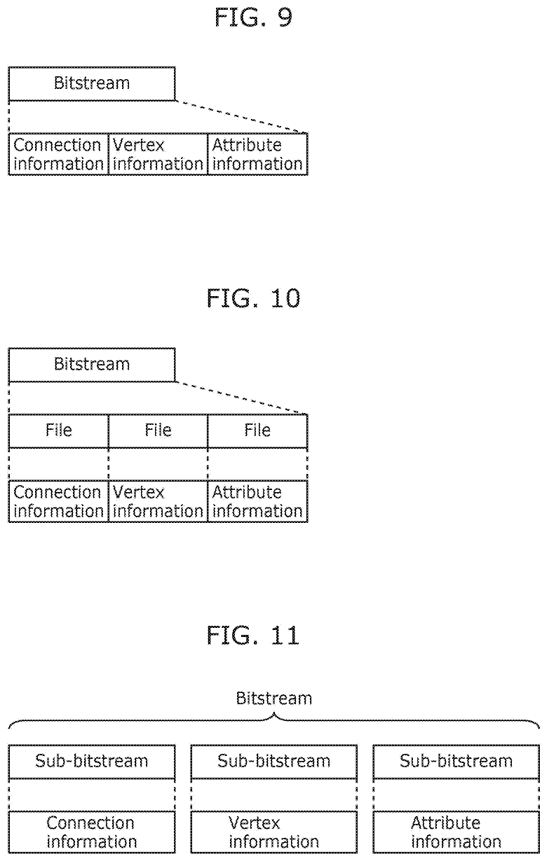

FIG. 9 is a conceptual diagram illustrating a configuration example of a bitstream according to the present embodiment. In this example, connection information, vertex information, and attribute information are integrated in the bitstream. For example, connection information, vertex information, and attribute information may be included in one file.

In addition, a plurality of portions of the pieces of information may be sequentially stored such as a first portion of connection information, a first portion of vertex information, a first portion of attribute information, a second portion of connection information, a second portion of vertex information, a second portion of attribute information. The plurality of portions may correspond to a plurality of temporally different portions, correspond to a plurality of spatially different portions, or correspond to a plurality of different faces.

Furthermore, an order of storage of connection information, vertex information, and attribute information is not limited to the example described above and an order of storage that differs from the above may be used.

FIG. 10 is a conceptual diagram illustrating another configuration example of a bitstream according to the present embodiment. In the example, a plurality of files are included in a bitstream and connection information, vertex information, and attribute information are respectively stored in different files. While a file including connection information, a file including vertex information, and a file including attribute information are illustrated here, storage formats are not limited to this example. For example, two types of information among connection information, vertex information, and attribute information may be included in one file and the one remaining type of information may be included in another file.

Alternatively, the pieces of information can be stored by being divided into a larger number of files. For example, a plurality of portions of connection information may be stored in a plurality of files, a plurality of portions of vertex information may be stored in a plurality of files, and a plurality of portions of attribute information may be stored in a plurality of files. The plurality of portions may correspond to a plurality of temporally different portions, correspond to a plurality of spatially different portions, or correspond to a plurality of different faces.

Furthermore, an order of storage of connection information, vertex information, and attribute information is not limited to the example described above and an order of storage that differs from the above may be used.

FIG. 11 is a conceptual diagram illustrating another configuration example of a bitstream according to the present embodiment. In the example, a bitstream is constituted of a plurality of separable sub-bitstreams and connection information, vertex information, and attribute information are respectively stored in different sub-bitstreams.

While a sub-bitstream including connection information, a sub-bitstream including vertex information, and a sub-bitstream including attribute information are illustrated here, storage formats are not limited to this example.

For example, two types of information among connection information, vertex information, and attribute information may be included in one sub-bitstream and the one remaining type of information may be included in another sub-bitstream. Specifically, attribute information such as a two-dimensional image may be stored in a sub-bitstream conforming to an image coding system separately from a sub-bitstream of connection information and vertex information.

In addition, each sub-bitstream may include a plurality of files. Furthermore, a plurality of portions of connection information may be stored in a plurality of files, a plurality of portions of vertex information may be stored in a plurality of files, and a plurality of portions of attribute information may be stored in a plurality of files.

Furthermore, an order of storage of connection information, vertex information, and attribute information is not limited to the example illustrated in FIG. 9, FIG. 10, and FIG. 11, and an order of storage that differs from this example may be used. For example, vertex information, connection information, and attribute information may be stored in a bitstream in this order. Alternatively, in an order other than this order, e.g., in any of orders: connection information, attribute information, and vertex information; vertex information, attribute information, and connection information; attribute information, connection information, and vertex information; and attribute information, vertex information, and connection information, these pieces of information may be stored in a bitstream.

Furthermore, each of connection information, vertex information, and attribute information may be divided into a plurality of data items, and the plurality of data items may be stored in a bitstream in a periodic order or in a random order.

### Specific Example

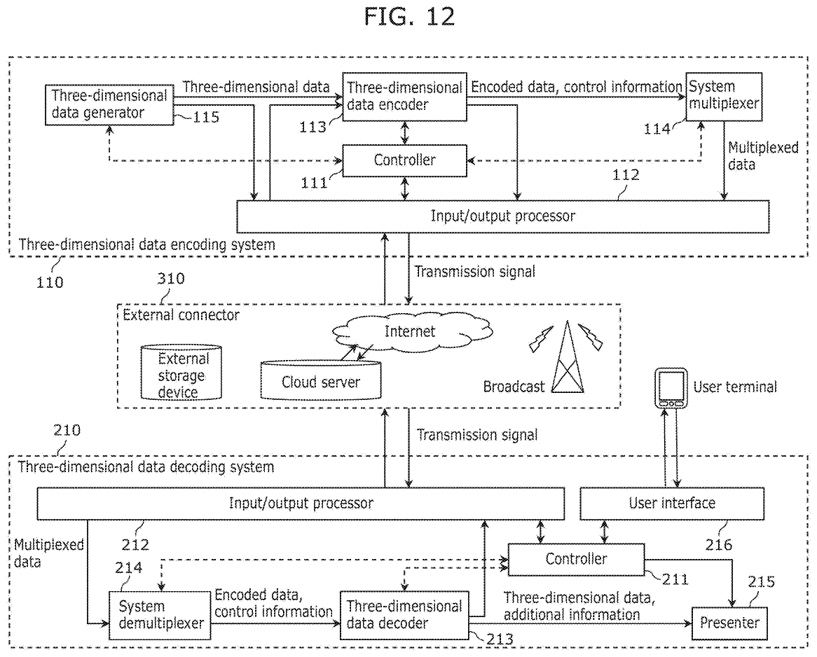

FIG. 12 is a block diagram illustrating a specific example of the encoding/decoding system according to the present embodiment. In FIG. 12, the encoding/decoding system includes three-dimensional data encoding system 110, three-dimensional data decoding system 210, and external connector 310.

Three-dimensional data encoding system 110 includes controller 111, input/output processor 112, three-dimensional data encoder 113, three-dimensional data generator 115, and system multiplexer 114. Three-dimensional data decoding system 210 includes controller 211, input/output processor 212, three-dimensional data decoder 213, system demultiplexer 214, presenter 215, and user interface 216.

In three-dimensional data encoding system 110, sensor data is input from a sensor terminal to three-dimensional data generator 115. Three-dimensional data generator 115 generates three-dimensional data that is point cloud data, mesh data, or the like from the sensor data and inputs the three-dimensional data to three-dimensional data encoder 113.

For example, three-dimensional data generator 115 generates vertex information and generates connection information and attribute information which correspond to the vertex information. Three-dimensional data generator 115 may process vertex information when generating connection information and attribute information. For example, three-dimensional data generator 115 may reduce a data amount by deleting overlapping vertexes or transform vertex information (position shift, rotation, normalization, or the like). In addition, three-dimensional data generator 115 may render attribute information.

While three-dimensional data generator 115 is a constituent element of three-dimensional data encoding system 110 in FIG. 12, three-dimensional data generator 115 may be disposed on the outside independent of three-dimensional data encoding system 110.

For example, a sensor terminal that provides sensor data for generating three-dimensional data may be a mobile object such as an automobile, a flying object such as an airplane, a mobile terminal, a camera, or the like. Alternatively, a range sensor such as LIDAR, a millimeter-wave radar, an infrared sensor, or a range finder, a stereo camera, a combination of a plurality of monocular cameras, or the like may be used as the sensor terminal.

The sensor data may be a distance (position) of an object, a monocular camera image, a stereo camera image, a color, a reflectance, an attitude or an orientation of a sensor, a gyro, a sensing position (GPS information or elevation), a velocity, an acceleration, a time of day of sensing, air temperature, air pressure, humidity, magnetism, or the like.

Three-dimensional data encoder 113 corresponds to encoding device 100 illustrated in FIG. 5 and the like. For example, three-dimensional data encoder 113 encodes three-dimensional data and generates encoded data. In addition, three-dimensional data encoder 113 generates control information when encoding the three-dimensional data. Furthermore, three-dimensional data encoder 113 inputs the encoded data to system multiplexer 114 together with the control information.

The encoding system of three-dimensional data may be an encoding system using geometry or an encoding system using a video codec. In this case, an encoding system using geometry may also be expressed as a geometry-based encoding system. An encoding system using a video codec may also be expressed as a video-based encoding system.

System multiplexer 114 multiplexes encoded data and control information input from three-dimensional data encoder 113 and generates multiplexed data using a prescribed multiplexing system. System multiplexer 114 may multiplex other media such as video, audio, subtitles, application data, or document files, reference time information, or the like together with the encoded data and control information of three-dimensional data. Furthermore, system multiplexer 114 may multiplex attribute information related to sensor data or three-dimensional data.

For example, multiplexed data has a file format for accumulation, a packet format for transmission, or the like. ISOBMFF or an ISOBMFF-based system may be used as an accumulation system or a transmission system. Alternatively, MPEG-DASH, MMT, MPEG-2TS Systems, RTP, or the like may be used.

In addition, multiplexed data is output as a transmission signal by input/output processor 112 to external connector 310. The multiplexed data may be transmitted as a transmission signal in a wired manner or in a wireless manner. Alternatively, the multiplexed data is accumulated in an internal memory or a storage device. The multiplexed data may be transmitted via the Internet to a cloud server or stored in an external storage device.

For example, the transmission or accumulation of the multiplexed data is performed by a method in accordance with a medium for transmission or accumulation such as broadcasting or communication. As a communication protocol, http, ftp, TCP, UDP, IP, or a combination thereof may be used. In addition, a pull-type communication scheme may be used or a push-type communication scheme may be used.

Ethernet (registered trademark), USB, RS-232C, HDMI (registered trademark), a coaxial cable, or the like may be used for wired transmission. In addition, 3GPP (registered trademark), 3G/4G/5G as specified by IEEE, a wireless LAN, Wi-Fi, Bluetooth, or a millimeter-wave may be used for wireless transmission. Furthermore, for example, DVB-T2, DVB-S2, DVB-C2, ATSC 3.0, ISDB-S3, or the like may be used as a broadcasting system.

Note that sensor data may be input to three-dimensional data generator 115 or system multiplexer 114. In addition, three-dimensional data or encoded data may be output as-is as a transmission signal to external connector 310 via input/output processor 112. The transmission signal output from three-dimensional data encoding system 110 is input to three-dimensional data decoding system 210 via external connector 310.

In addition, each operation of three-dimensional data encoding system 110 may be controlled by controller 111 which executes application programs.

In three-dimensional data decoding system 210, a transmission signal is input to input/output processor 212. Input/output processor 212 decodes multiplexed data having a file format or a packet format from the transmission signal and inputs the multiplexed data to system demultiplexer 214. System demultiplexer 214 acquires encoded data and control information from the multiplexed data and inputs the encoded data and the control information to three-dimensional data decoder 213. System demultiplexer 214 may extract other media, reference time information, or the like from the multiplexed data.

Three-dimensional data decoder 213 corresponds to decoding device 200 illustrated in FIG. 7 and the like. For example, three-dimensional data decoder 213 decodes three-dimensional data from the encoded data based on an encoding system specified in advance. Subsequently, the three-dimensional data is presented to a user by presenter 215.

In addition, additional information such as sensor data may be input to presenter 215. Presenter 215 may present three-dimensional data based on the additional information. In addition, an instruction by the user may be input to user interface 216 from a user terminal. Furthermore, presenter 215 may present three-dimensional data based on the input instruction.

Note that input/output processor 212 may acquire three-dimensional data and encoded data from external connector 310.

In addition, each operation of three-dimensional data encoding system 210 may be controlled by controller 211 which executes application programs.

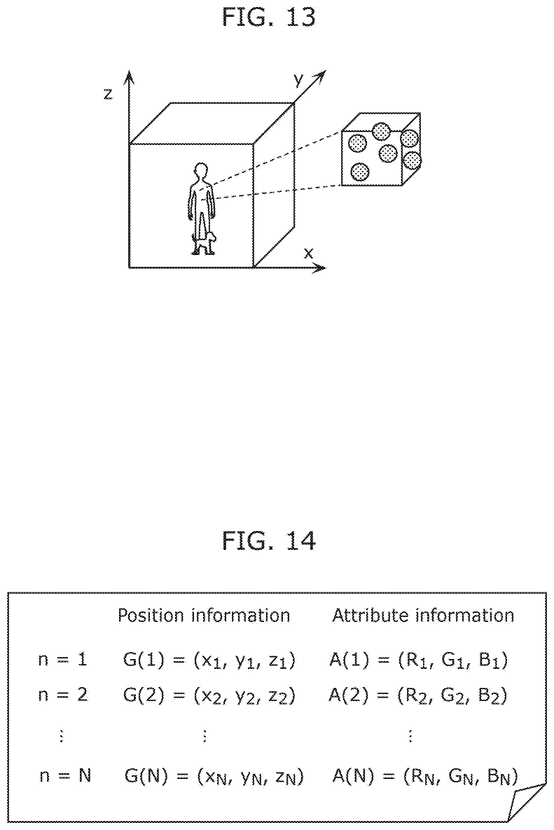

FIG. 13 is a conceptual diagram illustrating a configuration example of point cloud data according to the present embodiment. Point cloud data refers to data of a point cloud that indicates a three-dimensional object.

Specifically, a point cloud is constituted of a plurality of points and has position information which indicates a three-dimensional coordinate position of each point and attribute information which indicates an attribute of each point. The position information is also expressed as geometry.

For example, a type of attribute information may be a color, a reflectance, or the like. Attribute information related to one type may be associated with one point, attribute information related to a plurality of different types may be associated with one point, or attribute information having a plurality of values with respect to a same type may be associated with one point.

FIG. 14 is a conceptual diagram illustrating a data file example of the point cloud data according to the present embodiment. The example is an example of a case where items of position information and items of attribute information have a one-to-one correspondence and the example indicates position information and attribute information of N-number of points which constitute the point cloud data. In this example, position information is information indicating a three-dimensional coordinate position by three axes of x, y, and z and attribute information is information indicating a color by RGB. As a representative data file of point cloud data, a PLY file or the like can be used.

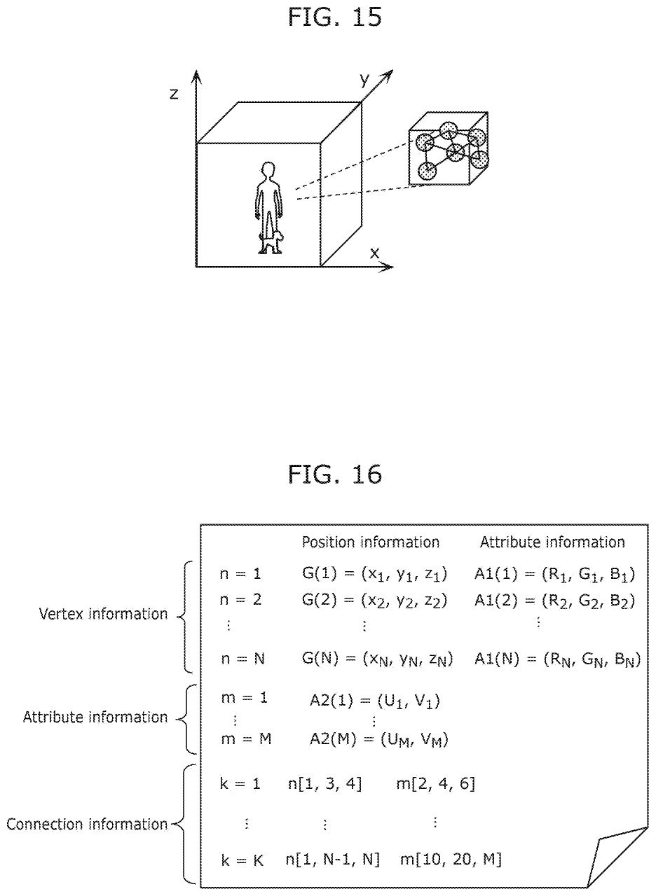

FIG. 15 is a conceptual diagram illustrating a configuration example of mesh data according to the present embodiment. Mesh data is data used in CG (computer graphics) or the like and is data of a three-dimensional mesh which represents a three-dimensional shape of an object by a plurality of faces. Each face is also expressed as a polygon and has a polygonal shape such as a triangle or a quadrilateral.

Specifically, in addition to the plurality of points which constitute a point cloud, a three-dimensional mesh is constituted of a plurality of edges and a plurality of faces. Each point is also expressed as a vertex or a position. Each edge corresponds to a line segment which connects two vertexes. Each face corresponds to an area enclosed by three or more edges.

In addition, a three-dimensional mesh has position information indicating three-dimensional coordinate positions of vertexes. The position information is also expressed as vertex information or geometry. Furthermore, a three-dimensional mesh has connection information indicating a relationship among a plurality of vertexes constituting an edge or a face. The connection information is also expressed as connectivity. In addition, a three-dimensional mesh has attribute information indicating an attribute with respect to a vertex, an edge, or a face. The attribute information in a three-dimensional mesh is also expressed as a texture.

For example, attribute information may indicate a color, a reflectance, or a normal vector with respect to a vertex, an edge, or a face. An orientation of a normal vector can express a front and a rear of a face.

An object file or the like may be used as a data file format of mesh data.

FIG. 16 is a conceptual diagram illustrating a data file example of the mesh data according to the present embodiment. In the example, a data file includes pieces of position information G(1) to G(N) and pieces of attribute information A1(1) to A1(N) of N-number of vertexes which constitute a three-dimensional mesh. In addition, in the example, M-number of pieces of attribute information A2(1) to A2(M) are included. An item of attribute information need not correspond one-to-one to a vertex and need not correspond one-to-one to a face. In addition, attribute information need not exist.

Connection information is indicated by a combination of indexes of vertexes. n [1, 3, 4] indicates a face of a triangle constituted of three vertexes n=1, n=3, and n=4. In addition, m [2, 4, 6] indicates that pieces of attribute information m=2, m=4, and m=6 respectively correspond to the three vertexes.

In addition, a substantive content of the attribute information may be described in a separate file. Furthermore, a pointer with respect to the content may be associated with a vertex, a face, or the like. For example, attribute information indicating an image with respect to a face may be stored in a two-dimensional attribute map file. In addition, a file name of the attribute map and a two-dimensional coordinate value in the attribute map may be described in pieces of attribute information A2(1) to A2(M). Methods of designating attribute information with respect to a face are not limited to these methods and any kind of method may be used.

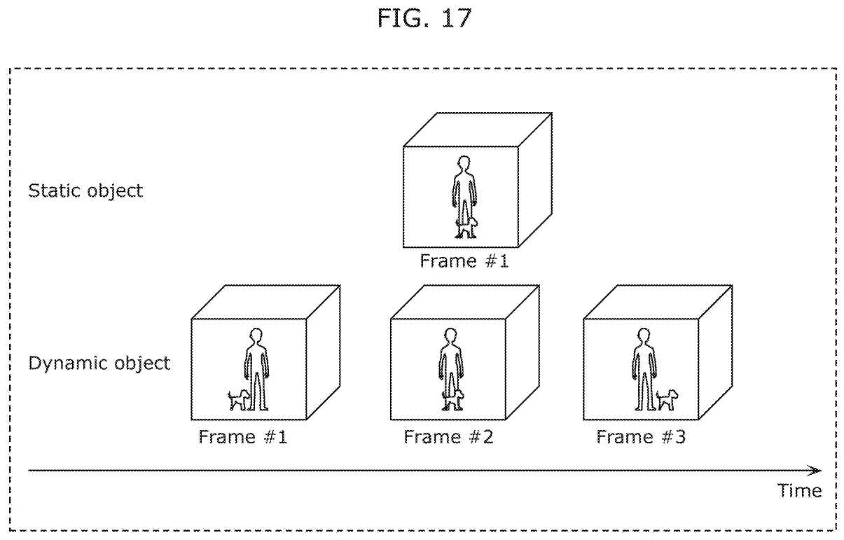

FIG. 17 is a conceptual diagram illustrating a type of three-dimensional data according to the present embodiment. Point cloud data and mesh data may either indicate a static object or a dynamic object. A static object is an object that does not temporally change and a dynamic object is an object that temporally changes. A static object may correspond to three-dimensional data with respect to an arbitrary time point.

For example, point cloud data with respect to an arbitrary time point may be expressed as a PCC frame. In addition, mesh data with respect to an arbitrary time point may be expressed as a mesh frame. Furthermore, a PCC frame and a mesh frame may be simply expressed as a frame.

In addition, an area of an object may be limited to a certain range in a similar manner to ordinary video data or need not be limited in a similar manner to map data. Furthermore, a density of points or faces may be set in various ways. Sparse point cloud data or sparse mesh data may be used or dense point cloud data or dense mesh data may be used.

Next, encoding and decoding of a point cloud or a three-dimensional mesh will be described. A device, processing, or a syntax for encoding and decoding vertex information of a three-dimensional mesh according to the present disclosure may be applied to the encoding and decoding of a point cloud. A device, processing, or a syntax for encoding and decoding a point cloud according to the present disclosure may be applied to the encoding and decoding of vertex information of a three-dimensional mesh.

In addition, a device, processing, or a syntax for encoding and decoding attribute information of a point cloud according to the present disclosure may be applied to the encoding and decoding of connection information or attribute information of a three-dimensional mesh. Furthermore, a device, processing, or a syntax for encoding and decoding connection information or attribute information of a three-dimensional mesh according to the present disclosure may be applied to the encoding and decoding of attribute information of a point cloud.

Furthermore, at least a part of processing may be commonalized between the encoding and decoding of point cloud data and the encoding and decoding of mesh data. Accordingly, sizes of circuits and software programs can be suppressed.

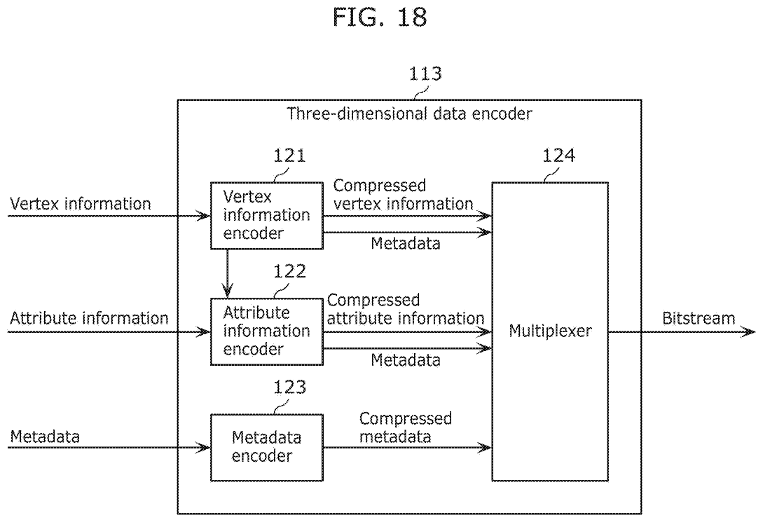

FIG. 18 is a block diagram illustrating a configuration example of three-dimensional data encoder 113 according to the present embodiment. In this example, three-dimensional data encoder 113 includes vertex information encoder 121, attribute information encoder 122, metadata encoder 123, and multiplexer 124. Vertex information encoder 121, attribute information encoder 122, and multiplexer 124 may correspond to vertex information encoder 101, attribute information encoder 103, postprocessor 105, and the like illustrated in FIG. 6.

In addition, in this example, three-dimensional data encoder 113 encodes three-dimensional data according to a geometry-based encoding system. Encoding according to the geometry-based encoding system takes a three-dimensional structure into consideration. Furthermore, in encoding according to the geometry-based encoding system, attribute information is encoded using configuration information obtained during encoding of vertex information.

Specifically, first, vertex information, attribute information, and metadata included in three-dimensional data generated from sensor data are respectively input to vertex information encoder 121, attribute information encoder 122, and metadata encoder 123. In this case, connection information included in three-dimensional data may be handled in a similar manner to attribute information. In addition, in the case of point cloud data, position information may be handled as vertex information.

Vertex information encoder 121 encodes vertex information into compressed vertex information and outputs the compressed vertex information to multiplexer 124 as encoded data. In addition, vertex information encoder 121 generates metadata of the compressed vertex information and outputs the metadata to multiplexer 124. Furthermore, vertex information encoder 121 generates configuration information and outputs the configuration information to attribute information encoder 122.

Attribute information encoder 122 encodes attribute information into compressed attribute information using the configuration information generated by vertex information encoder 121 and outputs the compressed attribute information to multiplexer 124 as encoded data. In addition, attribute information encoder 122 generates metadata of the compressed attribute information and outputs the metadata to multiplexer 124.

Metadata encoder 123 encodes compressible metadata into compressed metadata and outputs the compressed metadata to multiplexer 124 as encoded data. The metadata encoded by metadata encoder 123 may be used to encode vertex information and to encode attribute information.

Multiplexer 124 multiplexes the compressed vertex information, the metadata of the compressed vertex information, the compressed attribute information, the metadata of the compressed attribute information, and the compressed metadata into a bitstream. In addition, multiplexer 124 inputs the bitstream into a system layer.

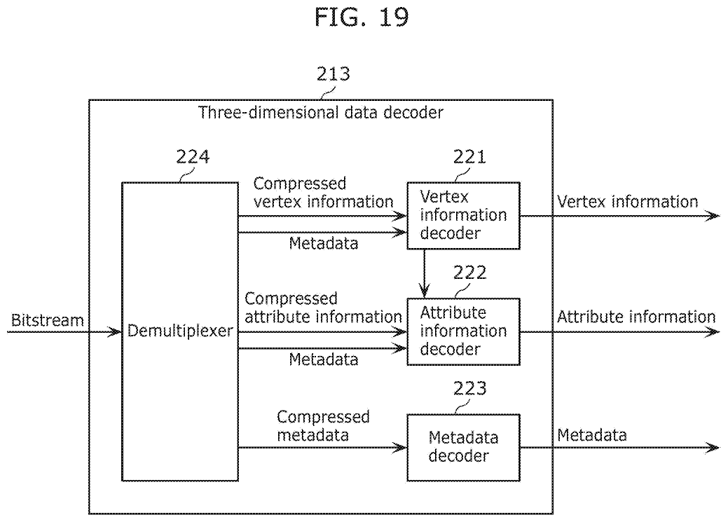

FIG. 19 is a block diagram illustrating a configuration example of three-dimensional data decoder 213 according to the present embodiment. In this example, three-dimensional data decoder 213 includes vertex information decoder 221, attribute information decoder 222, metadata decoder 223, and demultiplexer 224. Vertex information decoder 221, attribute information decoder 222, and demultiplexer 224 may correspond to vertex information decoder 201, attribute information decoder 203, preprocessor 204, and the like illustrated in FIG. 8.

In addition, in this example, three-dimensional data decoder 213 decodes three-dimensional data according to a geometry-based encoding system. Decoding according to the geometry-based encoding system takes a three-dimensional structure into consideration. Furthermore, in decoding according to the geometry-based encoding system, attribute information is decoded using configuration information obtained during decoding of vertex information.

Specifically, first, a bitstream is input from a system layer into demultiplexer 224. Demultiplexer 224 separates compressed vertex information, metadata of the compressed vertex information, compressed attribute information, metadata of the compressed attribute information, and compressed metadata from the bitstream. The compressed vertex information and the metadata of the compressed vertex information are input to vertex information decoder 221. The compressed attribute information and the metadata of the compressed attribute information are input to attribute information decoder 222. The metadata is input to metadata decoder 223.

Vertex information decoder 221 decodes vertex information from the compressed vertex information using the metadata of the compressed vertex information. In addition, vertex information decoder 221 generates configuration information and outputs the configuration information to attribute information decoder 222. Attribute information decoder 222 decodes attribute information from the compressed attribute information using the configuration information generated by vertex information decoder 221 and the metadata of the compressed attribute information. Metadata decoder 223 decodes metadata from the compressed metadata. The metadata decoded by metadata decoder 223 may be used to decode vertex information and to decode attribute information.

Subsequently, the vertex information, the attribute information, and the metadata are output from three-dimensional data decoder 213 as three-dimensional data. For example, the metadata is metadata of vertex information and attribute information and can be used in an application program.

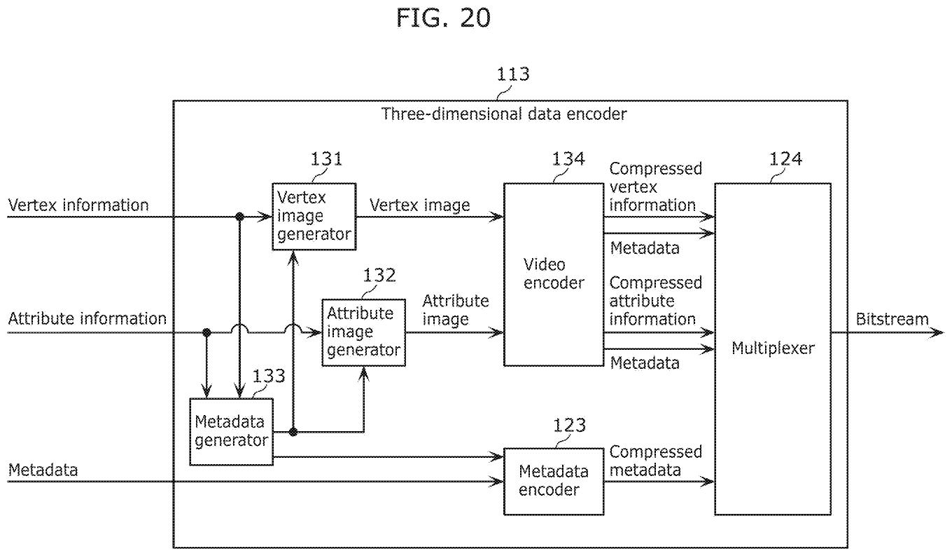

FIG. 20 is a block diagram illustrating a configuration example of three-dimensional data encoder 113 according to the present embodiment. In this example, three-dimensional data encoder 113 includes vertex image generator 131, attribute image generator 132, metadata generator 133, video encoder 134, metadata encoder 123, and multiplexer 124. Vertex image generator 131, attribute image generator 132, and video encoder 134 may correspond to vertex information encoder 101, attribute information encoder 103, and the like illustrated in FIG. 6.

In addition, in this example, three-dimensional data encoder 113 encodes three-dimensional data according to a video-based encoding system. In encoding according to the video-based encoding system, a plurality of two-dimensional images are generated from three-dimensional data and the plurality of two-dimensional images are encoded according to a video encoding system. In this case, the video encoding system may be HEVC (high efficiency video coding), VVC (versatile video coding), or the like.

Specifically, first, vertex information and attribute information included in three-dimensional data generated from sensor data are input to metadata generator 133. In addition, the vertex information and the attribute information are respectively input to vertex image generator 131 and attribute image generator 132. Furthermore, the metadata included in the three-dimensional data is input to metadata encoder 123. In this case, connection information included in three-dimensional data may be handled in a similar manner to attribute information. In addition, in the case of point cloud data, position information may be handled as vertex information.

Metadata generator 133 generates map information of a plurality of two-dimensional images from the vertex information and the attribute information. In addition, metadata generator 133 inputs the map information into vertex image generator 131, attribute image generator 132, and metadata encoder 123.

Vertex image generator 131 generates a vertex image based on the vertex information and the map information and inputs the vertex image into video encoder 134. Attribute image generator 132 generates an attribute image based on the attribute information and the map information and inputs the attribute image into video encoder 134.

Video encoder 134 respectively encodes the vertex image and the attribute image into compressed vertex information and compressed attribute information according to the video encoding system and outputs the compressed vertex information and the compressed attribute information to multiplexer 124 as encoded data. In addition, video encoder 134 generates metadata of the compressed vertex information and metadata of the compressed attribute information and outputs the pieces of metadata to multiplexer 124.

Metadata encoder 123 encodes compressible metadata into compressed metadata and outputs the compressed metadata to multiplexer 124 as encoded data. Compressible metadata includes map information. The metadata encoded by metadata encoder 123 may be used to encode vertex information and to encode attribute information.

Multiplexer 124 multiplexes the compressed vertex information, the metadata of the compressed vertex information, the compressed attribute information, the metadata of the compressed attribute information, and the compressed metadata into a bitstream. In addition, multiplexer 124 inputs the bitstream into a system layer.

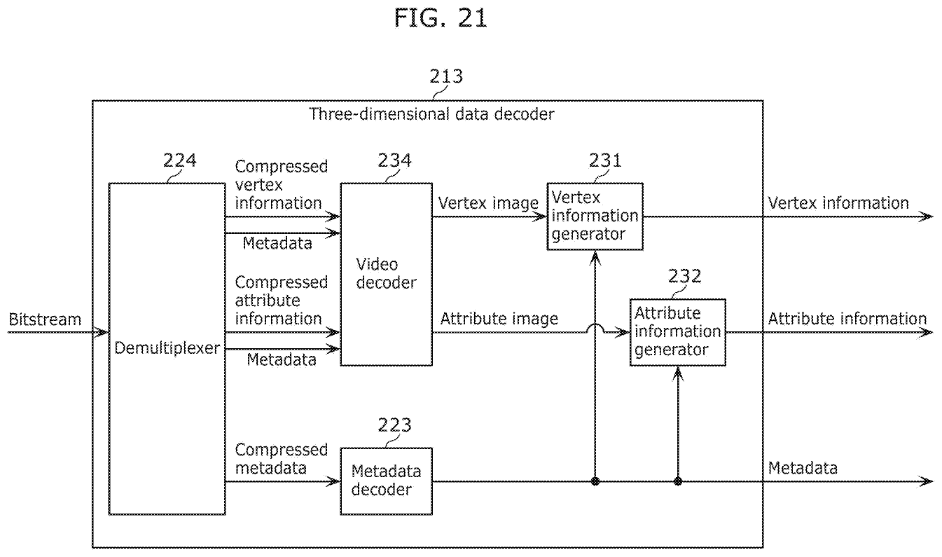

FIG. 21 is a block diagram illustrating another configuration example of three-dimensional data decoder 213 according to the present embodiment. In this example, three-dimensional data decoder 213 includes vertex information generator 231, attribute information generator 232, video decoder 234, metadata decoder 223, and demultiplexer 224. Vertex information generator 231, attribute information generator 232, and video decoder 234 may correspond to vertex information decoder 201, attribute information decoder 203, and the like illustrated in FIG. 8.

In addition, in this example, three-dimensional data decoder 213 decodes three-dimensional data according to a video-based encoding system. In decoding according to the video-based encoding system, a plurality of two-dimensional images are decoded according to a video encoding system and three-dimensional data is generated from the plurality of two-dimensional images. In this case, the video encoding system may be HEVC (high efficiency video coding), VVC (versatile video coding), or the like.

Specifically, first, a bitstream is input from a system layer into demultiplexer 224. Demultiplexer 224 separates compressed vertex information, metadata of the compressed vertex information, compressed attribute information, metadata of the compressed attribute information, and compressed metadata from the bitstream. The compressed vertex information, the metadata of the compressed vertex information, the compressed attribute information, and the metadata of the compressed attribute information are input to video decoder 234. The compressed metadata is input to metadata decoder 223.

Video decoder 234 decodes a vertex image according to the video encoding system. In doing so, video decoder 234 decodes the vertex image from the compressed vertex information using the metadata of the compressed vertex information. In addition, video decoder 234 inputs the vertex image into vertex information generator 231. Furthermore, video decoder 234 decodes an attribute image according to the video encoding system. In doing so, video decoder 234 decodes the attribute image from the compressed attribute information using the metadata of the compressed attribute information. In addition, video decoder 234 inputs the attribute image into attribute information generator 232.

Metadata decoder 223 decodes metadata from the compressed metadata. The metadata decoded by metadata decoder 223 includes map information to be used to generate vertex information and to generate attribute information. In addition, the metadata decoded by metadata decoder 223 may be used to decode the vertex image and to decode the attribute image.

Vertex information generator 231 reproduces vertex information from the vertex image according to the map information included in the metadata decoded by metadata decoder 223. Attribute information generator 232 reproduces r attribute information from the attribute image according to the map information included in the metadata decoded by metadata decoder 223.

Subsequently, the vertex information, the attribute information, and the metadata are output from three-dimensional data decoder 213 as three-dimensional data. For example, the metadata is metadata of vertex information and attribute information and can be used in an application program.

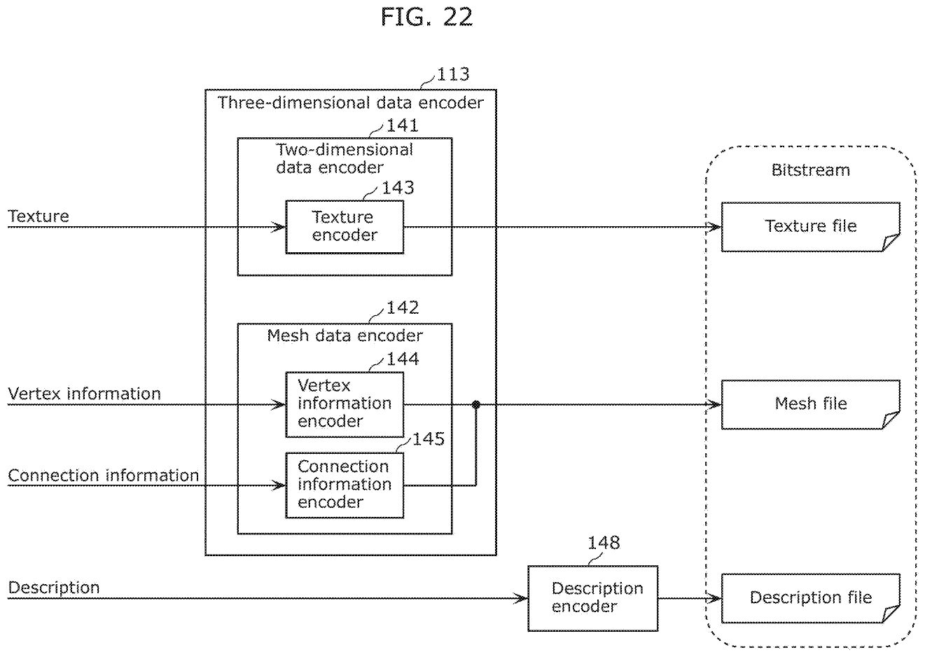

FIG. 22 is a conceptual diagram illustrating a specific example of encoding processing according to the present embodiment. FIG. 22 illustrates three-dimensional data encoder 113 and description encoder 148. In this example, three-dimensional data encoder 113 includes two-dimensional data encoder 141 and mesh data encoder 142. Two-dimensional data encoder 141 includes texture encoder 143. Mesh data encoder 142 includes vertex information encoder 144 and connection information encoder 145.

Vertex information encoder 144, connection information encoder 145, and texture encoder 143 may correspond to vertex information encoder 101, connection information encoder 102, attribute information encoder 103, and the like illustrated in FIG. 6.

For example, two-dimensional data encoder 141 operates as texture encoder 143 and generates a texture file by encoding a texture corresponding to attribute information as two-dimensional data according to an image encoding system or a video encoding system.

In addition, mesh data encoder 142 operates as vertex information encoder 144 and connection information encoder 145 and generates a mesh file by encoding vertex information and connection information. Mesh data encoder 142 may further encode mapping information with respect to a texture. The encoded mapping information may be included in a mesh file.

In addition, description encoder 148 generates a description file by encoding a description corresponding to metadata such as text data. Description encoder 148 may encode a description in the system layer. For example, description encoder 148 may be included in system multiplexer 114 illustrated in FIG. 12.

Due to the operation described above, a bitstream including a texture file, a mesh file, and a description file is generated. The files may be multiplexed in the bitstream in a file format such as gITF (graphics language transmission format) or USD (universal scene description).

Note that three-dimensional data encoder 113 may include two mesh data encoders as mesh data encoder 142. For example, one mesh data encoder encodes vertex information and connection information of a static three-dimensional mesh and the other mesh data encoder encodes vertex information and connection information of a dynamic three-dimensional mesh.

In addition, two mesh files may be included in the bitstream so as to correspond to the three-dimensional meshes. For example, one mesh file corresponds to the static three-dimensional mesh and the other mesh file corresponds to the dynamic three-dimensional mesh.

Furthermore, the static three-dimensional mesh may be an intra-frame three-dimensional mesh which is encoded using intra-prediction and the dynamic three-dimensional mesh may be an inter-frame three-dimensional mesh which is encoded using inter-prediction. In addition, as information of the dynamic three-dimensional mesh, difference information between vertex information or connection information of the intra-frame three-dimensional mesh and vertex information or connection information of the inter-frame three-dimensional mesh may be used.

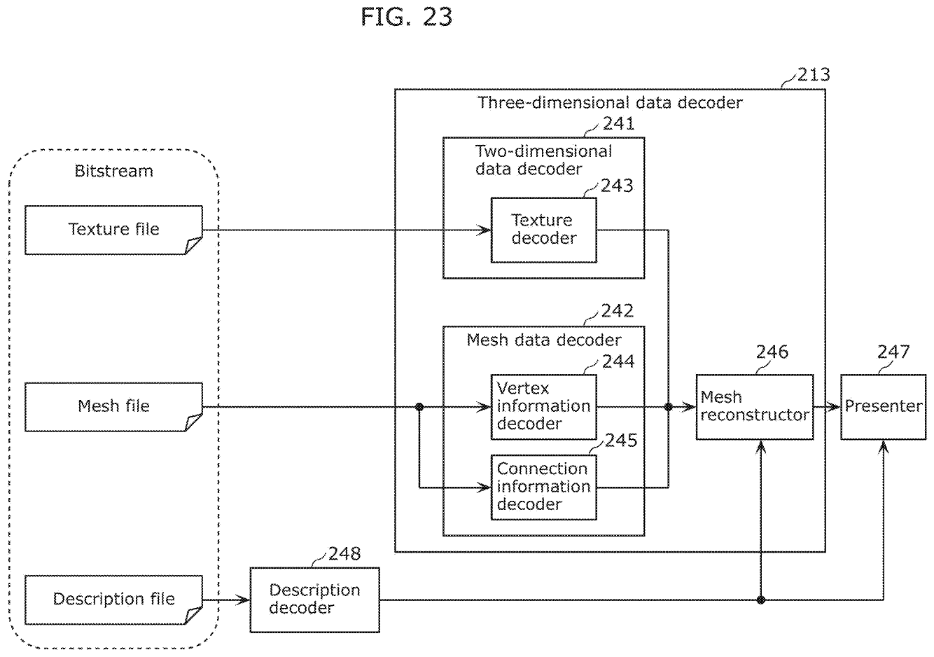

FIG. 23 is a conceptual diagram illustrating a specific example of decoding processing according to the present embodiment. FIG. 23 illustrates three-dimensional data decoder 213, description decoder 248, and presenter 247. In this example, three-dimensional data decoder 213 includes two-dimensional data decoder 241, mesh data decoder 242, and mesh reconstructor 246. Two-dimensional data decoder 241 includes texture decoder 243. Mesh data decoder 242 includes vertex information decoder 244 and connection information decoder 245.

Vertex information decoder 244, connection information decoder 245, texture decoder 243, and mesh reconstructor 246 may correspond to vertex information decoder 201, connection information decoder 202, attribute information decoder 203, postprocessor 205, and the like illustrated in FIG. 8. Presenter 247 may correspond to presenter 215 and the like illustrated in FIG. 12.

For example, two-dimensional data decoder 241 operates as texture decoder 243 and decodes a texture corresponding to attribute information from a texture file as two-dimensional data according to an image encoding system or a video encoding system.

In addition, mesh data decoder 242 operates as vertex information decoder 244 and connection information decoder 245 and decodes vertex information and connection information from a mesh file. Mesh data decoder 242 may further decode mapping information with respect to a texture from the mesh file.

Furthermore, description decoder 248 decodes a description corresponding to metadata such as text data from a description file. Description decoder 248 may decode a description in the system layer. For example, description decoder 248 may be included in system demultiplexer 214 illustrated in FIG. 12.

Mesh reconstructor 246 reconstructs a three-dimensional mesh from vertex information, connection information, and a texture according to a description. Presenter 247 renders and outputs the three-dimensional mesh according to the description.

Due to the operation described above, a three-dimensional mesh is reconstructed and output from a bitstream including a texture file, a mesh file, and a description file.

Note that three-dimensional data decoder 213 may include two mesh data decoders as mesh data decoder 242. For example, one mesh data decoder decodes vertex information and connection information of a static three-dimensional mesh and the other mesh data decoder decodes vertex information and connection information of a dynamic three-dimensional mesh.

In addition, two mesh files may be included in the bitstream so as to correspond to the three-dimensional meshes. For example, one mesh file corresponds to the static three-dimensional mesh and the other mesh file corresponds to the dynamic three-dimensional mesh.

Furthermore, the static three-dimensional mesh may be an intra-frame three-dimensional mesh which is encoded using intra-prediction and the dynamic three-dimensional mesh may be an inter-frame three-dimensional mesh which is encoded using inter-prediction. In addition, as information of the dynamic three-dimensional mesh, difference information between vertex information or connection information of the intra-frame three-dimensional mesh and vertex information or connection information of the inter-frame three-dimensional mesh may be used.

An encoding system of a dynamic three-dimensional mesh may be called DMC (dynamic mesh coding). In addition, a video-based encoding system of a dynamic three-dimensional mesh may be called VDMC (video-based dynamic mesh coding).

An encoding system of a point cloud may be called PCC (point cloud compression). A video-based encoding system of a point cloud may be called V-PCC (video-based point cloud compression). In addition, a geometry-based encoding system of a point cloud may be called G-PCC (geometry-based point cloud compression).

### Implementation Example

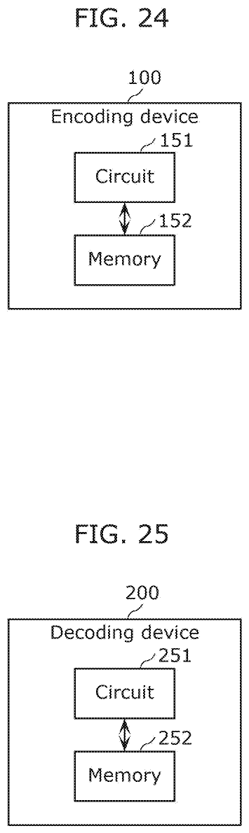

FIG. 24 is a block diagram illustrating an implementation example of encoding device 100 according to the present embodiment. Encoding device 100 includes circuit 151 and memory 152. For example, a plurality of constituent elements of encoding device 100 illustrated in FIG. 5 and the like are implemented by circuit 151 and memory 152 illustrated in FIG. 24.

Circuit 151 is a circuit which performs information processing and which is capable of accessing memory 152. For example, circuit 151 is a dedicated or general-purpose electric circuit which encodes a three-dimensional mesh. Circuit 151 may be a processor such as a CPU. Alternatively, circuit 151 may be a set of a plurality of electric circuits.

Memory 152 is a dedicated or general-purpose memory that stores information used by circuit 151 to encode a three-dimensional mesh. Memory 152 may be an electric circuit and may be connected to circuit 151. In addition, memory 152 may be included in circuit 151. Alternatively, memory 152 may be a set of a plurality of electric circuits. Furthermore, memory 152 may be a magnetic disk, an optical disk, or the like or may be expressed as a storage, a recording medium, or the like. In addition, memory 152 may be a non-volatile memory or a volatile memory.

For example, memory 152 may store a three-dimensional mesh or a bitstream. In addition, memory 152 may store a program used by circuit 151 to encode a three-dimensional mesh.

Note that in encoding device 100, all of the plurality of constituent elements illustrated in FIG. 5 and the like need not be implemented and all of the plurality of processing steps described herein need not be performed. A part of the plurality of constituent elements illustrated in FIG. 5 and the like may be included in another device and a part of the plurality of processing steps described herein may be executed by another device. In addition, a plurality of constituent elements according to the present disclosure may be optionally combined and implemented or a plurality of processing steps according to the present disclosure may be optionally combined and executed in encoding device 100.

FIG. 25 is a block diagram illustrating an implementation example of decoding device 200 according to the present embodiment. Decoding device 200 includes circuit 251 and memory 252. For example, a plurality of constituent elements of decoding device 200 illustrated in FIG. 7 and the like are implemented by circuit 251 and memory 252 illustrated in FIG. 25.

Circuit 251 is a circuit which performs information processing and which is capable of accessing memory 252. For example, circuit 251 is a dedicated or general-purpose electric circuit which decodes a three-dimensional mesh. Circuit 251 may be a processor such as a CPU. Alternatively, circuit 251 may be a set of a plurality of electric circuits.

Memory 252 is a dedicated or general-purpose memory that stores information used by circuit 251 to decode a three-dimensional mesh. Memory 252 may be an electric circuit and may be connected to circuit 251. In addition, memory 252 may be included in circuit 251. Alternatively, memory 252 may be a set of a plurality of electric circuits. Furthermore, memory 252 may be a magnetic disk, an optical disk, or the like or may be expressed as a storage, a recording medium, or the like. In addition, memory 252 may be a non-volatile memory or a volatile memory.

For example, memory 252 may store a three-dimensional mesh or a bitstream. In addition, memory 252 may store a program used by circuit 251 to decode a three-dimensional mesh.

Note that in decoding device 200, all of the plurality of constituent elements illustrated in FIG. 7 and the like need not be implemented and all of the plurality of processing steps described herein need not be performed. A part of the plurality of constituent elements illustrated in FIG. 7 and the like may be included in another device and a part of the plurality of processing steps described herein may be executed by another device. In addition, a plurality of constituent elements according to the present disclosure may be optionally combined and implemented or a plurality of processing steps according to the present disclosure may be optionally combined and executed in decoding device 200.

An encoding method and a decoding method including steps performed by each constituent element of encoding device 100 and decoding device 200 according to the present disclosure may be executed by any device or system. For example, a part of or all of the encoding method and the decoding method may be executed by a computer including a processor, a memory, an input/output circuit, and the like. In doing so, the encoding method and the decoding method may be executed by having the computer execute a program that enables the computer to execute the encoding method and the decoding method.

In addition, a program or a bitstream may be recorded on a non-transitory computer-readable recording medium such as a CD-ROM.

An example of a program may be a bitstream. For example, a bitstream including an encoded three-dimensional mesh includes a syntax element that enables decoding device 200 to decode the three-dimensional mesh. In addition, the bitstream causes decoding device 200 to decode the three-dimensional mesh according to the syntax element included in the bitstream. Therefore, a bitstream can perform a similar role to a program.

The bitstream described above may be an encoded bitstream including an encoded three-dimensional mesh or a multiplexed bitstream including an encoded three-dimensional mesh and other information.

In addition, each constituent element of encoding device 100 and decoding device 200 may be constituted of dedicated hardware, general-purpose hardware which executes the program or the like described above, or a combination thereof. Furthermore, the general-purpose hardware may be constituted of a memory on which a program is recorded, a general-purpose processor which reads the program from the memory and executes the program, and the like. In this case, the memory may be a semiconductor memory, a hard disk, or the like and the general-purpose processor may be a CPU or the like.

Furthermore, the dedicated hardware may be constituted of a memory, a dedicated processor, and the like. For example, the dedicated processor may execute the encoding method and the decoding method by referring to a memory for recording data.

In addition, as described above, the respective constituent elements of encoding device 100 and decoding device 200 may be electric circuits. The electric circuits may constitute one electric circuit as a whole or may be respectively different electric circuits. Furthermore, the electric circuits may correspond to dedicated hardware or to general-purpose hardware which executes the program or the like described above. Moreover, encoding device 100 and decoding device 200 may be implemented as integrated circuits.

In addition, encoding device 100 may be a transmitting device which transmits a three-dimensional mesh. Decoding device 200 may be a receiving device which receives a three-dimensional mesh.

### <One or More Main Aspects>

A three-dimensional model digitally represents an object in such a manner that a user can three-dimensionally search the model through zooming, panning, and rotation while temporarily rendering the model. One method of constructing such a representation is to construct a three-dimensional mesh with polygons. The model stores positions of vertexes of polygons, connectivity of the vertexes, and attributes associated with the vertexes (such as normal and UV patches). The polygons are triangles or rectangles, for example.

To store all of these items of information in an uncompressed manner, a vast storage area is needed, and therefore, a vast bandwidth is needed for transmission. Polygons forming a mesh, in particular, polygons in temporal or spatial proximity to each other, often have repetitive patterns and similar attributes. Such a repetition can be used for planning encoding and decoding methods efficient for storage and transmission.

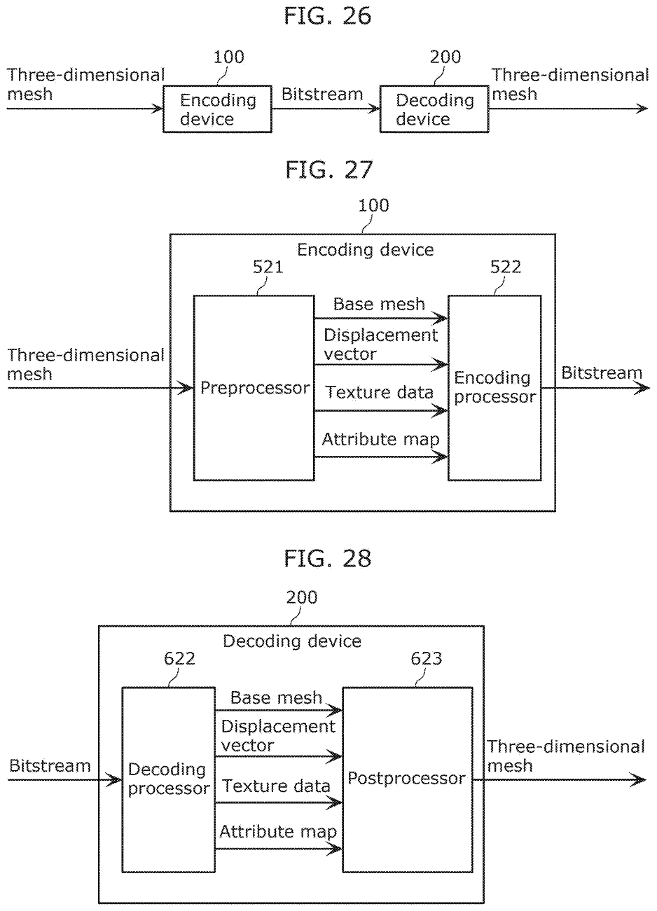

FIG. 26 is a block diagram illustrating another configuration example of the encoding/decoding system according to the embodiment. As illustrated in FIG. 26, the encoding/decoding system includes a pair of encoding device 100 and decoding device 200. The encoding/decoding system receives a three-dimensional mesh frame that is input in forms of vertex three-dimensional coordinates (vertex information), connectivity (connection information) and associated attributes (attribute information).

Encoding device 100 encodes all associated information into a bitstream (compressed bitstream). The bitstream may be formed by a plurality of bitstreams. The bitstream is transmitted to decoding device 200 through a transmission path. Decoding device 200 decodes the bitstream and generates a three-dimensional model (three-dimensional mesh) from the decoded vertex three-dimensional coordinates, connectivity and associated attributes.

FIG. 27 is a block diagram illustrating yet another configuration example of encoding device 100 according to the present embodiment. In this example, encoding device 100 includes preprocessor 521 and encoding processor 522.

Preprocessor 521 reads a three-dimensional mesh, processes the three-dimensional mesh, extracts a base mesh, a displacement vector, texture data and an attribute map, and passes the base mesh, the displacement vector, the texture data, and the attribute map to encoding processor 522. Encoding processor 522 separately compresses the base mesh, the displacement vector, the texture data, and the attribute map, and combines them to generate a bitstream.

FIG. 28 is a block diagram illustrating yet another configuration example of decoding device 200 according to the present embodiment. In this example, decoding device 200 includes decoding processor 622 and postprocessor 623.

Decoding processor 622 reads a bitstream, separates a base mesh, a displacement vector, texture data, and an attribute map from the bitstream, separately decodes them, and passes them to postprocessor 623. Postprocessor 623 processes the base mesh according to the displacement vector and the attribute map to generate a three-dimensional mesh.

In the encoding method, for example, the original three-dimensional mesh is first decimated to obtain a base mesh that includes less vertexes. In the base mesh, a vertex need not be located at the original position, and connectivity of vertexes may change as a result of the decimation.

After that, a plurality of new vertexes are repeatedly added between connected existing vertexes in the base mesh to segmentalize the base mesh. Then, a displacement vector between the segmentalized three-dimensional mesh and the input three-dimensional mesh is calculated. The displacement vector is used in decoding device 200 so that segmentalized vertexes are located at predicted positions.

This information is transformed into a wavelet coefficient through wavelet transformation and encoded using a video codec by mapping a coefficient onto a plane of a video frame. A texture of the three-dimensional mesh and a map for combining all information for reconstruction are separately encoded and then combined into one bitstream.

Decoding device 200 first decodes a base mesh. A plurality of new vertexes are repeatedly added between connected existing vertexes in the base mesh to segmentalize the base mesh. Then, all vertexes and connectivity are obtained. The vertexes may be located at different positions than the corresponding vertexes in the input three-dimensional mesh.

Then, a wavelet coefficient is decoded by a video decoder, and an inverse wavelet transformation is applied to reconstruct a displacement vector. Using this information, the vertexes are placed at predicted positions, the texture is mapped onto a plane created based on the vertexes and the connectivity thereof, and thereby the three-dimensional mesh is completely decoded.

Recent developments in obtaining, modeling, and rendering of three-dimensional data are promoting applications concerning three-dimensional contents for various platforms and devices. Three-dimensional media is a very convenient method for highly immersive user experience in applications such as digital entertainment, health care, and robotics.

A three-dimensional mesh is used for rendering immersive media, for example, and is formed of several polygons that represent a boundary face of a volumetric object. Each polygon includes vertexes in a three-dimensional space and connection information that defines a way of connection of the vertexes. Optionally, the three-dimensional mesh may include an attribute, such as color, normal, and material property.

A dynamic mesh is a type of mesh in which at least one of connection information, geometry information, mapping information, a vertex attribute, and an attribute map temporally changes. The dynamic mesh is formed of a vast amount of data that temporally changes, so that a mass storage may be needed. Therefore, to appropriately store and transmit such data, an efficient compression solution is essential.

A method referred to Edgebreaker is a method of encoding a three-dimensional mesh in which individual meshes are triangles. The Edgebreaker can correspond to a method for classifying triangles constituting a three-dimensional mesh. In this method, each triangle forming a three-dimensional mesh is classified into five types C, L, E, R, and S according to the pattern of adjacent triangles, and the three-dimensional mesh is represented by a character string formed by a combination of C, L, E, R, and S.

Here, S means split, E means end, C means corner, and L and R each mean the position of an adjacent triangle to be encoded next. These types are also referred to as type S, type E, type C, type L, and type R. For example, a triangle of type C is not adjacent to an encoded triangle. A triangle adjacent on the right to a triangle of type L is encoded next. A triangle adjacent on the left to a triangle of type R is encoded next.

It should be noted that encoding (or decoding) a triangle can include encoding (or decoding) a connection type of a triangle. Additionally, an encoded (or decoded) connection type of a triangle may mean an encoded (or decoded) connection type.

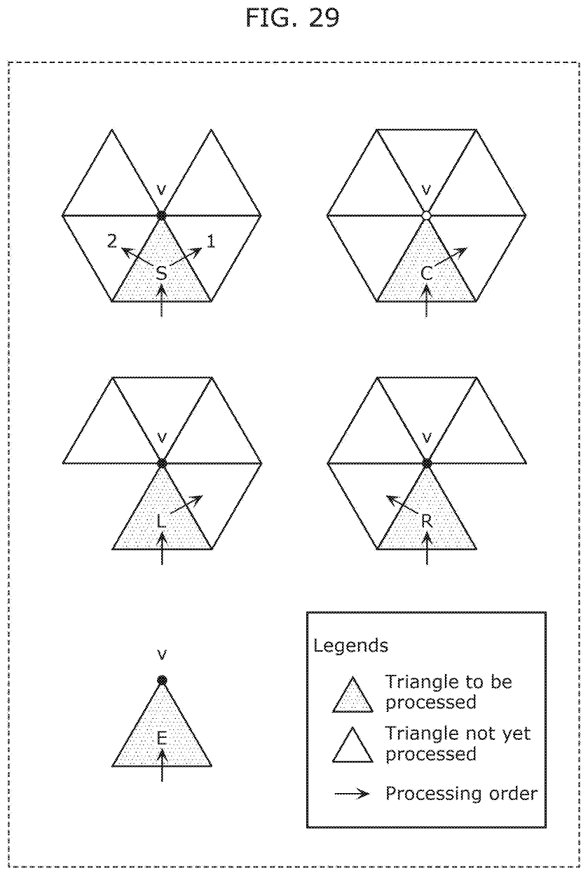

FIG. 29 is a conceptual diagram illustrating the five connection types according to the present embodiment. The connection type indicates a connection relationship between a triangle to be processed and a triangle that is not yet processed. Here, “to be processed” corresponds to “to be visited”, “already processed” corresponds to “already visited”, and “not yet processed” corresponds to “not yet visited”. Note that the vertexes of a visited triangle may be regarded as already visited. Furthermore, a space where no triangle exists and a vertex abutting on the space may be regarded as already visited.

In type S, along the path to the triangle to be processed in the processing order, a plurality of triangles not yet processed are separately connected to the triangle to be processed on both sides thereof. In other words, a plurality of triangles not yet processed are connected to the triangle to be processed on both sides thereof in a split manner. For example, in type S, vertex v is already visited. After the triangle of type S is processed, the triangle not yet processed connected to the right side of the triangle of type S is first processed. After that, specifically, after the triangle of type E is processed, the triangle not yet processed connected to the left side of the triangle of type S is processed.

In type C, along the path to the triangle to be processed in the processing order, a plurality of triangles not yet processed are connected to the triangle to be processed on both sides thereof without being separated. In other words, a plurality of triangles not yet processed are connected to the triangle to be processed on both sides thereof in a non-split manner. For example, in type C, vertex v is not yet visited. After the triangle of type C is processed, the triangle not yet processed connected to the right side of the triangle of type C is processed.

In type L, along the path to the triangle to be processed in the processing order, any triangle not yet processed is not connected to the left side of the triangle to be processed, and a triangle not yet processed is connected to the right side of the triangle to be processed. For example, in type L, vertex v is already visited. After the triangle of type L is processed, the triangle not yet processed connected to the right side of the triangle of type L is processed.

In type R, along the path to the triangle to be processed in the processing order, any triangle not yet processed is not connected to the right side of the triangle to be processed, and a triangle not yet processed is connected to the left side of the triangle to be processed. For example, in type R, vertex v is already visited. After the triangle of type R is processed, the triangle not yet processed connected to the left side of the triangle of type R is processed.

In type E, along the path to the triangle to be processed in the processing order, any triangle not yet processed is not connected to the right side and the left side of the triangle to be processed. For example, in type E, vertex v is already visited. After the triangle of type E is processed, for example, a triangle not yet processed connected to the left side of an already processed triangle of type S is processed. Alternatively, after the triangle of type E is processed, the process ends.

For example, type C is a type in which, along a path to a triangle to be processed in processing order, two triangles not yet processed are connected to the right side and the left side of the triangle to be processed, and all of a plurality of triangles including the two triangles and connected to a vertex of the triangle to be processed are not yet processed. In addition, for example, type S is a type in which, along the path to the triangle to be processed in the processing order, two triangles not yet processed are connected to the right side and the left side of the triangle to be processed, and is different from a corner type.

In particular, in type C, a triangle to be processed and a plurality of triangles not yet processed can form a corner at vertex v on a three-dimensional mesh. Accordingly, type C indicates a corner and can be expressed as a corner type. Other types S, L, R, and E can be expressed as a split type, a left type, a right type, and an end type, respectively. Additionally, a type equivalent to these types may be determined by a method other than the Edgebreaker.

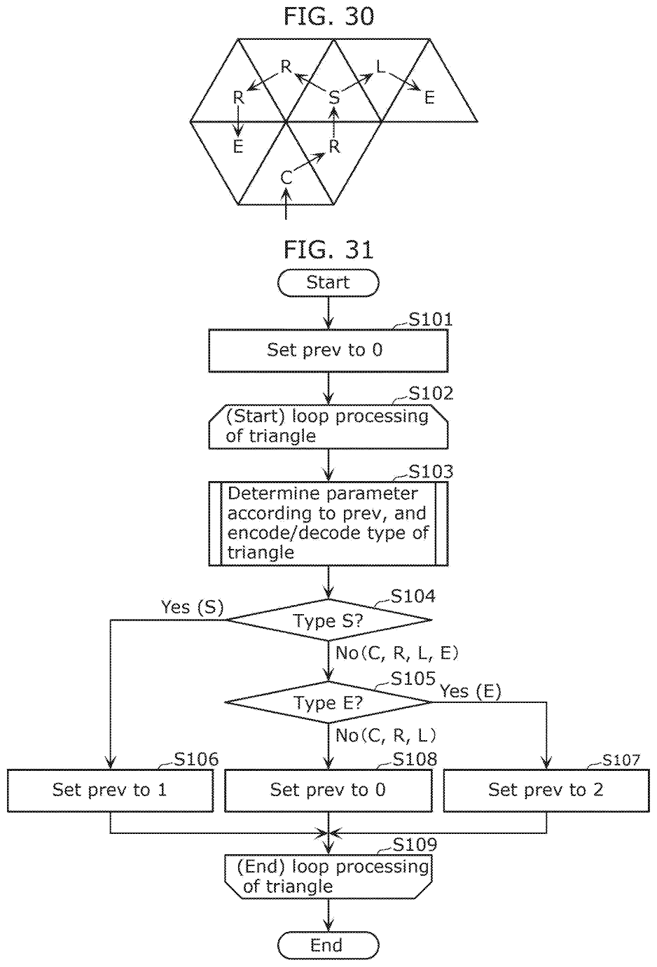

FIG. 30 is a conceptual diagram illustrating an example of the connection types sequentially determined according to the present embodiment. As illustrated in FIG. 30, the connection type of each of the plurality of triangles forming the three-dimensional mesh is sequentially determined to be any of the plurality of types illustrated in FIG. 29, and then encoding and decoding are performed. The connection type indicates a connection relationship between a plurality of triangles, and can indicate the processing order of the plurality of triangles. Furthermore, the connection type can be used for reconstruction of the three-dimensional model.

Furthermore, types C, L, E, R, and S may be assigned bit patterns 0, 110, 111, 101, and 100, respectively. These bit patterns may be encoded. Furthermore, concerning the leading triangle, in addition to type C, L, E, R, or S, information about each vertex of the leading triangle (such as three-dimensional coordinate positions, texture map coordinate positions, and normal vectors) may be encoded. Furthermore, concerning the triangle of type C, information about a new additional vertex may be encoded, for example.

For example, Edgebreaker according to the present disclosure may be used for encoding processing and decoding processing for a three-dimensional mesh, or may be used for encoding processing and decoding processing for a base mesh illustrated in FIGS. 27 and 28. Specifically, the processing according to the present disclosure may be applied to encoding processing and decoding processing for information that indicates a connection relationship between a plurality of faces that are a plurality of polygons forming a three-dimensional mesh.

When a three-dimensional mesh structure is restored by decoding a character string including above C, L, E, R, and S, a process referred to as zippering in which adjacent triangles are connected in sequence is performed. This process is performed when a triangle of type L or type E appears, and is repeatedly performed on a series of connectable triangles. As a result, the three-dimensional mesh structure is restored.

Additionally, a method referred to as Spirale Reversi in which a three-dimensional mesh structure is restored by traversing a character string including above C, L, E, R, and S in reverse order from the end of the character string is known. This method may allow repeated reading of the character string to be suppressed, and allow the three-dimensional mesh structure to be efficiently restored. In addition, the method may allow information about the restored three-dimensional mesh structure to be used in encoding and decoding of the character string including C, L, E, R, and S, by encoding and decoding the character string in reverse order from the end of the character string.

FIG. 31 is a flowchart illustrating encoding processing and decoding processing for a connection type according to this embodiment. Specifically, FIG. 31 illustrates an example of a method of encoding the type (C, L, E, R, or S) associated with each triangle forming a three-dimensional mesh on a triangle basis. Here, the encoding is entropy encoding, such as arithmetic encoding or Huffman coding.

In this method, the value of variable prev is set according to the connection type encoded immediately before the current connection type. Then, according to prev, a parameter that controls the entropy encoding of the connection type of the triangle is determined. Then, according to the parameter determined, entropy encoding of the connection type to be encoded is performed.

Specifically, first, prev is set to an initial value (0, for example) (S101). Then, entropy encoding of the connection type of each triangle is repeated (S102 to S109). Here, a parameter for controlling the entropy encoding of the connection type of the triangle is determined according to prev, and entropy encoding of the connection type to be encoded is performed (S103).

For example, when arithmetic encoding is used for entropy encoding, a context used for determining a predicted occurrence probability of information to be encoded is determined from among a plurality of contexts according to prev. Alternatively, when Huffman coding is used for entropy encoding, a codeword table used for encoding is determined from among a plurality of codeword tables according to prev.

According to the encoded connection type, then, the value of prev used for controlling entropy encoding of the next connection type to be encoded is set (S104 to S107). Specifically, first, whether the encoded connection type is type S or not is determined. When the encoded connection type is type S (Yes in S104), prev is set to 1 (S106).

When the encoded connection type is not type S (No in S104: the encoded connection type is any of C, R, L, and E), whether the encoded connection type is type E or not is determined (S105). When the encoded connection type is type E (Yes in S105), prev is set to 2 (S107). When the encoded connection type is not type E (No in S105: the encoded connection type is any of C, R, and L), prev is set to 0 (S108).

As a result of trials, the inventors have made a new finding that the tendency of the occurrence probability of each type encoded immediately after encoding of type S or E is different from the tendency of the occurrence probability of each type encoded immediately after type C, R, or L. Therefore, by switching the control of the entropy encoding according to the connection type encoded immediately before the current connection type as described above, the encoding efficiency of the entropy encoding may be able to be improved.

Note that FIG. 31 illustrates an example in which the connection type is classified into three groups, a group of type S, a group of type E, and a group of types C, R, and L, for switching the control of the entropy encoding. However, the context may be determined for each of the five types.

Furthermore, in the example in FIG. 31, the determination and setting concerning type E (S105 and S107) may be omitted. In that case, the connection type may be classified into two groups, a group of type S and a group of types C, R, L, and E, for switching the control of the entropy encoding.

In this way, the encoding efficiency may be improved compared with the case where there is only one group, and the memory utilization may be reduced compared with the case where there are three groups.

Furthermore, in FIG. 31, the value of prev is set to any of 0, 1, and 2 according to the encoded connection type. However, another method may be used in which three groups, a group of type S, a group of type E, and a group of types C, R, and L, may be distinguished for switching the control of the entropy encoding.

Furthermore, although the control of the entropy encoding is switched in the above description, “encoding” may be interchanged with “decoding”, and the control of entropy decoding may be switched.

Furthermore, in the above description, the context of arithmetic encoding is selected according to the type associated with the triangle processed immediately before the triangle to be processed. However, the selection of the context is not limited to this example. Specifically, the selection of the context is not limited to the selection according to the immediately preceding type, and the parameter for entropy encoding or entropy decoding of the connection information to be processed may be determined according to encoded or decoded connection information (link information).

The encoded or decoded link information may be link information of the polygon encoded or decoded immediately before the current polygon. Furthermore, the entropy encoding or the entropy decoding may be arithmetic encoding or arithmetic decoding, and in that case, the parameter may be the context or a parameter for deriving the context.

In an example of the selection of the context, a first context may be used when the link information of the polygon encoded or decoded immediately before the current polygon is not a type that indicates a split. And when the link information of the polygon encoded or decoded immediately before the current polygon is a type that indicates a split, a second context may be used.

In other words, for the polygon to be processed, the context may be determined based on whether the type of the link information of a processed polygon at a predetermined position is a type that indicates a split. Alternatively, for the polygon to be processed, the context may be determined based on whether the type of the link information of a processed polygon at a predetermined position is a type that indicates an end.

Furthermore, whether to determine the context based on the type of the processed polygon may be switched. Furthermore, the connection type used as a determination criterion may be switched. In that case, a parameter may be encoded that indicates whether the switching is appropriate or not, the context to be selected, or the connection type of the polygon associated with the context, for example.

Furthermore, the sequence of the processing including determinations and settings may be changed, or part of the processing may be omitted. For example, the determination of type S (S104) and the determination of type E (S105) may be interchanged, or one of the determinations may be omitted.

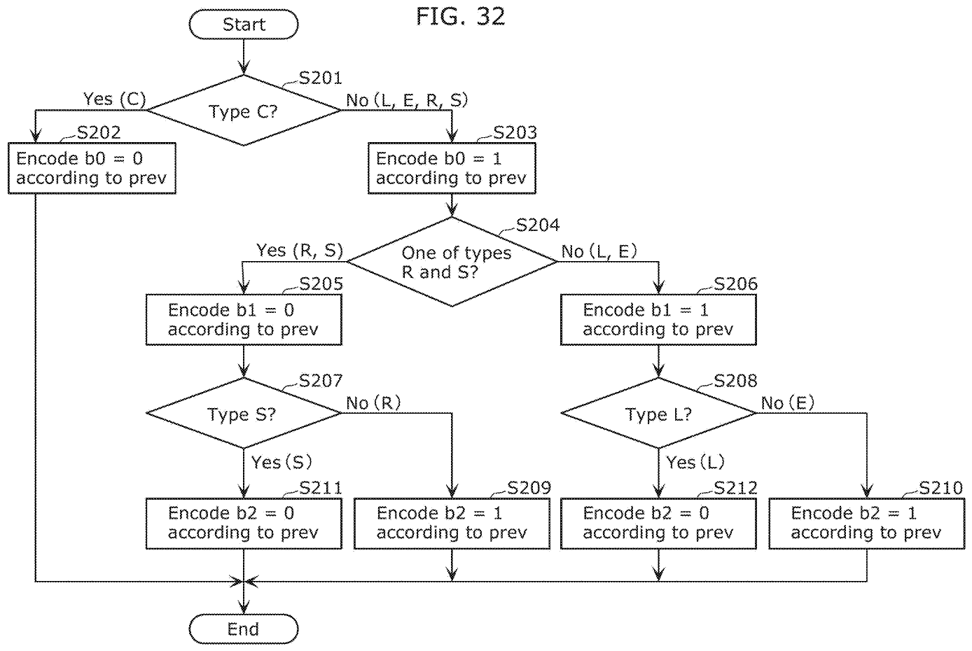

FIG. 32 is a flowchart illustrating a first specific example of the encoding of the connection type according to the present embodiment. Specifically, FIG. 32 illustrates an example of the encoding processing (S103) in FIG. 31. In this example, types C, L, E, R, and S are assigned bit patterns 0, 110, 111, 101, and 100, respectively, and the entropy encoding is performed starting from the most significant bit.

First, whether the connection type of the triangle to be encoded is type C is determined (S201). When the connection type is type C (Yes in S201), 0 is encoded as the value of first bit b0 by entropy encoding according to prev (S202). When the connection type is not type C (No in S201: the connection type is any of L, E, R, and S), 1 is encoded as the value of first bit b0 by entropy encoding according to prev (S203).

Then, whether the connection type of the triangle to be encoded is one of types R and S is determined (S204). When the connection type is one of types R and S (Yes in S204), 0 is encoded as the value of second bit b1 by entropy encoding according to prev (S205).

Then, whether the connection type of the triangle to be encoded is type S is determined (S207). When the connection type is type S (Yes in S207), 0 is encoded as the value of third bit b2 by entropy encoding according to prev (S211). When the connection type is not type S (No in S207: the connection type is R), 1 is encoded as the value of third bit b2 by entropy encoding according to prev (S209).

When the connection type is not one of types R and S (No in S204: the connection type is L or E), 1 is encoded as the value of second bit b1 by entropy encoding according to prev (S206).

Then, whether the connection type of the triangle to be encoded is type L is determined (S208). When the connection type is type L (Yes in S208), 0 is encoded as the value of third bit b2 by entropy encoding according to prev (S212). When the connection type is not type L (No in S208: the connection type is E), 1 is encoded as the value of third bit b2 by entropy encoding according to prev (S210).

Note that when arithmetic encoding is used for the entropy encoding, the context used for determining the predicted occurrence probability of information to be encoded is determined from among a plurality of contexts according to prev. When Huffman coding is used for the entropy encoding, the codeword table used for encoding is determined from among a plurality of codeword tables according to prev.

Furthermore, in the entropy encoding of the value of third bit b2 (S207 to S212), the context or codeword table may be determined according to the value of second bit b1 in addition to prev.

The tendency of the occurrence probability of each type encoded immediately after type S or E is different from the tendency of the occurrence probability of each type encoded immediately after type C, R, or L. Therefore, as described above, the control of the entropy encoding is switched according to prev determined in the procedure in FIG. 31. In this way, the encoding efficiency of the entropy encoding may be able to be improved.

In addition, the content of the event indicated by the value of third bit b2 depends on the value of second bit b1 (type S or R when b1=0, and type L or E when b1=1). Therefore, if the context or codeword table is determined according to the value of second bit b1 in addition to prev in the entropy encoding of the value of third bit b2, the encoding efficiency may be able to be further improved.

In the above description, encoding a bit may be inputting a bit to an encoding engine. Furthermore, in the encoding engine, a plurality of bits may be compressed into less bits.

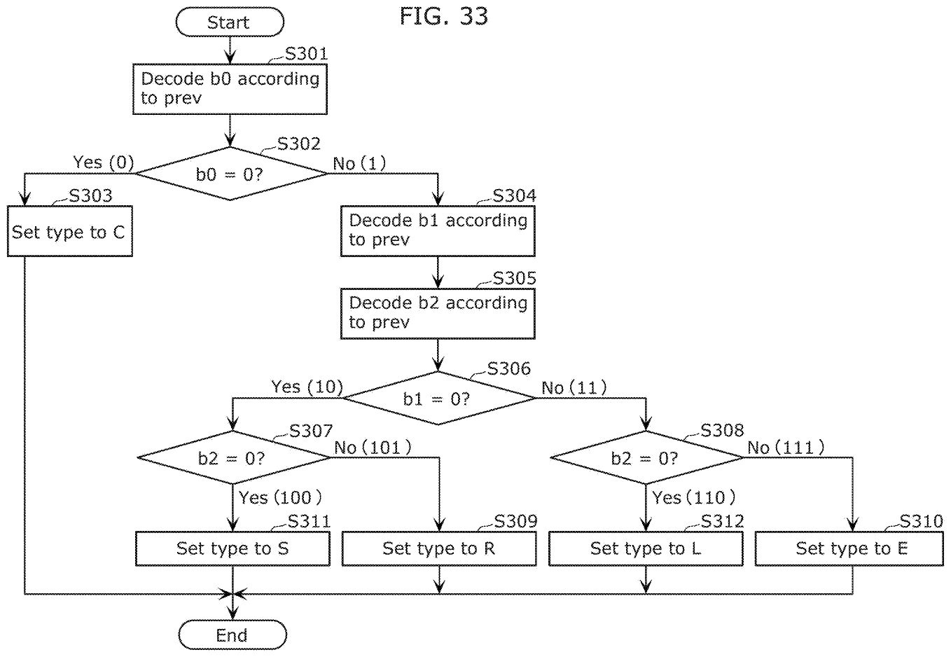

FIG. 33 is a flowchart illustrating a first specific example of the decoding of the connection type according to the present embodiment. Specifically, FIG. 33 illustrates an example of the decoding processing (S103) in FIG. 31. In this example, entropy decoding of the bit sequence encoded in the encoding method described above with reference to FIG. 32 is performed, and the connection type of the triangle to be decoded is set to any of types C, L, E, R, and S.

First, the value of first bit b0 is decoded by entropy decoding according to prev (S301). Then, whether the value of first bit b0 is 0 is determined (S302). When the value of first bit b0 is 0 (Yes in S302), the connection type of the triangle to be decoded is set to type C (S303).

When the value of first bit b0 is not 0 (No in S302), the value of second bit b1 is decoded by entropy decoding according to prev (S304). Furthermore, the value of third bit b2 is decoded by entropy decoding according to prev (S305). Then, the bit pattern of second bit b1 and third bit b2 is determined (S306 to S308). Then, according to the determination result, the connection type of the triangle to be decoded is set to any of types L, E, R, and S (S309 to S312).

Specifically, when the value of second bit b1 and the value of third bit b2 are 0 and 0, respectively (Yes in S306 and Yes in S307), the connection type is set to type S (S311). When the value of second bit b1 and the value of third bit b2 are 0 and 1, respectively (Yes in S306 and No in S307), the connection type is set to type R (S309).

When the value of second bit b1 and the value of third bit b2 are 1 and 0, respectively (No in S306 and Yes in S308), the connection type is set to type L (S312). When the value of second bit b1 and the value of third bit b2 are 1 and 1, respectively (No in S306 and No in S308), the connection type is set to type E (S310).

Note that when arithmetic decoding is used for the entropy decoding, the context used for determining the predicted occurrence probability of information to be decoded is determined from among a plurality of contexts according to prev. When Huffman decoding is used for the entropy decoding, the codeword table used for decoding is determined from among a plurality of codeword tables according to prev. Furthermore, in the entropy decoding of the value of third bit b2, the context or codeword table may be determined according to the value of second bit b1 in addition to prev.

The tendency of the occurrence probability of each type decoded immediately after type S or E is different from the tendency of the occurrence probability of each type decoded immediately after type C, R, or L, so that as described above, the control of the entropy decoding is switched according to prev determined in the procedure in FIG. 31. This may enable efficient decoding and a reduction of the coding amount.

In addition, the content of the event indicated by the value of third bit b2 depends on the value of second bit b1 (type S or R when b1=0, and type L or E when b1=1). Therefore, if the context or codeword table is determined according to the value of second bit b1 in addition to prev in the entropy decoding of the value of third bit b2, the coding amount may be able to be further reduced.

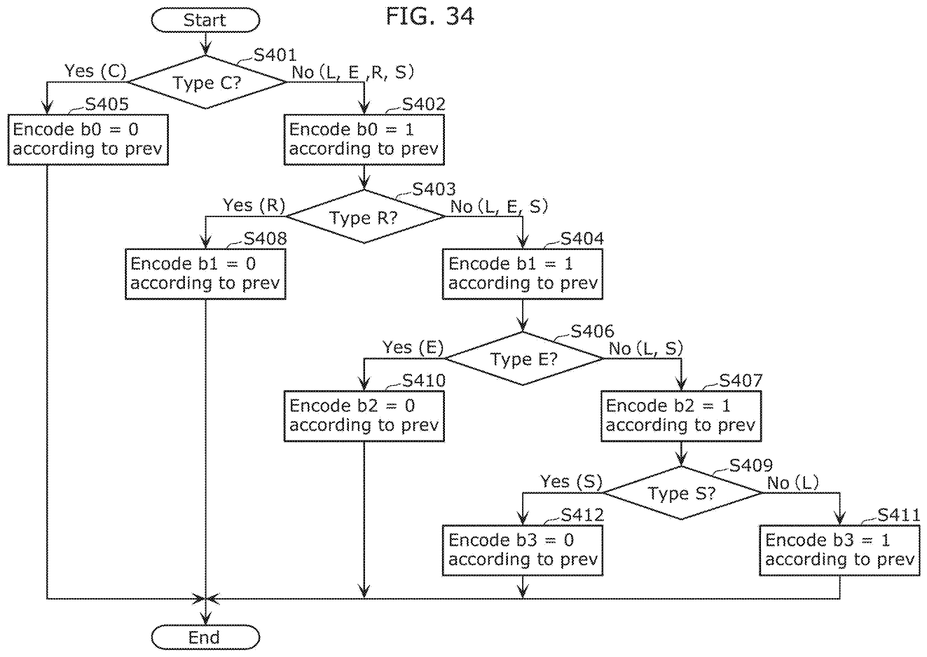

FIG. 34 is a flowchart illustrating a second specific example of the encoding of the connection type according to the present embodiment. Specifically, FIG. 34 illustrates an example of the encoding processing (S103) in FIG. 31. In this example, types C, R, E, S and L are assigned bit patterns 0, 10, 110, 1110, and 1111, respectively, and the entropy encoding is performed starting from the most significant bit.

First, whether the connection type of the triangle to be encoded is type C is determined (S401). When the connection type is type C (Yes in S401), 0 is encoded as the value of first bit b0 by entropy encoding according to prev (S405). When the connection type is not type C (No in S401: the connection type is any of L, E, R, and S), 1 is encoded as the value of first bit b0 by entropy encoding according to prev (S402).

Then, whether the connection type of the triangle to be encoded is type R is determined (S403). When the connection type is type R (Yes in S403), 0 is encoded as the value of second bit b1 by entropy encoding according to prev (S408). When the connection type is not type R (No in S403: the connection type is any of L, E, and S), 1 is encoded as the value of second bit b1 by entropy encoding according to prev (S404).

Then, whether the connection type of the triangle to be encoded is type E is determined (S406). When the connection type is type E (Yes in S406), 0 is encoded as the value of third bit b2 by entropy encoding according to prev (S410). When the connection type is not type E (No in S406: the connection type is any of L and S), 1 is encoded as the value of third bit b2 by entropy encoding according to prev (S407).

Then, whether the connection type of the triangle to be encoded is type S is determined (S409). When the connection type is type S (Yes in S409), 0 is encoded as the value of fourth bit b3 by entropy encoding according to prev (S412). When the connection type is not type S (No in S409: the connection type is L), 1 is encoded as the value of fourth bit b3 by entropy encoding according to prev (S411).

Note that when arithmetic encoding is used for the entropy encoding, the context used for determining the predicted occurrence probability of information to be encoded is determined from among a plurality of contexts according to prev. When Huffman coding is used for the entropy encoding, the codeword table used for encoding is determined from among a plurality of codeword tables according to prev.

The tendency of the occurrence probability of each type encoded immediately after type S or E is different from the tendency of the occurrence probability of each type encoded immediately after type C, R, or L. Therefore, as described above, the control of the entropy encoding is switched according to prev determined in the procedure in FIG. 31. In this way, the encoding efficiency of the entropy encoding may be able to be improved.

Furthermore, in the above description, types C, R, E, S, and L are assigned bit patterns 0, 10, 110, 1110, and 1111, respectively. However, the types determined in the determination processing (S401, S403, S406, and S409) can be set according to the way of assignment of bit patterns. In this way, any assignment is possible.

Furthermore, a type whose occurrence frequency is high may be assigned a short bit pattern. In this way, the encoding efficiency may be able to be improved. Therefore, types C and R, whose occurrence frequencies are high, may be assigned bit patterns 0 and 10, respectively.

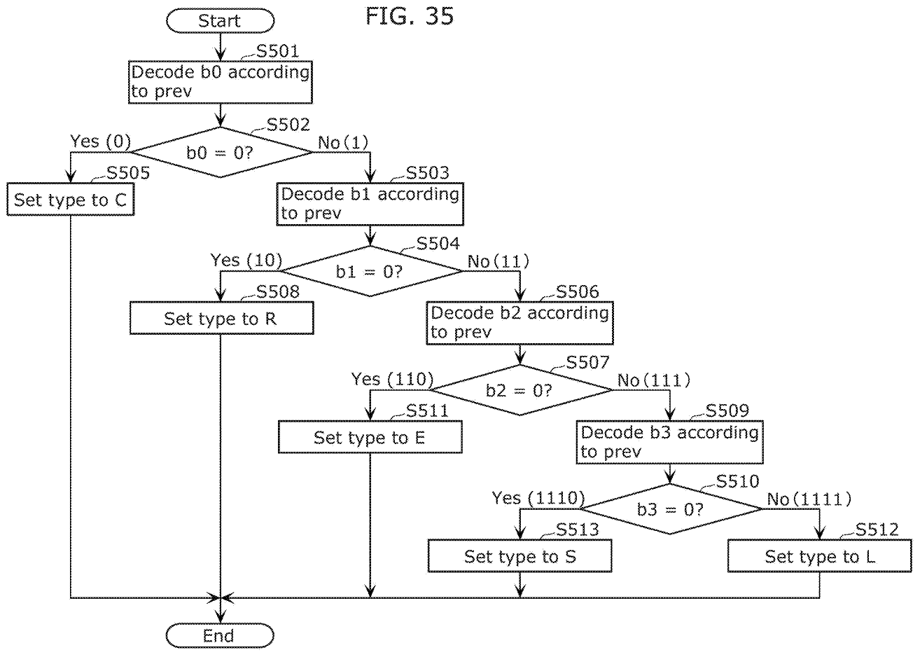

FIG. 35 is a flowchart illustrating a second specific example of the decoding of the connection type according to the present embodiment. Specifically, FIG. 35 illustrates an example of the decoding processing (S103) in FIG. 31. In this example, entropy decoding of the bit sequence encoded in the encoding method described above with reference to FIG. 34 is performed, and the connection type of the triangle to be decoded is set to any of types C, L, E, R, and S.

First, the value of first bit b0 is decoded by entropy decoding according to prev (S501). Then, whether the value of first bit b0 is 0 is determined (S502). When the value of first bit b0 is 0 (Yes in S502), the connection type of the triangle to be decoded is set to type C (S505). When the value of first bit b0 is not 0 (No in S502), the value of second bit b1 is decoded by entropy decoding according to prev (S503).

Then, whether the value of second bit b1 is 0 is determined (S504). When the value of second bit b1 is 0 (Yes in S504), the connection type of the triangle to be decoded is set to type R (S508). When the value of second bit b1 is not 0 (No in S504), the value of third bit b2 is decoded by entropy decoding according to prev (S506).

Then, whether the value of third bit b2 is 0 is determined (S507). When the value of third bit b2 is 0 (Yes in S507), the connection type of the triangle to be decoded is set to type E (S511). When the value of third bit b2 is not 0 (No in S507), the value of fourth bit b3 is decoded by entropy decoding according to prev (S509).

Then, whether the value of fourth bit b3 is 0 is determined (S510). When the value of fourth bit b3 is 0 (Yes in S510), the connection type of the triangle to be decoded is set to type S (S513). When the value of fourth bit b3 is not 0 (No in S510), the connection type of the triangle to be decoded is set to type L (S512).

Note that when arithmetic decoding is used for the entropy decoding, the context used for determining the predicted occurrence probability of information to be decoded is determined from among a plurality of contexts according to prev. When Huffman decoding is used for the entropy decoding, the codeword table used for decoding is determined from among a plurality of codeword tables according to prev.

The tendency of the occurrence probability of each type decoded immediately after type S or E is different from the tendency of the occurrence probability of each type decoded immediately after type C, R, or L, so that as described above, the control of the entropy decoding is switched according to prev determined in the procedure in FIG. 31. This may enable efficient decoding and a reduction of the coding amount.

Furthermore, in the above description, types C, R, E, S, and L are assigned bit patterns 0, 10, 110, 1110, and 1111, respectively. However, the types set in the setting processing (S505, S508, S511, S513, and S512) can be set according to the way of assignment of bit patterns. In this way, any assignment is possible.

Furthermore, a type whose occurrence frequency is high may be assigned a short bit pattern. In this way, the coding amount may be able to be reduced. Therefore, types C and R, whose occurrence frequencies are high, may be assigned bit patterns 0 and 10, respectively.

In the example described using FIGS. 31 to 35, the value of variable prev is set according to a type of the immediately previously encoded triangle. In addition, a parameter for controlling the entropy encoding of the connection type of the triangle is determined according to prev. Then, according to the parameter determined, entropy encoding of the connection type of the triangle to be encoded is performed.

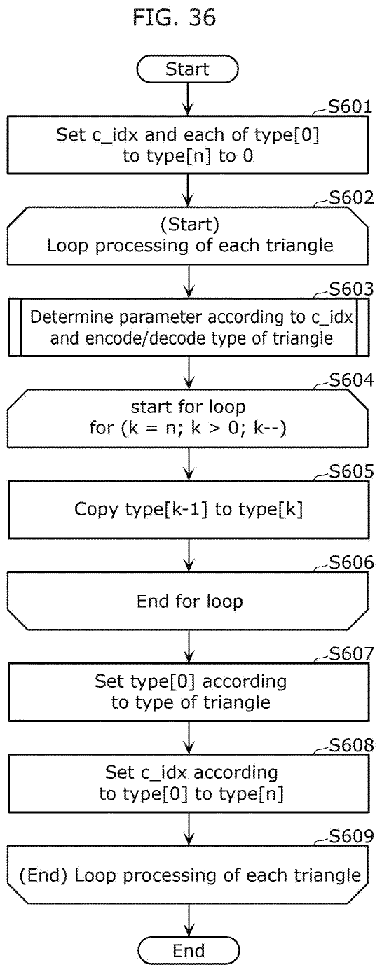

FIG. 36 is a flowchart illustrating another example of encoding processing and decoding processing for a connection type according to the present embodiment. Specifically, in this example, variable c_idx may be used in place of prev. For example, in addition to the connection type of the immediately previously encoded triangle, the value of c_idx is set also according to the connection types of n-number (where n is an integer greater than or equal to 1) of triangles encoded in the past. In other words, the value of c_idx is set according to the connection types of (n+1)-number of encoded triangles.

Specific processing in FIG. 36 will be described step by step. First, each of variables c_idx and type[0] to type[n] (where n is an integer greater than or equal to 1) is set to an initial value (for example, 0) (S601).

Variable c_idx is used to determine a parameter for controlling the entropy encoding of the connection type of the triangle. Variables type[0] to type[n] hold integers corresponding to the connection types of encoded triangles. Specifically, type[x] holds an integer corresponding to an (x+1)-th previous connection type and, for example, holds 0 for Type C, 1 for Type L, 2 for Type E, 3 for Type R, 4 for Type S, and the like.

Then, entropy encoding of the connection type of each triangle is repeated (S602 to S609). Specifically, first, a parameter for controlling entropy encoding of the connection type of the triangle is determined according to c_idx, and using the determined parameter, entropy encoding of the connection type of the triangle to be encoded is performed (S603).

For example, when arithmetic encoding is used for entropy encoding, a context used for determining a predicted occurrence probability of information to be encoded may be determined from among a plurality of contexts according to c_idx. Specifically, for example, a plurality of contexts may be stored as a one-dimensional array, and an element specified by c_idx from the one-dimensional array may be used as a context.

Alternatively, when Huffman coding is used for entropy encoding, a codeword table used for encoding may be determined from among a plurality of codeword tables according to c_idx.

Next, in loop processing (S604 to S606), each of type[1] to type[n] is updated to an integer corresponding to the connection type of the previously encoded triangle. In other words, for each k from n to 1, a value of type[k-1] is copied to type[k] (S605).

Next, type[0] is set to an integer corresponding to the connection type of the triangle encoded in the current encoding processing (S603) (S607). Then, c_idx is set according to type[0] to type[n] (S608). This c_idx is used when encoding the connection type of a next triangle.

A specific example of setting c_idx (S608) is as follows. For example, idx_x (0≤x≤n) is determined according to type[x]. In this case, type[x] can take five possible values. On the other hand, idx_x can take five or fewer possible values. Furthermore, c_idx may be set using an (n+1)-dimensional array by c_idx=array [idx_0] [idx_1] . . . [idx_n]. According to this configuration, a value of c_idx may be set according to a combination of idx_0, idx_1, . . . , idx_n.

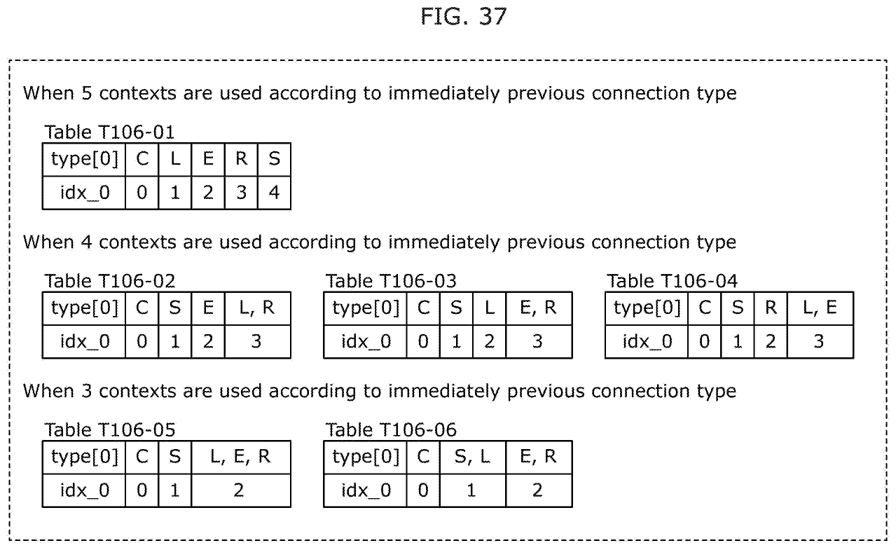

FIG. 37 is a relationship diagram illustrating an example of a correspondence between an immediately previous connection type and values used to determine a context according to the present embodiment. For example, as illustrated in Table T106-01, five values of idx_0 are associated with five values of type[0]. In this case, five contexts are used according to the immediately previous connection type.

In addition, for example, as illustrated in Table T106-02, Table T106-03, and Table T106-04, four values of idx_0 are associated with the five values of type[0]. In this case, five contexts are used according to the immediately previous connection type. In addition, for example, as illustrated in Table T106-05 and Table T106-06, three values of idx_0 are associated with the five values of type[0]. In this case, three contexts are used according to the immediately previous connection type.

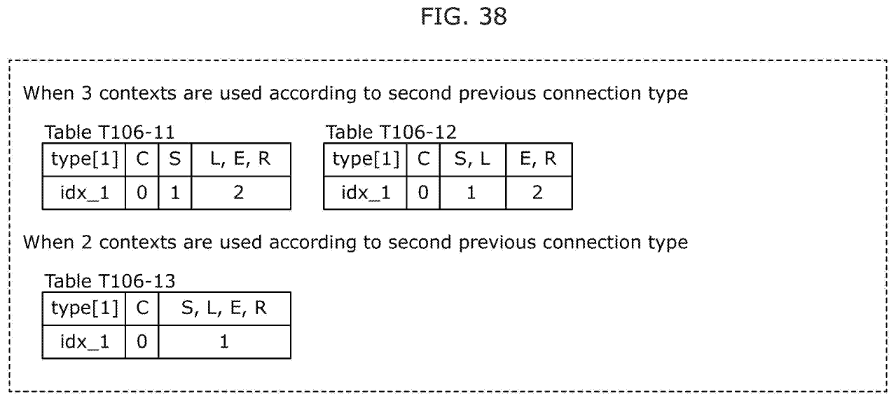

FIG. 38 is a relationship diagram illustrating an example of a correspondence between a second previous connection type and values used to determine a context according to the present embodiment. For example, as illustrated in Table T106-11 and Table T106-12, three values of idx_1 are associated with five values of type[1]. In this case, three contexts are used according to the second previous connection type.

In addition, for example, as illustrated in Table T106-13, two values of idx_1 are associated with the five values of type[1]. In this case, two contexts are used according to the second previous connection type.

For example, when n=1, c_idx is determined according to the connection type of the immediately previous triangle and the connection type of the second previous triangle, and the context is determined according to c_idx. In this case, a combination of one table from Table T106-01 to Table T106-06 and one table from Table T106-11 to Table T106-13 may be used. Then, idx_0 and idx_1 are defined by the two tables, c_idx is determined by c_idx=array [idx_0] [idx_1], and the context is determined by c_idx.

In addition, for example, when four contexts are used according to the connection type of the immediately previous triangle and three contexts are used according to the connection type of the second previous triangle, 12 contexts may be used by combining the four contexts and the three contexts.

Note that an example of setting c_idx according to an array has been described above. However, a method for setting a context used to encode the connection type of a triangle to be encoded according to the connection types of (n+1)-number of encoded triangles is not limited to methods based on an array. For example, c_idx may be determined by the following equation.

$${c}_{idx} = idx\_ 0 + {\sum }_{k = 1}^{n} ( idx\_k \times {\prod }_{j = 0}^{k - 1} N ( j ) ) \qquad [ Math . 1 ]$$

Here, N(k) denotes the number of elements in idx_k (k=0, . . . , n−1). For example, when Table T106-01 is used, N(0) is expressed as 5, and when Table T106-11 is used, N(1) is expressed as 3. Alternatively, the context may be stored in an (n+1)-dimensional array, and the context may be directly determined based on the combination of idx_0, idx_1, . . . , idx_n.

The inventors obtained the following findings as a result of their trials. Type C occurs frequently, and type C also occurs consecutively frequently. Therefore, by making the context when type C has been immediately previously and second previously encoded independent of contexts in other cases, efficient encoding and a reduction in the coding amount may become possible.

In addition, a trend of the occurrence probability for each type encoded immediately after type S differs from a trend of the occurrence probability of each type encoded immediately after other types. Therefore, by making the context when type S has been immediately previously and second previously encoded independent of contexts in other cases, efficient encoding and a reduction of the coding amount may become possible.

Specifically, using Table T106-01 to Table T106-05, Table T106-11, and the like may make efficient encoding and reduction of the coding amount possible.

Furthermore, in order to reduce memory utilization, the context of one of type C and type S may be integrated with the context of the other of type C and type S. The inventors found that, in this case, it may be possible to reduce memory utilization while suppressing an increase in the coding amount by integrating a context of type S with contexts of other types while maintaining the independence of a context of type C. Specifically, using Table T106-06, Table T106-12, Table T106-13, and the like, it may be possible to reduce memory utilization while suppressing an increase in the coding amount.

Note that in the example in FIG. 36, a value of 0 to 4 is set to type[n] according to the connection type of the triangle. However, a different method may be used to identify the connection type of the triangle. In addition, in Table T106-01 to Table T106-06 and Table T106-11 to Table T106-13, a value of 0 to 4 is set to idx_n according to the connection type of the triangle. However, a different method may be used to uniquely determine an element of an array according to the connection type of the triangle.

In addition, an example of encoding is described above. However, by substituting “decoding” for “encoding”, similar examples can be applied to decoding.

Note that a shape of a face is not limited to a triangle and other shapes may be used. For example, a polygon other than a triangle may be used. In addition, whether or not to determine a context based on the connection type of a processed polygon may be switched, and a polygon, a group of a connection type, and a correspondence of a context used as a determination criterion of the context may be switched. In this case, a parameter indicating the switching, the correspondence, and the like may be encoded.

In addition, in any of the aspects of the present disclosure, instead of setting a context for arithmetic encoding of a connection type of a polygon to be processed according to the connection type of a processed polygon, a parameter indicating the context may be derived according to the connection type of the processed polygon. For example, the parameter indicating the context may be derived through an operation using the value of prev or c_idx.

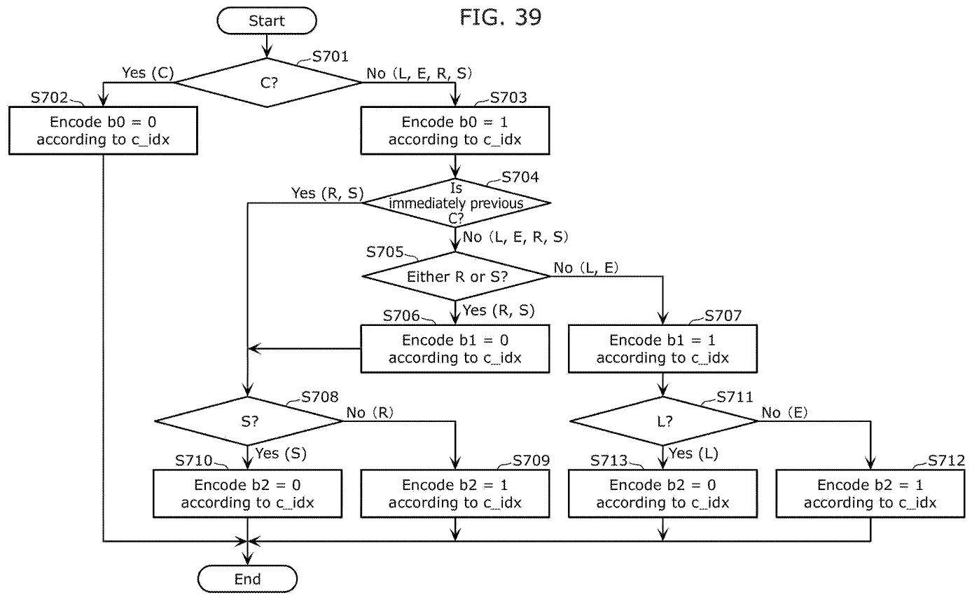

FIG. 39 is a flowchart illustrating a third specific example of encoding of the connection type according to the present embodiment. Specifically, FIG. 39 illustrates an example of the encoding processing (S603) in FIG. 36. In this example, types C, L, E, R, and S are assigned bit patterns 0, 110, 111, 101, and 100, respectively, and the entropy encoding is performed starting from the most significant bit.

First, whether the connection type of the triangle to be encoded is type C is determined (S701). When the connection type is type C (Yes in S701), 0 is encoded as the value of first bit b0 by entropy encoding according to prev (S702). When the connection type is not type C (No in S701: the connection type is any of L, E, R, and S), 1 is encoded as the value of first bit b0 by entropy encoding according to c_idx (S703).

Next, whether or not the connection type of the previously (immediately previously) encoded triangle is type C is determined (S704). When the connection type of the previously encoded triangle is type C (Yes in S704), the connection type of the triangle to be encoded is determined to be neither type E nor type L. Then, whether or not the connection type is type S is determined without encoding the value of second bit b1 (S708).

When the connection type of the previously encoded triangle is not type C (No in S704), whether or not the connection type of the triangle to be encoded is either type R or type S is determined (S705). When the connection type is either type R or type S (Yes in S705), 0 is encoded as the value of second bit b1 by entropy encoding according to c_idx (S706).

Then, whether or not the connection type of the triangle to be encoded is type S is determined (S708). When the connection type is type S (Yes in S708), 0 is encoded as the value of third bit b2 by entropy encoding according to c_idx (S710). When the connection type is not type S (No in S708: the connection type is R), 1 is encoded as the value of third bit b2 by entropy encoding according to c_idx (S709).

When the connection type is neither type R nor type S (No in S705: the connection type is L or E), 1 is encoded as the value of second bit b1 by entropy encoding according to c_idx (S707). Then, whether or not the connection type of the triangle to be encoded is type L is determined (S711). When the connection type is type L (Yes in S711), 0 is encoded as the value of third bit b2 by entropy encoding according to c_idx (S713). When the connection type is not type L (No in S711: the connection type is E), 1 is encoded as the value of third bit b2 by entropy encoding according to c_idx (S712).

Note that when arithmetic encoding is used for entropy encoding, a context used for determining a predicted occurrence probability of information to be encoded is determined from among a plurality of contexts according to c_idx. When Huffman coding is used for entropy encoding, a codeword table used for encoding is determined from among a plurality of codeword tables according to c_idx.

In addition, in the entropy encoding of the value of third bit b2 (S709, S710, S712, and S713), the context or the codeword table may be determined according to the value of second bit b1 in addition to c_idx. Here, when the previous connection type is type C, since the connection type of the triangle to be encoded is either type R or type S, 0 is used as the value of second bit b1.

Neither type L nor type E can logically occur immediately after type C. Therefore, immediately after type C, by omitting the encoding of second bit b1 for identifying type L and type E and only encoding the two bits of first bit b0 and third bit b2, it may be possible to encode the connection type of the triangle with a smaller coding amount.

In addition, it may be possible to suppress the coding amount of the connection type of the triangle by always using the same context for encoding second bit b1 immediately after type C instead of omitting the encoding of second bit b1.

In addition, the content of the event indicated by the value of third bit b2 depends on the value of second bit b1 (type S or R when b1=0, and type L or E when b1=1). Therefore, if the context or codeword table is determined according to the value of second bit b1 in addition to c_idx in the entropy encoding of the value of third bit b2, it may be possible to further reduce the coding amount.

In addition, bit patterns 0, 011, 111, 101, and 001 may be assigned to types C, L, E, R, and S, respectively. Alternatively, unnecessary leading zeros may be omitted and bit patterns 0, 11, 111, 101, and 1 may be assigned to types C, L, E, R, and S, respectively. In addition, entropy encoding may be performed starting from the least significant bit.

Accordingly, types C, L, E, R, and S are assigned bit patterns 0, 110, 111, 101, and 100, respectively, and an operation corresponding to the operation described above in which entropy encoding is performed starting from the most significant bit can be performed.

In the above description, encoding a bit may be inputting a bit to an encoding engine. Furthermore, in the encoding engine, a plurality of bits may be compressed into less bits.

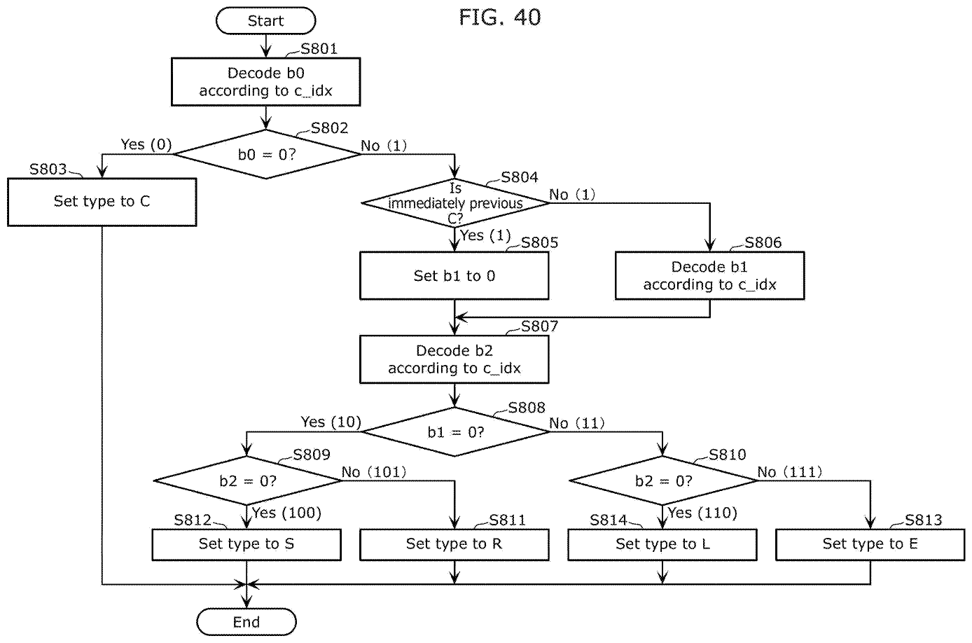

FIG. 40 is a flowchart illustrating a third specific example of decoding of the connection type according to the present embodiment. Specifically, FIG. 40 illustrates an example of the decoding processing (S603) in FIG. 36. In this example, entropy decoding of the bit sequence encoded in the encoding method described above with reference to FIG. 39 is performed, and the connection type of the triangle to be decoded is set to any of types C, L, E, R, and S.

First, the value of first bit b0 is decoded by entropy decoding according to c_idx (S801). Then, whether the value of first bit b0 is 0 is determined (S802). When the value of first bit b0 is 0 (Yes in S802), the connection type of the triangle to be decoded is set to type C (S803). When the value of first bit b0 is not 0 (No in S802), whether or not the connection type of the previously (immediately previously) decoded triangle is type C is determined (S804).

When the connection type of the previously decoded triangle is type C (Yes in S804), the connection type of the triangle to be decoded is determined to be neither type E nor type L. Then, without decoding the value of second bit b1, the value of second bit b1 is set to 0 (S805). When the connection type of the previously decoded triangle is not type C (No in S804), the value of second bit b1 is decoded by entropy decoding according to c_idx (S806).

Next, the value of third bit b2 is decoded by entropy decoding according to c_idx (S807). Then, the bit pattern of second bit b1 and third bit b2 is determined (S808 to S810). Then, according to the determination result, the connection type of the triangle to be decoded is set to any of types L, E, R, and S (S811 to S814).

Specifically, when the value of second bit b1 and the value of third bit b2 are 0 and 0, respectively (Yes in S808 and Yes in S809), the connection type is set to type S (S812). When the value of second bit b1 and the value of third bit b2 are 0 and 1, respectively (Yes in S808 and No in S809), the connection type is set to type R (S811).

When the value of second bit b1 and the value of third bit b2 are 1 and 0, respectively (No in S808 and Yes in S810), the connection type is set to type L (S814). When the value of second bit b1 and the value of third bit b2 are 1 and 1, respectively (No in S808 and No in S810), the connection type is set to type E (S813).

Note that when arithmetic decoding is used for the entropy decoding, the context used for determining the predicted occurrence probability of information to be decoded is determined from among a plurality of contexts according to c_idx. When Huffman decoding is used for the entropy decoding, the codeword table used for decoding is determined from among a plurality of codeword tables according to c_idx. Furthermore, in the entropy decoding of the value of third bit b2 (S807), the context or codeword table may be determined according to the value of second bit b1 in addition to c_idx.

Neither type L nor type E can logically occur immediately after type C. Therefore, immediately after type C, by omitting the decoding of second bit b1 for identifying type L and type E and only decoding the two bits of first bit b0 and third bit b2, it may be possible to decode the connection type of the triangle with a smaller coding amount.

In addition, it may be possible to suppress the coding amount of the connection type of the triangle by always using the same context for decoding second bit b1 immediately after type C instead of omitting the decoding of second bit b1.

In addition, the content of the event indicated by the value of third bit b2 depends on the value of second bit b1 (type S or R when b1=0, and type L or E when b1=1). Therefore, by determining the context or codeword table according to the value of second bit b1 in addition to c_idx in the entropy decoding of the value of third bit b2, it may be possible to further reduce the coding amount.

In addition, bit patterns 0, 011, 111, 101, and 001 may be assigned to types C, L, E, R, and S, respectively. Alternatively, unnecessary leading zeros may be omitted and bit patterns 0, 11, 111, 101, and 1 may be assigned to types C, L, E, R, and S, respectively. In addition, entropy decoding may be performed starting from the least significant bit.

Accordingly, types C, L, E, R, and S are assigned bit patterns 0, 110, 111, 101, and 100, respectively, and an operation corresponding to the operation described above in which entropy decoding is performed starting from the most significant bit can be performed.

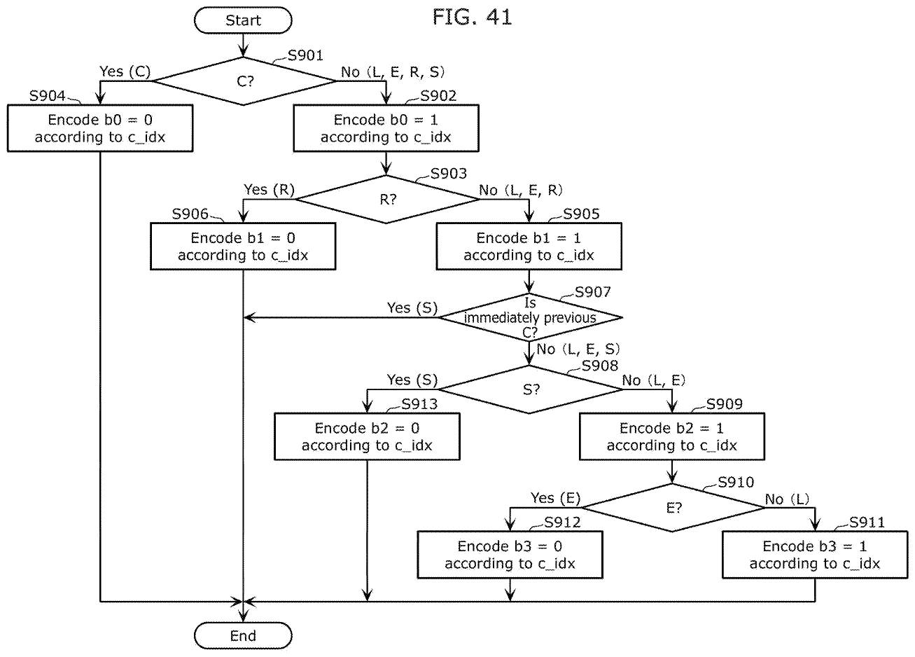

FIG. 41 is a flowchart illustrating a fourth specific example of encoding of the connection type according to the present embodiment. Specifically, FIG. 41 illustrates an example of the encoding processing (S603) in FIG. 36. In this example, types C, R, E, S and L are assigned bit patterns 0, 10, 110, 1110, and 1111, respectively, and the entropy encoding is performed starting from the most significant bit.

First, whether or not the connection type of the triangle to be encoded is type C is determined (S901). When the connection type is type C (Yes in S901), 0 is encoded as the value of first bit b0 by entropy encoding according to c_idx (S904). When the connection type is not type C (No in S901: the connection type is any of L, E, R, and S), 1 is encoded as the value of first bit b0 by entropy encoding according to c_idx (S902).

Next, whether or not the connection type of the triangle to be encoded is type R is determined (S903). When the connection type is type R (Yes in S903), 0 is encoded as the value of second bit b1 by entropy encoding according to c_idx (S906). When the connection type is not type R (No in S903: the connection type is any of L, E, and S), 1 is encoded as the value of second bit b1 by entropy encoding according to c_idx (S905).

Next, whether or not the connection type of the previously (immediately previously) encoded triangle is type C is determined (S907). When the connection type of the previously encoded triangle is type C (Yes in S907), the connection type of the triangle to be encoded is determined to be neither type E nor type L. Then, without encoding the value of third bit b2, the processing ends.

When the connection type of the previously encoded triangle is not type C (No in S907), whether or not the connection type of the triangle to be encoded is type S is determined (S908). When the connection type is type S (Yes in S908), 0 is encoded as the value of third bit b2 by entropy encoding according to c_idx (S913). When the connection type is not type S (No in S908: the connection type is either L or E), 1 is encoded as the value of third bit b2 by entropy encoding according to c_idx (S909).

Next, whether or not the connection type of the triangle to be encoded is type E is determined (S910). When the connection type is type E (Yes in S910), 0 is encoded as the value of fourth bit b3 by entropy encoding according to c_idx (S912). When the connection type is not type E (No in S910: the connection type is L), 1 is encoded as the value of fourth bit b3 by entropy encoding according to c_idx (S911).

Note that when arithmetic encoding is used for entropy encoding, a context used for determining a predicted occurrence probability of information to be encoded is determined from among a plurality of contexts according to c_idx. When Huffman coding is used for entropy encoding, a codeword table used for encoding is determined from among a plurality of codeword tables according to c_idx.

Neither type L nor type E can logically occur immediately after type C. Therefore, immediately after type C, by omitting the encoding of third bit b2 for identifying type L and type E and only encoding the two bits of first bit b0 and second bit b1, it may be possible to encode the connection type of the triangle with a smaller coding amount.

In addition, it may be possible to suppress the coding amount of the connection type of the triangle by always using the same context for encoding third bit b2 immediately after type C instead of omitting the encoding of third bit b2.

In addition, in the above description, types C, R, S, E, and L are assigned bit patterns 0, 10, 110, 1110, and 1111, respectively. However, the types determined in the determination processing (S901, S903, S908, and S910) can be set according to the way of assignment of bit patterns. In this way, any assignment is possible.

For example, as described above, types E and L may be assigned bit patterns 1110 and 1111, respectively. Alternatively, types E and L may be assigned bit patterns 1111 and 1110, respectively. Accordingly, it may be possible to omit encoding of third bit b2 immediately after type C.

Furthermore, a type whose occurrence frequency is high may be assigned a short bit pattern. Accordingly, efficient encoding and a reduction of the coding amount may be possible. Therefore, as described above, types C and R whose occurrence frequencies are high may be assigned bit patterns 0 and 10, respectively. Alternatively, types C and R may be assigned bit patterns 10 and 0, respectively.

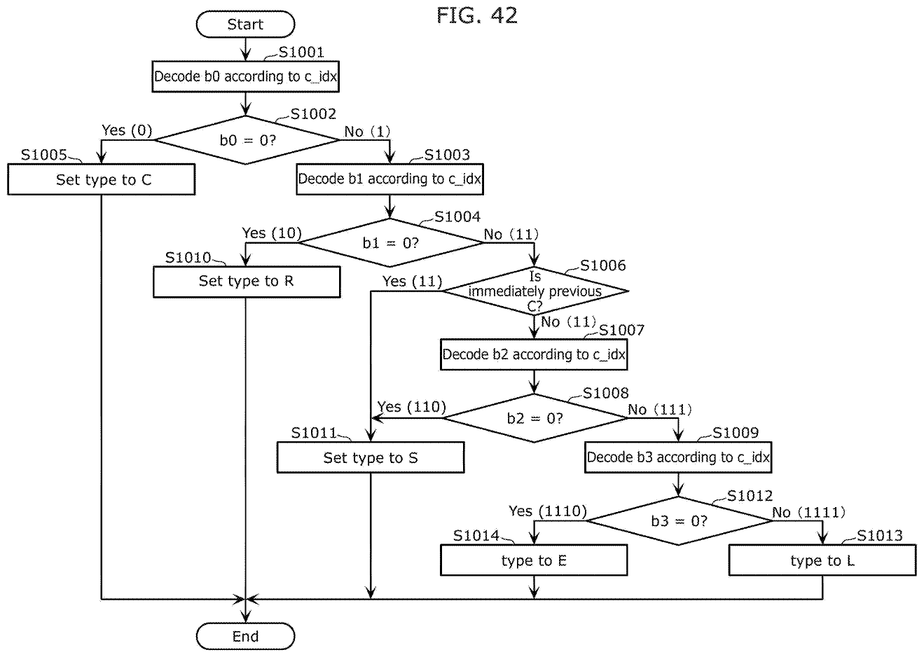

FIG. 42 is a flowchart illustrating a fourth specific example of decoding of the connection type according to the present embodiment. Specifically, FIG. 42 illustrates an example of the decoding processing (S603) in FIG. 36. In this example, entropy decoding of the bit sequence encoded in the encoding method described above with reference to FIG. 41 is performed, and the connection type of the triangle to be decoded is set to any of types C, L, E, R, and S.

First, the value of first bit b0 is decoded by entropy decoding according to c_idx (S1001). Then, whether or not the value of first bit b0 is 0 is determined (S1002). When the value of first bit b0 is 0 (Yes in S1002), the connection type of the triangle to be decoded is set to type C (S1005). When the value of first bit b0 is not 0 (No in S1002), the value of second bit b1 is decoded by entropy decoding according to c_idx (S1003).

Then, whether or not the value of second bit b1 is 0 is determined (S1004). When the value of second bit b1 is 0 (Yes in S1004), the connection type of the triangle to be decoded is set to type R (S1010). When the value of second bit b1 is not 0 (No in S1004), whether or not the connection type of the previously (immediately previously) decoded triangle is type C is determined (S1006).

When the connection type of the previously decoded triangle is type C (Yes in S1006), the connection type of the triangle to be decoded is determined to be type S. Then, without decoding the value of third bit b2, the connection type of the triangle to be decoded is set to type S (S1011). When the connection type of the previously decoded triangle is not type C (No in S1006), the value of third bit b2 is decoded by entropy decoding according to c_idx (S1007).

Then, whether or not the value of third bit b2 is 0 is determined (S1008). When the value of third bit b2 is 0 (Yes in S1008), the connection type of the triangle to be decoded is set to type S (S1011). When the value of third bit b2 is not 0 (No in S1008), the value of fourth bit b3 is decoded by entropy decoding according to c_idx (S1009).

Then, whether or not the value of fourth bit b3 is 0 is determined (S1012). When the value of fourth bit b3 is 0 (Yes in S1012), the connection type of the triangle to be decoded is set to type E (S1014). When the value of fourth bit b3 is not 0 (No in S1012), the connection type of the triangle to be decoded is set to type L (S1013).

Note that when arithmetic decoding is used for the entropy decoding, the context used for determining the predicted occurrence probability of information to be decoded is determined from among a plurality of contexts according to c_idx. When Huffman decoding is used for the entropy decoding, the codeword table used for decoding is determined from among a plurality of codeword tables according to c_idx.

Neither type L nor type E can logically occur immediately after type C. Therefore, immediately after type C, by omitting the decoding of third bit b2 for identifying type L and type E and only decoding the two bits of first bit b0 and second bit b1, it may be possible to decode the connection type of the triangle with a smaller coding amount.

In addition, it may be possible to suppress the coding amount of the connection type of the triangle by always using the same context for decoding third bit b2 immediately after type C instead of omitting the decoding of third bit b2.

In addition, in the above description, types C, R, S, E, and L are assigned bit patterns 0, 10, 110, 1110, and 1111, respectively. However, the types to be set in the setting processing (S1005, S1010, S1011, S1014, and S1013) may be set according to the way of assignment of bit patterns. In this way, any assignment is possible.

For example, as described above, types E and L may be assigned bit patterns 1110 and 1111, respectively. Alternatively, types E and L may be assigned bit patterns 1111 and 1110, respectively. Accordingly, it may be possible to omit decoding of third bit b2 immediately after type C.

Furthermore, a type whose occurrence frequency is high may be assigned a short bit pattern. Accordingly, it may be possible to reduce the coding amount. Therefore, as described above, types C and R whose occurrence frequencies are high may be assigned bit patterns 0 and 10, respectively. Alternatively, types C and R may be assigned bit patterns 10 and 0, respectively.

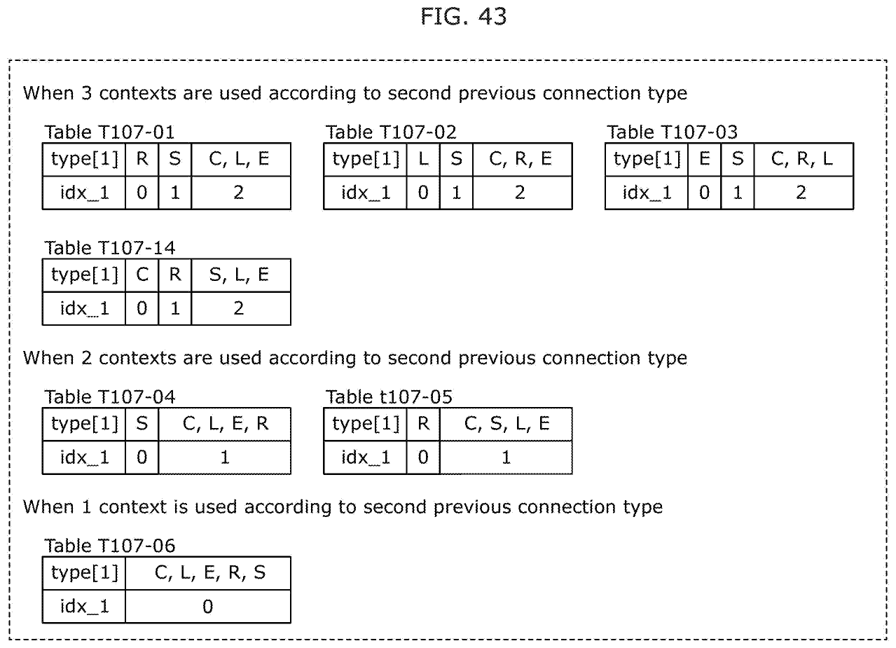

FIG. 43 is a relationship diagram illustrating another example of a correspondence between a second previous connection type and values used to determine a context according to the present embodiment. For example, in the setting processing (S608) in FIG. 36, when n=1, c_idx is set using the values illustrated in FIG. 38 according to each type of triangle. The values illustrated in FIG. 43 may be used instead of the values illustrated in FIG. 38.

For example, as illustrated in Table T107-01 to Table T107-03 and Table T107-14, three values of idx_1 are associated with five values of type[1]. In this case, two contexts are used according to the second previous connection type. In addition, for example, as illustrated in Table T107-04 and Table T107-05, two values of idx_1 are associated with the five values of type[1]. In this case, two contexts are used according to the second previous connection type.

In addition, for example, as illustrated in Table T107-06, one value of idx_1 is associated with the five values of type[1]. In this case, one context is used according to the second previous connection type.

Furthermore, the table used to determine idx_1 may be determined according to the connection type (type[0]) of the previously (immediately previously) encoded/decoded triangle. Specifically, when idx_0 is determined using Table T106-01, the table for determining idx_1 may be determined as follows.
(1) When the connection type of the previously encoded or decoded triangle is type C, then Table T107-05 or Table T107-06 may be used.
(2) When the connection type of the previously encoded or decoded triangle is type S, then Table T107-06 may be used.
(3) When the connection type of the previously encoded or decoded triangle is type L, then Table T107-01 or Table T107-06 may be used.
(4) When the connection type of the previously encoded or decoded triangle is type R, then Table T107-02, Table T107-14, or Table T106-13 may be used.
(5) When the connection type of the previously encoded or decoded triangle is type E, then Table T107-03 or Table T107-04 may be used.

The inventors obtained the following findings as a result of their trials. If the previous (immediately previous) connection type differs, a correspondence between the connection type of the triangle to be encoded and the second previous connection type differs. Therefore, by switching the second previous type to be made independent in the determination of a context according to the previous (immediately previous) type, it may be possible to improve encoding efficiency of the entropy encoding. As a result, by using the combinations described above, it may be possible to reduce memory utilization while suppressing a decline in encoding efficiency of the entropy encoding.

In addition, in any of the aspects of the present disclosure, instead of setting a context for arithmetic encoding of a connection type of a polygon to be processed according to the connection type of a processed polygon, a parameter indicating the context may be derived according to the connection type of the processed polygon. For example, the parameter indicating the context may be derived through an operation using the value of prev or c_idx.

As described above, when the connection type of the immediately previous triangle is type C, the connection type of the triangle to be processed is neither type L nor type E. Specifically, for example, as illustrated in FIG. 29, when the connection type of the triangle to be processed is type C, a triangle that is not yet processed is connected to the left side of a next triangle. On the other hand, when the connection type of the triangle is type L or type E, a triangle that is not yet processed is not connected to the left side of the triangle. Therefore, when the connection type of the triangle to be processed is type C, the connection type of the next triangle is neither type L nor type E.

As a result, when the connection type of the immediately previous triangle is type C, information for identifying the connection type of the triangle to be processed is encoded from a candidate set of types C, R, and S. Accordingly, it may be possible to reduce the coding amount as compared to encoding information for identifying the connection type from a candidate set of all types.

Here, when the connection type of the immediately previous triangle is type C, a candidate set of types C, R, and S is used as the candidate set of connection types of the triangle to be processed. However, the candidate set of connection types to be processed is not limited to this example and may be defined by a previously processed connection type.

In the above example, values shown in Table T106-01 to Table 106-06 in FIG. 37 and Table T107-01 to Table T107-06 and Table T107-14 in FIG. 43 are set to idx_0 and idx_1 according to the connection types of (n+1)-number (here n=1) of encoded triangles. Next, c_idx is set according to idx_0 and idx_1 (S608 in FIG. 36). Additionally, c_idx may be set according to Crun that indicates the number of types C encoded consecutively, in addition to the connection types of (n+1)-number of encoded triangles.

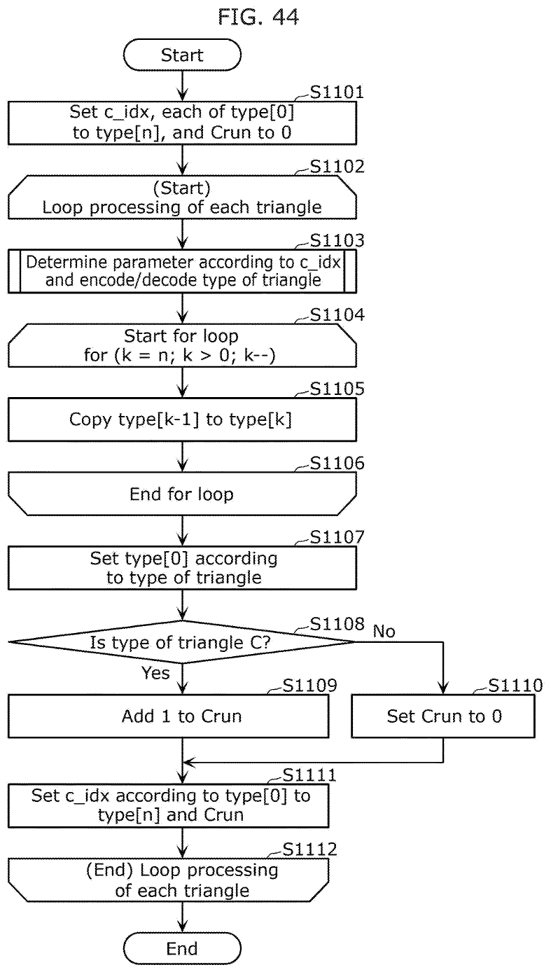

FIG. 44 is a flowchart illustrating another example of encoding processing and decoding processing for a connection type according to the present embodiment. In this procedure, processes related to initialization, update, and use of Crun are added. The other portions are the same as those of the procedure shown in FIG. 36. The following describes the additional portions.

Specifically, setting Crun to 0 is added in an initialization process (S1101). Moreover, adding 1 to Crun according to the connection type of the triangle (S1109) or setting Crun to 0 (S1110) is added in an update process (S1108 to S1110). Furthermore, using Crun is added in a c_idx setting process (S1111).

As a result of the above, the number of types C encoded consecutively is set to Crun. Then, in the c_idx setting process (S1111), c_idx is set using the number of types C encoded consecutively, in addition to the connection types of (n+1)-number of encoded triangles.

Here, specifically, the number of types C encoded consecutively corresponds to the number of one or more types C encoded consecutively up to previous (immediately previous) type C, and corresponds to the number of one or more connection types each of which is encoded consecutively as type C up to a previous connection type. In addition, the number of types C encoded consecutively may be expressed as, for example, the run count of type C, the run length of type C, the run count of a value equal to type C, the run length of a value equal to type C, or the number of types C of triangles encoded consecutively. Additionally, type C corresponds to the above-described corner type.

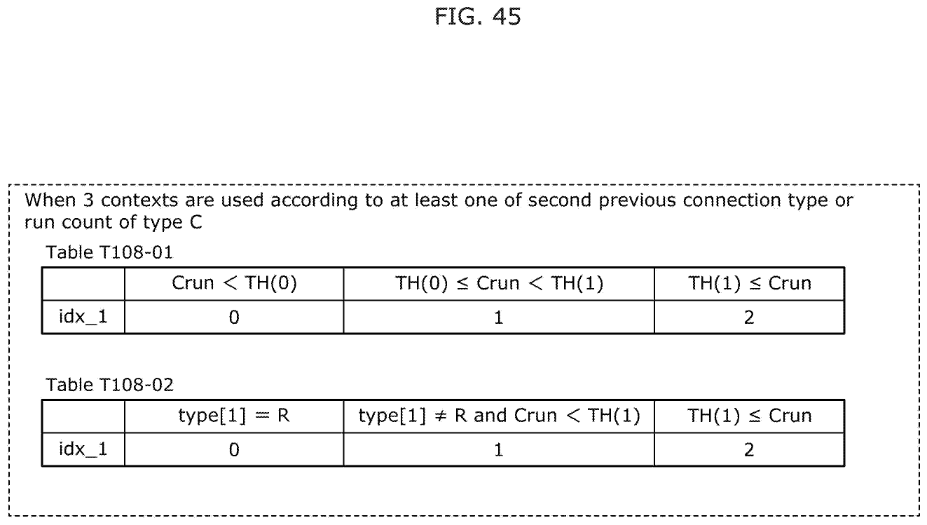

FIG. 45 is a relationship diagram illustrating an example of a correspondence between at least one of a second previous connection type or the run count of type C and values used to determine a context according to the present embodiment. In this example, three values and three contexts are used for idx_1 according to at least one of the second previous connection type or the run count of type C.

Specifically, when the connection type (type[0]) of a previously (immediately previously) encoded triangle is type C, idx_1 for setting c_idx may be determined using the example of Table T108-01 in FIG. 45 in the c_idx setting process (S1111). In the example of Table T108-01, when Crun is less than threshold value TH(0), idx_1 is set to 0; when Crun is greater than or equal to threshold value TH(0) and less than threshold value TH(1), idx_1 is set to 1; and when Crun is greater than or equal to threshold value TH(1), idx_1 is set to 2.

Here, threshold value TH(0) is less than threshold value TH(1). As a specifically set value, threshold value TH(0) may be 2 or a value greater than or equal to 2 and less than or equal to 4. Threshold value TH(1) may be 7 or a value greater than or equal to 5.

When 2 or a value close to 2 is used as threshold value TH(0), different contexts are used between a case in which type C does not occur consecutively and the run count of type C is few and a case in which type C occurs consecutively. Consequently, this may allow the connection type of the next triangle to be encoded according to an occurrence probability of the connection type of the next triangle in each of the cases. Accordingly, there is a possibility of improving the encoding efficiency.

It should be noted that when threshold value TH(0) is 2, the condition Crun <TH(0) in the example of Table T108-01 may be determined by another method that makes it possible to achieve the same result. For example, a condition that type[0] is a value representing type C and type[1] is a value representing a type other than type C may be determined.

Moreover, in the case in which type C does not occur consecutively, type[1] is often type R. For this reason, even when idx_1 is set as in the example of Table 108-02 in FIG. 45, there is a possibility of achieving the same effect as the case in which threshold value TH(0) is 2 in Table T108-01.

Furthermore, in a generic mesh, the run count of type C is often a value less than or equal to approximately 6 to 8. On the other hand, in a large mesh having a large number of triangles constituting the mesh, the run count of type C may exceed 100.

For this reason, when 7 or a value close to 7 is used as threshold value TH(1), different contexts are used between a case in which the generic mesh has the run count of type C that is a value less than or equal to approximately 6 to 8 and a case in which the large mesh includes type C that occurs extremely frequently consecutively. In consequence, this may allow the connection type of the next triangle to be encoded according to an occurrence probability of the connection type of the next triangle in each of the cases. Accordingly, there is a possibility of improving the encoding efficiency.

It should be noted that an example of encoding is described above. However, by substituting “encoding” for “decoding”, similar examples is applicable to decoding.

Moreover, the table used to determine idx_1 may be determined according to the connection type (type[0]) of the previously (immediately previously) encoded/decoded triangle in the procedure in FIG. 44. Specifically, when idx_0 is determined using Table T106-01, the table for determining idx_1 may be determined as follows.

(1) When the connection type of the previously encoded or decoded triangle is type C, then Table T108-01 may be used. In this case, c_idx may be determined to be one of 0, 1, or 2 according to the run count of type C.

(2) When the connection type of the previously encoded or decoded triangle is type S, then Table T107-06 may be used. In this case, c_idx may be determined to be 3.

(3) When the connection type of the previously encoded or decoded triangle is type L, then Table T107-06 may be used. In this case, c_idx may be determined to be 4.

(4) When the connection type of the previously encoded or decoded triangle is type R, then Table T107-14 may be used. In this case, c_idx may be determined to be one of 5, 6, or 7 according to the connection type of the second previously encoded or decoded triangle.

(5) When the connection type of the previously encoded or decoded triangle is type E, then Table T107-06 may be used. In this case, c_idx may be determined to be 8.

The inventors obtained the following findings as a result of their trials. When the previous (immediately previous) connection type (type[0]) differs, a correspondence between the connection type of the triangle to be encoded and the second previous connection type (type[1]) or the third or more previous connection type (type[n], n≥2) differs. Therefore, by switching a method for determining idx_1 used to determine a context according to the previous (immediately previous) type, it may be possible to improve encoding efficiency of the entropy encoding.

As a result, by using the combinations described above, it may be possible to reduce memory utilization while suppressing a decline in encoding efficiency of the entropy encoding.

It should be noted that in the above combinations, even when idx_1 is determined using Table T108-02 in the case where the connection type of the previously encoded/decoded triangle is type C, there is a possibility of achieving the same effect.

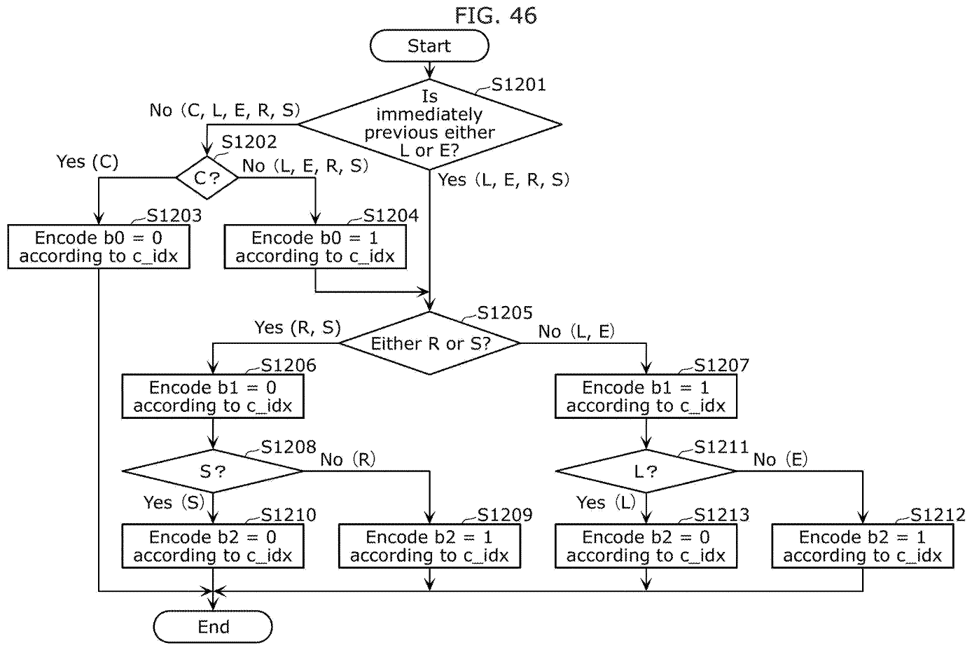

FIG. 46 is a flowchart illustrating a fifth specific example of encoding of the connection type according to the present embodiment. Specifically, FIG. 46 illustrates an example of the encoding processing (S603) in FIG. 36 and the encoding processing (S1103) in FIG. 44.

In this example, a character string including types C, L, E, R, and S is encoded from the end to the beginning of the character string, that is, in reverse order. In other words, for each of a plurality of triangles forming a mesh, the connection type of the triangle is determined according to processing order, and the connection type is encoded in reverse order of the processing order used to determine the connection type. In this example, types C, L, E, R, and S are assigned bit patterns 0, 110, 111, 101, and 100, respectively, and the entropy encoding is performed starting from the most significant bit of each bit pattern.

Specifically, first, whether the connection type of the previously (immediately previously) encoded triangle is either type L or type E is determined (S1201).

When the connection type of the previously encoded triangle is type L or type E (Yes in S1201), the connection type of the triangle to be encoded is determined not to be type C. Then, whether the connection type of the triangle to be encoded is one of types R and S is determined without encoding a value of first bit b0 (S1205).

When the connection type of the previously encoded triangle is neither type L nor type E (No in S1201), whether the connection type of the triangle to be encoded is type C is determined (S1202). When the connection type of the triangle to be encoded is type C (Yes in S1202), 0 is encoded as the value of first bit b0 by entropy encoding according to c_idx (S1203).

When the connection type of the triangle to be encoded is not type C (No in S1202: the connection type is any of L, E, R, and S), 1 is encoded as the value of first bit b0 by entropy encoding according to c_idx (S1204). Then, whether the connection type of the triangle to be encoded is one of types R and S is determined (S1205).

When the connection type of the triangle to be encoded is type R or type S (Yes in S1205), 0 is encoded as a value of second bit b1 by entropy encoding according to c_idx (S1206). Then, whether the connection type of the triangle to be encoded is type S is determined (S1208).

When the connection type of the triangle to be encoded is type S (Yes in S1208), 0 is encoded as a value of third bit b2 by entropy encoding according to c_idx (S1210). When the connection type of the triangle to be encoded is not type S (No in S1208: the connection type is R), 0 is encoded as the value of third bit b2 by entropy encoding according to c_idx (S1209).

When the connection type of the triangle to be encoded is neither type R nor type S (No in S1205: the connection type is L or E), 1 is encoded as the value of second bit b1 by entropy encoding according to c_idx (S1207). Then, whether the connection type of the triangle to be encoded is type L is determined (S1211).

When the connection type of the triangle to be encoded is type L (Yes in S1211), 0 is encoded as the value of third bit b2 by entropy encoding according to c_idx (S1213). When the connection type of the triangle to be encoded is not type L (No in S1211: the connection type is E), 1 is encoded as the value of third bit b2 by entropy encoding according to c_idx (S1212).

Note that when arithmetic encoding is used for entropy encoding, a context used for determining a predicted occurrence probability of information to be encoded is determined from among a plurality of contexts according to c_idx. When Huffman coding is used for entropy encoding, a codeword table used for encoding is determined from among a plurality of codeword tables according to c_idx.

In addition, in the entropy encoding of the value of third bit b2 (S1209, S1210, S1212, and S1213), the context or the codeword table may be determined according to the value of second bit b1 in addition to c_idx.

Type C does not logically occur immediately after type L or type E. Therefore, immediately after type L or type E, by omitting the encoding of first bit b0 for identifying type C and by encoding only the two bits of second bit b1 and third bit b2, it may be possible to encode the connection type of the triangle with a smaller coding amount.

In addition, it may be possible to suppress the coding amount of the connection type of the triangle by, for example, always using the same context for encoding first bit b0 immediately after type L or type E instead of omitting the encoding of first bit b0.

In addition, the content of the event indicated by the value of third bit b2 depends on the value of second bit b1 (type S or R when b1=0, and type L or E when b1=1). Therefore, if the context or codeword table is determined according to the value of second bit b1 in addition to c_idx in the entropy encoding of the value of third bit b2, it may be possible to further reduce the coding amount.

In addition, bit patterns 0, 011, 111, 101, and 001 may be assigned to types C, L, E, R, and S, respectively. Alternatively, unnecessary leading zeros may be omitted and bit patterns 0, 11, 111, 101, and 1 may be assigned to types C, L, E, R, and S, respectively. In addition, entropy encoding may be performed starting from the least significant bit of each bit pattern.

Accordingly, types C, L, E, R, and S are assigned bit patterns 0, 110, 111, 101, and 100, respectively, and an operation corresponding to the operation described above in which entropy encoding is performed starting from the most significant bit may be performed.

In the above description, encoding a bit may be inputting a bit to an encoding engine. Furthermore, in the encoding engine, a plurality of bits may be compressed into less bits.

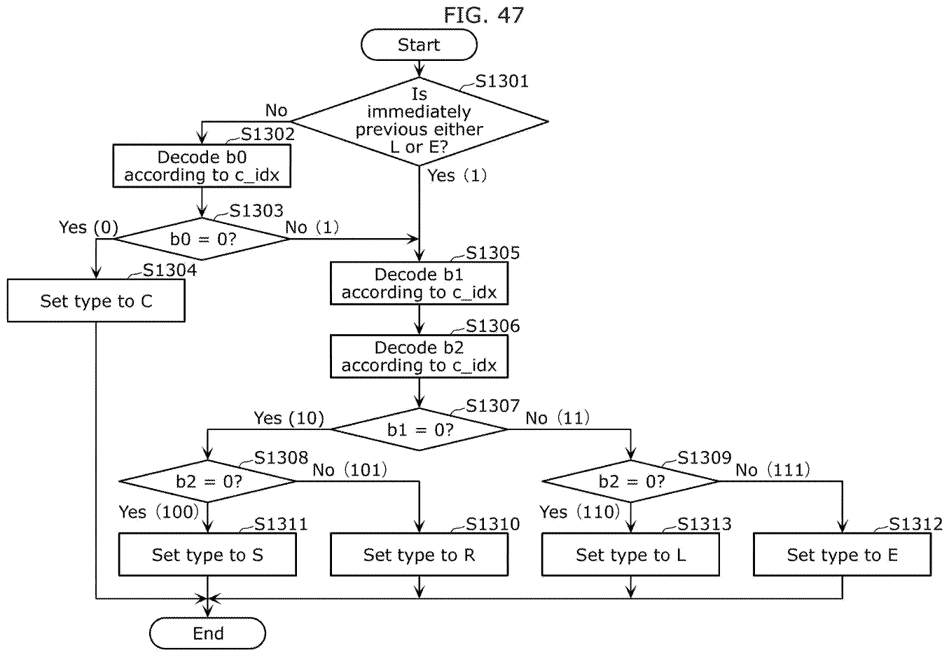

FIG. 47 is a flowchart illustrating a fifth specific example of decoding of the connection type according to the present embodiment. Specifically, FIG. 47 illustrates an example of the decoding processing (S603) in FIG. 36 and the decoding processing (S1103) in FIG. 44.

In this example, a bit sequence encoded by the encoding method described with reference to FIG. 46 is entropy-decoded. In other words, entropy decoding of the bit sequence in which the character string including types C, L, E, R, and S is encoded from the end to the beginning of the character string (i.e., in reverse order) is performed in decoding order identical to the encoding order. Then, one of types C, L, E, R, and S is set to the connection type of a triangle to be decoded.

Specifically, first, whether the connection type of the previously (immediately previously) decoded triangle is either type L or type E is determined (S1301).

When the connection type of the previously decoded triangle is type L or type E (Yes in S1301), the connection type of the triangle to be decoded is determined not to be type C. Next, a value of second bit b1 is decoded by entropy decoding according to c_idx without decoding a value of first bit b0 (S1305). It this case, the value of first bit b0 may be regarded as 1.

When the connection type of the previously decoded triangle is neither type L nor type E (No in S1301), the value of first bit b0 is decoded by entropy decoding according to c_idx (S1302). Then, whether the value of first bit b0 is 0 is determined (S1303).

When the value of first bit b0 is 0 (Yes in S1303), the connection type of the triangle to be decoded is set to type C (S1304). When the value of third bit b0 is not 0 (No in S1303), a value of second bit b1 is decoded by entropy decoding according to c_idx (S1305).

Next, a value of third bit b2 is decoded by entropy decoding according to c_idx (S1306). Then, a bit pattern of second bit b1 and third bit b2 is determined (S1307 to S1309). Then, according to the determination result, the connection type of the triangle to be decoded is set to any of types L, E, R, and S (S1310 to S1313).

Specifically, when the value of second bit b1 and the value of third bit b2 are 0 and 0 (Yes in S1307 and Yes in S1308), the connection type is set to type S (S1311). When the value of second bit b1 and the value of third bit b2 are 0 and 1, respectively (Yes in S1307 and No in S1308), the connection type is set to type R (S1310).

When the value of second bit b1 and the value of third bit b2 are 1 and 0, respectively (No in S1307 and Yes in S1309), the connection type is set to type L (S1313). When the value of second bit b1 and the value of third bit b2 are 1 and 1 (No in S1307 and No in S1309), the connection type is set to type E (S1312).

Note that when arithmetic decoding is used for the entropy decoding, the context used for determining the predicted occurrence probability of information to be decoded is determined from among a plurality of contexts according to c_idx. When Huffman decoding is used for the entropy decoding, the codeword table used for decoding is determined from among a plurality of codeword tables according to c_idx. Furthermore, in the entropy decoding of the value of third bit b2 (S1306), the context or codeword table may be determined according to the value of second bit b1 in addition to c_idx.

Type C does not logically occur immediately after type L or type E. Therefore, immediately after type L or type E, by omitting the decoding of first bit b0 for identifying type C and by decoding only the two bits of second bit b1 and third bit b2, it may be possible to decode the connection type of the triangle with a smaller coding amount.

In addition, it may be possible to suppress the coding amount of the connection type of the triangle by, for example, always using the same context for decoding first bit b0 immediately after type L or type E instead of omitting the decoding of first bit b0.

In addition, the content of the event indicated by the value of third bit b2 depends on the value of second bit b1 (type S or R when b1=0, and type L or E when b1=1). Therefore, by determining the context or codeword table according to the value of second bit b1 in addition to c_idx in the entropy decoding of the value of third bit b2, it may be possible to further reduce the coding amount.

In addition, bit patterns 0, 011, 111, 101, and 001 may be assigned to types C, L, E, R, and S, respectively. Alternatively, unnecessary leading zeros may be omitted and bit patterns 0, 11, 111, 101, and 1 may be assigned to types C, L, E, R, and S, respectively. In addition, entropy decoding may be performed starting from the least significant bit of each bit pattern.

Accordingly, types C, L, E, R, and S are assigned bit patterns 0, 110, 111, 101, and 100, respectively, and an operation corresponding to the operation described above in which entropy decoding is performed starting from the most significant bit may be performed.

As stated above, in the processing order used to determine the connection type, when the previous connection type is type C, the connection type to be processed is neither type L nor type E. As a result, in the reverse order of the processing order used to determine the connection type, when the previous connection type is type L or type E, the connection type to be processed is not type C.

Thus, in the case where encoding and decoding are performed in the reverse order of the processing order used to determine the connection type, when the previous connection type is type L or type E, information for identifying the connection type to be processed from a candidate set of types L, E, R, and S is encoded and decoded. Accordingly, it may be possible to reduce the coding amount as compared to encoding and decoding information for identifying the connection type from a candidate set of all types.

Here, when the previous connection type is type L or type E, the candidate set of types L, E, R, and S is used as a candidate set for the connection type of the triangle to be processed. However, the candidate set of connection types to be processed is not limited to this example and may be defined by a previously processed connection type.

For example, here, five types are defined with respect to connection types. However, the connection types may be defined according to a different method. For example, four or less types or six or more types may be defined with respect to connection types. In addition, a shape of a face is not limited to a triangle and may be another polygon. Furthermore, connection types may be defined according to the shape.

In addition, a candidate set of connection types of a face to be processed may be defined from connection types of previously processed faces according to the shape of each face, the definition of each type, and geometric characteristics. Accordingly, it may be possible to efficiently encode the connection type and to reduce the coding amount. Note that in the above description, “encoding” may be substituted for “decoding”.

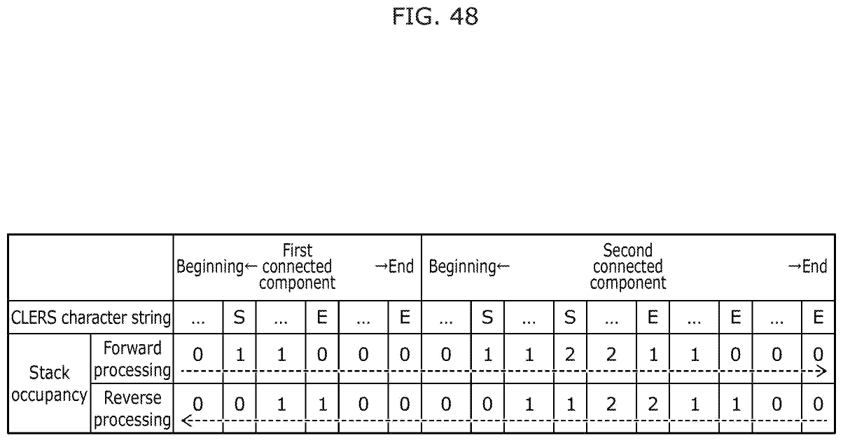

FIG. 48 is a conceptual diagram illustrating an example of changes in stack occupancy according to the present embodiment. Specifically, the figure shows an example of changes in stack occupancy for holding a branch point of a connected sequence in entropy encoding and entropy decoding of a connection type (type C, L, E, R, or S) associated by Edgebreaker for each of triangles forming a three-dimensional mesh.

In Edgebreaker, one of connection types including types C, L, E, R, and S is assigned to each triangle while traversing a plurality of triangles forming a three-dimensional mesh, based on predetermined rules. A character string including symbols C, L, E, R, and S each indicating a connection type is generated in the order indicated by the right-pointing arrow in the middle of FIG. 48.

Here, symbol C, L, E, R, or S indicating a connection type may be also expressed as a CLERS symbol. Additionally, a symbol to be processed may be also expressed as a current symbol. In addition, a character string including symbols C, L, E, R, and S may be also expressed as a CLERS character string, a symbol string, or a CLERS symbol string.

When a CLERS character string generated by Edgebreaker is processed in the forward direction (the order indicated by the right-pointing arrow in the middle of FIG. 48), a branch point is pushed onto a stack in type S, and the stack occupancy is incremented by 1. Then, since the process is returned to the branch point in type E, the branch point held in the stack is popped, and the stack occupancy is decremented by 1.

However, in the case where type E appears (for example, in the case of the end of a first connected component or the end of a second connected component in FIG. 48) when the stack is empty (occupancy is 0), a current symbol is determined to be the end of a connected component.

Afterward, when there is subsequent data, processing of a new connected component starts. For example, the start of processing a next second connected component is determined after the end of the first connected component in FIG. 48. In contrast, when there is not subsequent data, processing of mesh data ends. For example, at the end of the second connected component in FIG. 48, the current symbol is determined to be the end of the mesh data, and processing of the mesh data ends after the current symbol is processed.

It should be noted that a connected component corresponds to a subset of a three-dimensional mesh. In other words, the connected component corresponds to at least a portion of the three-dimensional mesh. The three-dimensional mesh often includes a plurality of connected components. A connected component may be abbreviated as a CC.

For example, a plurality of portions that are not consecutive with each other in a three-dimensional mesh may be determined to be a plurality of connected components. Additionally, a plurality of portions that are consecutive with each other in a three-dimensional mesh may be determined to be a plurality of connected components.

Specifically, the plurality of portions consecutive with each other in the three-dimensional mesh are divided into a plurality of connected components, and performing encoding processing and decoding processing for each connected component may be efficient. In this case, the plurality of portions consecutive with each other in the three-dimensional mesh are divided into the plurality of connected components, and the encoding processing and the decoding processing may be performed for each connected component.

More specifically, texture information of the three-dimensional mesh is mapped to a two-dimensional image and is encoded. However, it may be difficult to map the texture information of the three-dimensional mesh to the two-dimensional image. In such a case, the three-dimensional mesh may be divided into a plurality of submeshes and be encoded. A plurality of connected components may correspond to such a plurality of submeshes. In addition, a connected component may be an optional unit for defining a series of connection types.

Here, a plurality of portions that are in a CLERS character string and correspond to a plurality of connected components in a three-dimensional mesh may be expressed as a plurality of connected components. In other words, the connected components in the CLERS character string correspond to the connected components in the three-dimensional mesh. Each connected component can include a plurality of connection types of a plurality of triangles.

Moreover, the CLERS character string generated by Edgebreaker may be processed by, for example, what is called Spirale Reversi in a reverse direction (the order indicated by the left-pointing arrow in the bottom of FIG. 48) from the end of the CLERS character string.

In this case, a connected sequence is temporarily cut in type E, and the connected sequence is connected to the cut position in type S. For this reason, the cut position is pushed onto a stack in type E, and stack occupancy is incremented by 1. Then, the cut position held in the stack to connect the connected sequence to the cut position is popped in type S, and the stack occupancy is decremented by 1.

Since type E appears at the end of a connected component but a connected sequence of a connected component to be processed is not connected to a processed connected component, a cut position is not pushed onto a stack.

Here, when the CLERS character string is processed in the reverse direction, it is difficult to determine the end or the border of a connected component, based on the stack occupancy and the connection type of the triangle that has appeared. In view of this, in the present embodiment, when the CLERS character string of the mesh including the plurality of connected components is encoded and decoded in reverse order from the end of the CLERS character string, a configuration and a process for determining the end or the border of a connected component are indicated.

It should be noted that the end of a connected component is basically the end of a connected component in the forward direction. In addition, the border of the connected component means the boundary of the connected component. The end of the connected component corresponds to the border of the connected component. The border of the connected component may be determined by determining the end of the connected component. The determination of the end or the border of the connected component may be the determination of the end of the connected component, the determination of the border of the connected component, or the determination of both. Here, the term “determination” may be replaced with a term such as decision, specification, identification, or detection.

Furthermore, the CLERS character string described in the present disclosure may be generated in advance by a device different from encoding device 100. In this case, the CLERS character string generated in advance or the mesh data including the CLERS character string may be read out from a recording medium and inputted to encoding device 100. Alternatively, the CLERS character string generated in advance or the mesh data including the CLERS character string may be received via, for example, network 300 and inputted to encoding device 100.

Moreover, a CLERS character string inputted to encoding device 100 may be arranged in the forward direction or may be arranged in the reverse direction. When the CLERS character string inputted to encoding device 100 is arranged in the forward direction, encoding device 100 may rearrange the CLERS character string from the forward direction to the reverse direction. Alternatively, encoding device 100 may perform a conversion process for converting the CLERS character string arranged in the forward direction to the CLERS character string arranged in the reverse direction.

Likewise, a CLERS character string outputted by decoding device 200 may be arranged in the forward direction or may be arranged in the reverse direction. When the CLERS character string outputted from decoding device 200 is arranged in the forward direction, decoding device 200 may rearrange the CLERS character string from the reverse direction to the forward direction. Alternatively, decoding device 200 may perform a conversion process for converting the CLERS character string arranged in the reverse direction to the CLERS character string arranged in the forward direction.

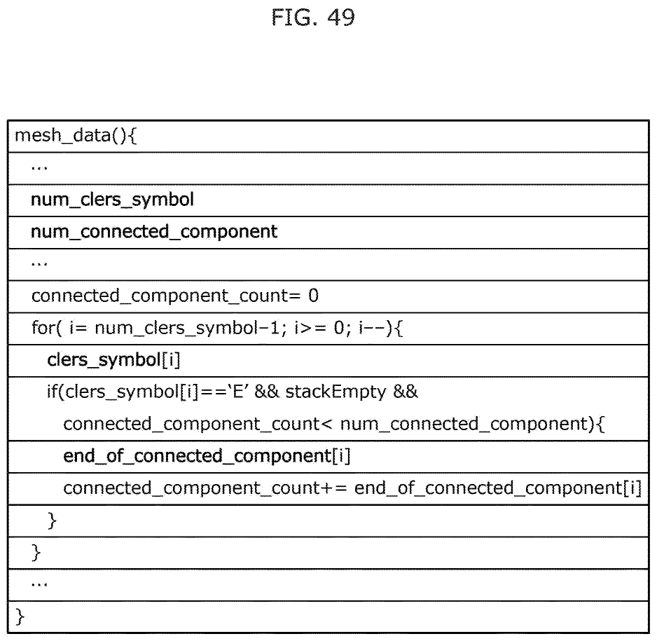

FIG. 49 is a syntax diagram illustrating a first syntax example of a symbol string including connected components according to the present embodiment. In this example, when a CLERS character string generated by Edgebreaker and including a plurality of connected components is encoded and decoded in reverse order from the end of the CLERS character string, whether a symbol is the end of a connected component is notified to allow the end or the border of the connected component to be determined.

Here, num_clers_symbol indicates the total number of symbols included in the CLERS character string of mesh data. Moreover, num_connected_component indicates the total number of connected components included in the mesh data. Furthermore, clers_symbol[i] indicates an i-th symbol when a first symbol in the CLERS character string is defined as a 0-th symbol.

Moreover, end_of_connected_component[i] indicates whether the i-th symbol is the end of a connected component. In this example, when end_of_connected_component[i] iS 1, end_of_connected_component[i] indicates that the i-th symbol is the end of the connected component; and when end_of_connected_component[i] is 0, end_of_connected_component[i] indicates that the i-th symbol is not the end of the connected component.

It should be noted that as shown in this example, with regard to notification of end_of_connected_component[i], when the i-th symbol may be determined not to be the end of the connected component without the notification, the notification may be omitted. When the notification is omitted, end_of_connected_component[i] may be set to 0 (not the end of the connected component), regarded as 0, or estimated to be 0.

For example, a symbol at the end of a connected component is “E”. For this reason, when a current symbol is not “E”, the notification of end_of_connected_component[i] may be omitted. It should be noted that clers_symbol[i] may be expressed in a bit pattern assigned to the i-th symbol (a connection type) among, for example, bit patterns 0, 110, 111, 101, and 100. In the example in FIG. 49, ‘E’ means a bit pattern assigned to type E.

Furthermore, in processing the symbol at the end of the connected component, a stack is assumed to be empty (occupancy is 0). For this reason, when the stack is not empty, the notification of end_of_connected_component[i] may be omitted. It should be noted that in the example in FIG. 49, when stackEmpty is 1, stackEmpty indicates that a stack is empty; and when stackEmpty is 0, stackEmpty indicates that the stack is not empty.

In addition, when the number of connected components not yet processed (not yet completed) among the plurality of connected components included in the mesh data is 1, that is, when there are no connected components not yet processed other than the connected component being processed, with regard to all the connected components, a symbol at the end of each connected component is assumed to be already processed. Accordingly, in this case, the notification of end_of_connected_component[i] may be omitted.

It should be noted that in the example in FIG. 49, the number of end_of_connected_component[i] indicating that the i-th symbol is the end of the connected component is counted as connected_component_count. Next, connected_component_count is compared with num_connected_component. Then, when connected_component_count is equal to num_connected_component, the notification is omitted.

In other words, in the example in FIG. 49, when the number of symbols processed as the ends of connected components is equal to the total number of the connected components, the notification is omitted. That the number of the symbols processed as the ends of the connected components is equal to the total number of the connected components corresponds to that the symbol corresponding to the end of each connected component is already encoded or decoded.

All or part of the plurality of conditions above may be applied in combination, or only one of the plurality of conditions may be applied.

As stated above, in notifying the symbol, whether the symbol is the end of the connected component is notified. Accordingly, even when the CLERS character string of the mesh including the plurality of connected components is encoded and decoded in the reverse order from the end of the CLERS character string, it is possible to correctly detect the end or the border of the connected component.

Additionally, with regard to the notification as to whether the symbol is the end of the connected component, when the symbol may be determined not to be the end of the connected component without the notification, the notification is omitted. Accordingly, it may be possible to encode and decode the CLERS character string of the mesh including the plurality of connected components in the reverse order from the end of the CLERS character string with a smaller coding amount.

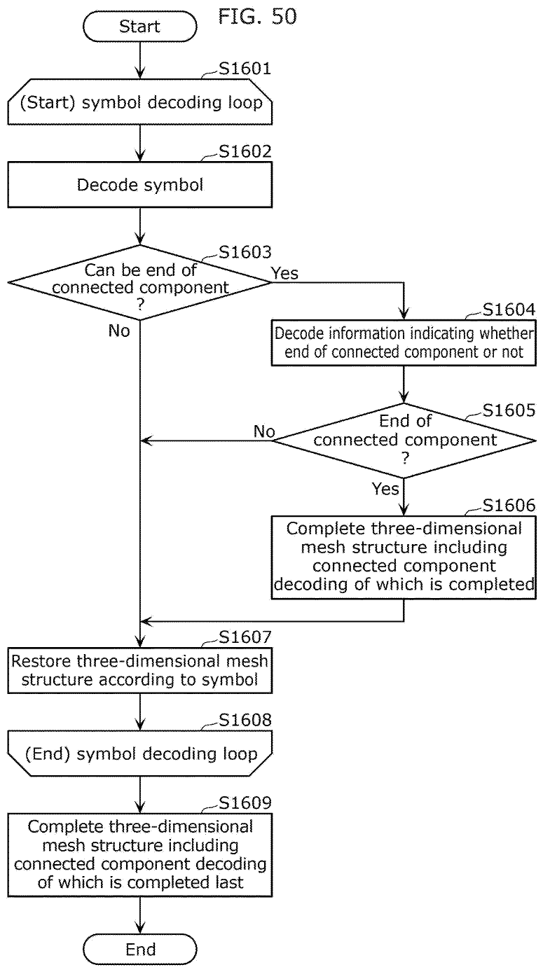

FIG. 50 is a flowchart illustrating a first decoding example of a symbol string including connected components according to the present embodiment. In this example, entropy decoding is performed on a CLERS character string including a plurality of connected components in reverse order from the end of the CLERS character string, and a three-dimensional mesh structure is restored. In addition, in this example, in loop processing (S1601 to S1608), symbols of the CLERS character string are decoded one by one, and the three-dimensional mesh structure is restored according to the symbols decoded. It should be noted that, here, the three-dimensional mesh structure may mean a structure of a portion of a three-dimensional mesh.

First, a symbol is decoded by entropy decoding (S1602). The symbol corresponds to clers_symbol[i] in FIG. 49. At this time, parameters for entropy decoding may be determined with reference to a restored three-dimensional mesh structure, or parameters for entropy decoding may be determined in combination with the other examples in FIG. 47 etc.

Next, whether the decoded symbol may be the end of a connected component is determined (S1603). This process corresponds to determining a condition for notifying end_of_connected_component[i] in FIG. 49. It should be noted that the determination may be made in combination of some conditions shown in FIG. 49 such as when the decoded symbol is “E” and when a stack is empty.

When the decoded symbol may be the end of the connected component (Yes in S1603), entropy decoding of information indicating whether the decoded symbol is the end of the connected component is performed (S1604). The information indicating whether the decoded symbol is the end of the connected component corresponds to end_of_connected_component[i] in FIG. 49. At this time, parameters for entropy decoding may be determined with reference to the restored three-dimensional mesh structure.

Then, whether the decoded symbol is the end of the connected component is determined based on the information decoded in a decoding process (S1604) (S1605). When the decoded symbol is the end of the connected component (Yes in S1605), a process for completing a three-dimensional mesh structure including a connected component the decoding of which is completed (a connected component including a previously decoded symbol) is performed (S1606).

Specifically, a triangle to which a symbol is not assigned, that is, a triangle whose symbol is not encoded, is located at the beginning of the connected component. The triangle at the beginning is connected to the three-dimensional mesh structure. In other words, an index of a vertex of the triangle at the beginning is associated with a vertex of a triangle whose symbol is decoded. The three-dimensional mesh structure including the connected component is completed through such association of the index of the vertex.

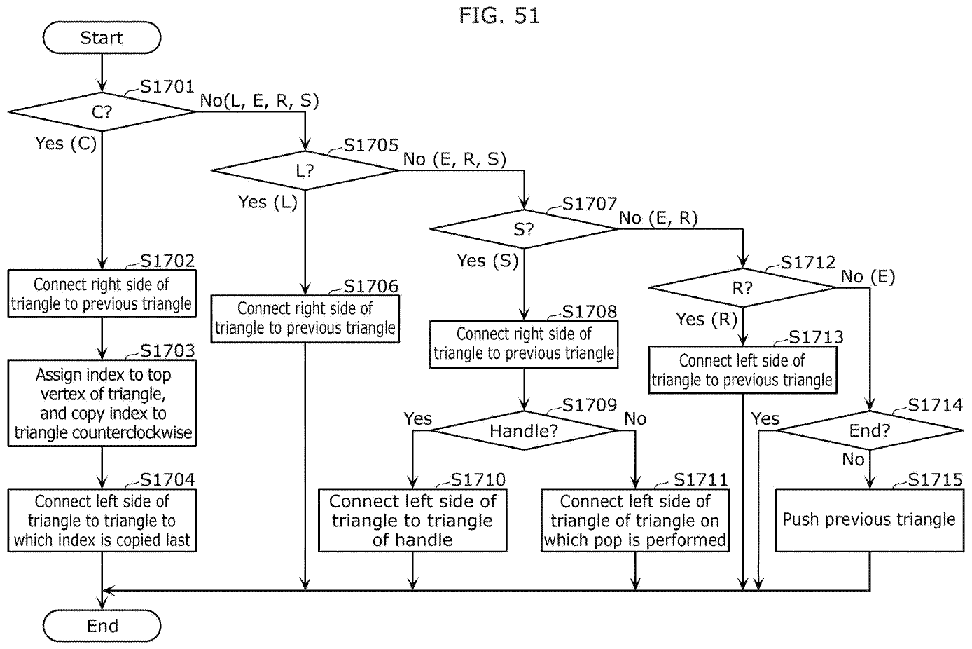

After that, the three-dimensional mesh structure is restored in accordance with the decoded symbol (S1607). The details are described below with reference to FIG. 51.

Finally, after the process of performing entropy decoding on all the symbols and restoring the three-dimensional mesh structure in accordance with the decoded symbol finishes, a process for completing a three-dimensional mesh structure including a connected component the decoding of which is completed last is performed (S1609). In other words, the above process (S1606) is performed on the connected component the decoding of which is completed last.

As stated above, whether the symbol is the end of the connected component is notified. Consequently, even when the CLERS character string of the mesh including the plurality of connected components is encoded and decoded in the reverse order from the end of the CLERS character string, it is possible to correctly detect the end or the border of the connected component. Accordingly, it is possible to appropriately select a triangle to be connected at the boundary of the connected component, and correctly restore the three-dimensional mesh structure.

Additionally, when the entropy decoding of the symbol is performed, it is possible to determine the parameters for the entropy decoding with reference to the restored three-dimensional mesh structure. Accordingly, it may be possible to reduce the coding amount.

Here, for example, the number of restored triangles located around a vertex of a triangle associated with a symbol to be decoded may be used as the restored three-dimensional mesh structure. In addition, parameters for entropy decoding may be, for example, parameters such as context information used to determine an occurrence probability in arithmetic decoding.

It should be noted that although the example of the decoding processing is described with reference to FIG. 50, the same operation is also applicable to the encoding processing by substituting “decoding” for “encoding”. When the same operation is applied to the encoding processing, a CLERS character string is generated by Edgebreaker before the loop processing (S1601 to S1608) is performed.

For example, since encoding device 100 makes it possible to identify the end (border) of a connected component, encoding device 100 encodes information for notifying decoding device 200 of the end (border) of the connected component. Specifically, encoding device 100 sets end_of_connected_component[i] in FIGS. 49 to 1 at the end (border) of the connected component and encodes end_of_connected_component[i]. Then, end_of_connected_component[i] may be used by decoding device 200 to detect the end (border) of the connected component.

Moreover, in the encoding processing, the process of restoring the three-dimensional mesh structure (S1607), the processes of completing the three-dimensional mesh structure (S1606 and S1609), and the process of determining the end (S1605) may be omitted. Alternatively, to enable the same reference as the decoding processing, in the encoding processing, these processes may be performed and the three-dimensional mesh structure may be reconstructed.

Furthermore, encoding device 100 and decoding device 200 according to the present disclosure may switch between a mode that encodes and decodes a CLERS character string in reverse order from the end of the CLERS character string and a mode that encodes and decodes the CLERS character string in order from the beginning of the CLERS character string, on, for example, a sequence, frame, or submesh basis. Each of the modes may be expressed as an application mode.

With regard to the mode switching, mode information indicating a mode may be notified using, for example, a header corresponding to a switching unit such as a sequence, a frame, or a submesh. Alternatively, one of the modes may be applied according to information for identifying an application tool such as profile information.

Moreover, encoding device 100 and decoding device 200 according to the present disclosure may always use the mode that encodes and decodes the CLERS character string in the reverse order from the end of the CLERS character string. When the mode that encodes and decodes the CLERS character string in the reverse order from the end of the CLERS character string is always used, the CLERS character string is encoded and decoded using a syntax structure including information indicating the end of the connected component without notifying the mode information using, for example, the header.

Furthermore, in the above example, the information indicating the end of the connected component is used between the plurality of connected components of the CLERS character string. This information may be expressed as information indicating the boundary (or the border) of the connected component. Additionally, different notification information unrelating to the boundary of the connected component may be written at the boundary of the connected component in encoded data of the CLERS character string.

FIG. 51 is a flowchart illustrating a process of restoring a mesh structure in accordance with a symbol according to the present embodiment. Here, the figure shows an example of the process of restoring the three-dimensional mesh structure in accordance with the decoded symbol (S1607) in FIG. 50.

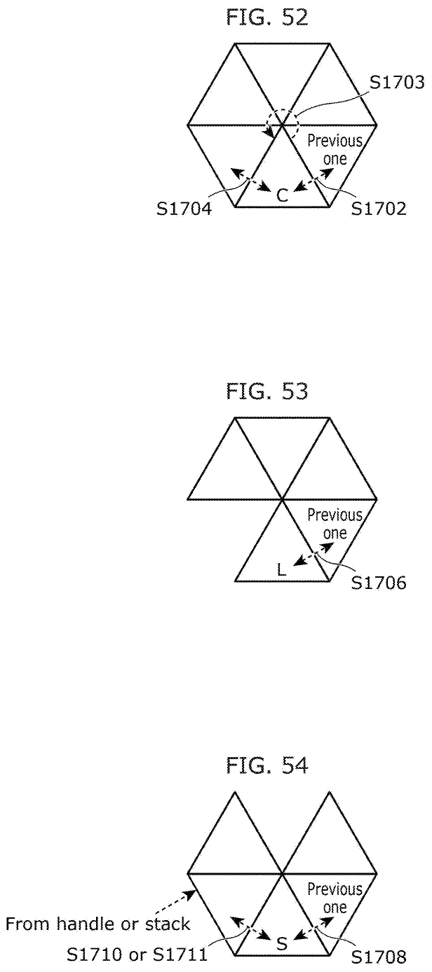

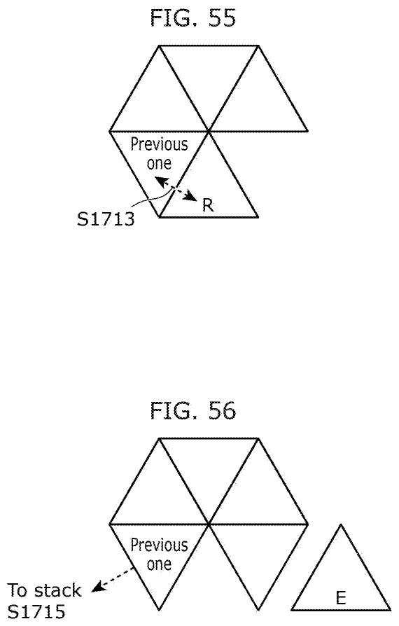

Specifically, a process to be performed in accordance with a decoded symbol is selected (S1701, S1705, S1707, and S1712). FIG. 52 to FIG. 56 each show a process to be performed in accordance with a decoded symbol. Each of FIG. 52 to FIG. 56 corresponds to a different one of processes to be performed according to types C, L, S, R, and E. Reference signs (steps) in FIG. 52 to FIG. 56 correspond to reference signs (steps) in FIG. 51.

For example, when the decoded symbol is “C” (Yes in S1701), the right side of a current triangle is connected to a previous triangle (S1702). Here, the current triangle is a triangle corresponding to the decoded symbol. In addition, the previous triangle is a triangle corresponding to a previously decoded symbol.

Next, a new index is assigned to a top vertex of the current triangle. Then, the index of the vertex is copied to a plurality of triangles sharing the vertex counterclockwise starting from the previous triangle (S1703). After that, the triangle to which the index of the vertex is copied last is connected to the left side of the current triangle (S1704).

When the decoded symbol is “L” (Yes in S1705), the right side of the current triangle is connected to the previous triangle (S1706).

When the decoded symbol is “S” (Yes in S1707), the right side of the current triangle is connected to the previous triangle (S1708). Next, whether a triangle notified as a handle is located on the left side of the current triangle is determined (S1709). The triangle notified as the handle is a triangle included in a ring structure referred to as a handle. For example, a handle corresponds to a plurality of triangles included in a ring structure ranging from the right side of a triangle of type S to the left side of the triangle in forward processing order.

When the triangle notified as the handle is located (Yes in S1709), the triangle notified as the handle is connected to the left side of the current triangle (S1710). In this case, a triangle (a cut position) is not popped from a stack. In contrast, when the triangle notified as the handle is not located (No in S1709), a triangle popped from the stack is connected to the left side of the current triangle (S1711).

When the decoded symbol is “R” (Yes in S1712), the left side of the current triangle is connected to the previous triangle (S1713).

When the decoded symbol is “E” (No in S1712), whether the current triangle is the end of a connected component is determined (S1714). When the current triangle is not the end of the connected component (No in S1714), the previous triangle is pushed onto the stack (S1715). It should be noted that determining the end (S1714) may be performed by the same method as determining the end (S1605) in FIG. 50. For example, the end of the connected component may be determined according to end_of_connected_component[i] in FIG. 49.

In the above description, the right side, the left side, and the top side of a triangle may be determined based on predetermined rules. For example, the right side, the left side, and the top side of the triangle may be determined along a forward path corresponding to processing order for determining a CLERS character string.

Although the example of the decoding processing is described with reference to FIG. 51, the same operation is also applicable to the encoding processing by substituting “decoding” for “encoding”. In addition, to enable the same reference as the decoding processing, in the encoding processing, the three-dimensional mesh structure may be reconstructed.

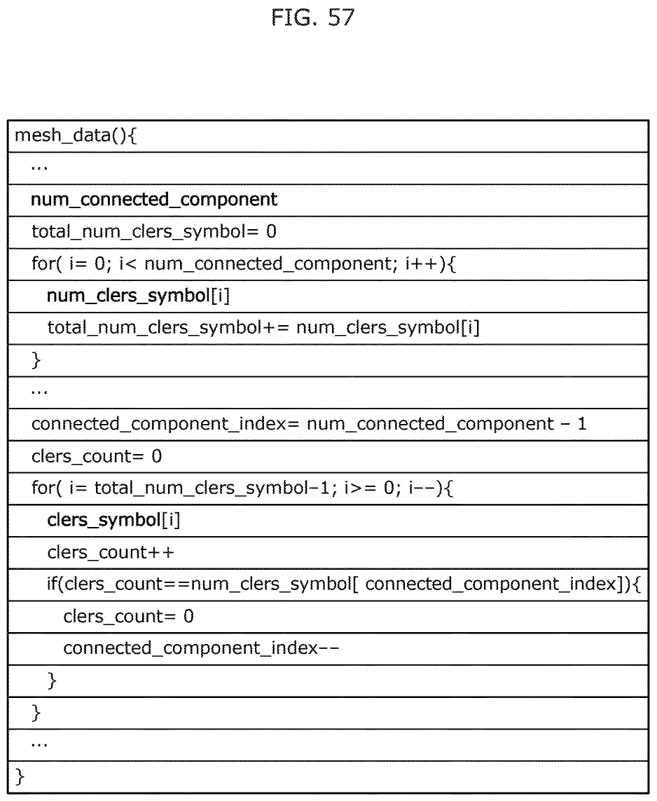

FIG. 57 is a syntax diagram illustrating a second syntax example of a symbol string including connected components according to the present embodiment. In this example, when a CLERS character string generated by Edgebreaker and including a plurality of connected components is encoded and decoded in reverse order from the end of the CLERS character string, the number of symbols included in each of the plurality of connected components is notified to allow the end or the border of the connected component to be determined.

Here, num_connected_component indicates the total number of connected components included in mesh data.

Moreover, num_clers_symbol[i] indicates the total number of symbols included in an i-th connected component when a first connected component of a three-dimensional mesh is defined as a 0-th connected component. In other words, num_clers_symbol[i] indicates the total number of symbols included in the i-th connected component when, among one or more connected components included in the CLERS character string of the entire three-dimensional mesh, the first connected component is defined as the 0-th connected component in the forward direction.

Furthermore, clers_symbol[i] indicates an i-th symbol when a first symbol in the CLERS character string is defined as a 0-th symbol in the forward direction. Moreover, total_num_clers_symbol indicates the total number (count) of symbols included in the CLERS character string of the entire three-dimensional mesh, and is derived by adding num_clers_symbol[i] for each i. Furthermore, clers_count indicates the number of decoded symbols for a current connected component that is a connected component to be decoded.

For example, clers_symbol[i] is sequentially notified, the number of which is equal to a number derived as total_num_clers_symbol. Then, in each connected component, clers_symbol[i] is sequentially notified, the number of which is sequentially counted as clers_count.

After that, whether clers_count is equal to num_clers_symbol[connected_component_index] is determined. Here, when clers_count is equal to num_clers_symbol[connected_component_index], decoding of all the symbols included in the connected component is determined to have been completed. To put it another way, the decoding processing has reached the border of the connected component, and a symbol to be decoded next is determined to be the end of a connected component to be decoded next.

It should be noted that connected_component_index is an index of the current connected component. Additionally, decoding may be substituted for encoding in the above description.

As stated above, even when the CLERS character string of the mesh including the plurality of connected components is encoded and decoded in the reverse order from the end of the CLERS character string, by notifying the number of the symbols included in each of the plurality of connected component, it is possible to correctly detect the end or the border of the connected component.

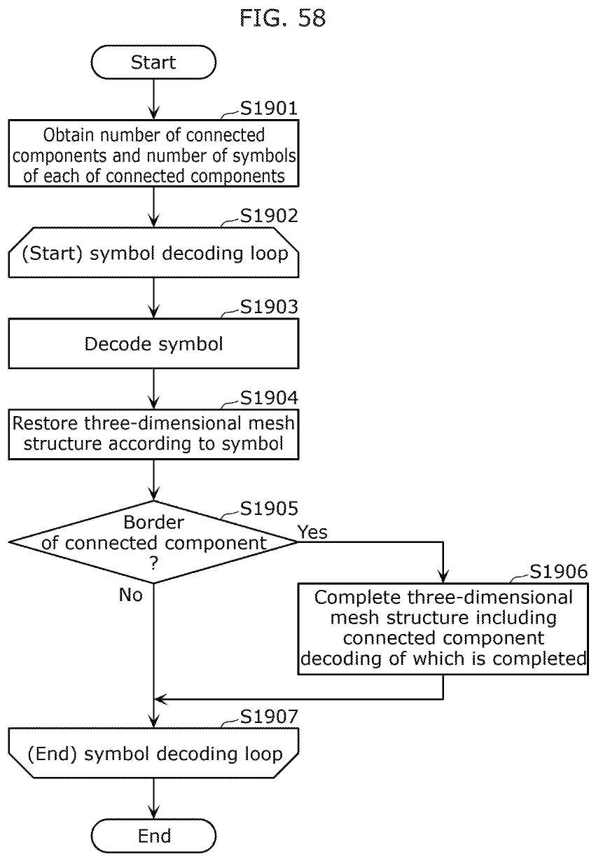

FIG. 58 is a flowchart illustrating a second decoding example of a symbol string including connected components according to the present embodiment. In this example, entropy decoding is performed on a CLERS character string including a plurality of connected components in the reverse order from the end of the CLERS character string, and a three-dimensional mesh structure is restored. In addition, in this example, in loop processing (S1902 to S1907), symbols of the CLERS character string are decoded one by one, and the three-dimensional mesh structure is restored according to the symbols decoded. It should be noted that, here, the three-dimensional mesh structure may mean a structure of a portion of a three-dimensional mesh.

First, before the loop processing, the number of connected components and the number of symbols included in each of the connected components are obtained (S1901). Here, the number of the connected components is equivalent to num_connected_component in FIG. 57. Additionally, the number of the symbols included in each connected component is equivalent to num_clers_symbol[i] in FIG. 57.

Next, the loop processing starts. In the loop processing, first, a symbol is decoded by entropy decoding (S1903). Here, the symbol corresponds to clers_symbol[i] in FIG. 57. At this time, parameters for entropy decoding may be determined with reference to a restored three-dimensional mesh structure, or parameters for entropy decoding may be determined in combination with the other examples in FIG. 47 etc. Next, a three-dimensional mesh structure is restored in accordance with the decoded symbol (S1904). The details are as described above with reference to FIG. 51.

Then, whether decoding processing has reached the border of a connected component is determined (S1905). This determination process corresponds to determining whether decoding of all symbols included in the connected component has been completed. In addition, the determination process corresponds to determining whether clers_count is equal to num_clers_symbol[connected_component_index] in FIG. 57. In other words, whether the decoding processing has reached the border of the connected component and a symbol to be decoded next is the end of a connected component to be decoded next are determined.

When the decoding processing is determined to have reached the border of the connected component (Yes in S1905), a process for completing a three-dimensional mesh structure including a connected component the decoding of which is completed (a connected component including a previously decoded symbol) is performed (S1906).

Specifically, a triangle to which a symbol is not assigned, that is, a triangle whose symbol is not encoded, is located at the beginning of the connected component. The triangle at the beginning is connected to the three-dimensional mesh structure. In other words, an index of a vertex of the triangle at the beginning is associated with a vertex of a triangle whose symbol is decoded. The three-dimensional mesh structure including the connected component is completed through such association of the index of the vertex.

As stated above, the number of the symbols included in each connected component is notified. For this reason, even when the CLERS character string of the mesh including the plurality of connected components is encoded and decoded in the reverse order from the end of the CLERS character string, it is possible to correctly detect the end or the border of the connected component. Accordingly, it is possible to appropriately select a triangle to be connected at the boundary of the connected component, and correctly restore the three-dimensional mesh structure.

Additionally, when the entropy decoding of the symbol is performed, it is possible to determine the parameters for the entropy decoding with reference to the restored three-dimensional mesh structure. Accordingly, it may be possible to reduce the coding amount.

Here, for example, the number of restored triangles located around a vertex of a triangle associated with a symbol to be decoded may be used as the restored three-dimensional mesh structure. In addition, the parameter for the entropy decoding may be, for example, parameters such as context information used to determine an occurrence probability in arithmetic decoding.

It should be noted that although the example of the decoding processing is described with reference to FIG. 58, the same operation is also applicable to the encoding processing by substituting “decoding” for “encoding”. When the same operation is applied to the encoding processing, a CLERS character string is generated by Edgebreaker before the loop processing (S1902 to S1907) is performed.

For example, since encoding device 100 makes it possible to identify the border of a connected component, encoding device 100 encodes information for notifying decoding device 200 of the border of the connected component. Specifically, encoding device 100 identifies and encodes num_connected_component and num_clers_symbol[i] in FIG. 57, based on the border of the connected component. Then, decoding device 200 may use num_connected_component and num_clers_symbol[i] to detect the border of the connected component.

Moreover, in the encoding processing, the process of restoring the three-dimensional mesh structure (S1904), the process of completing the three-dimensional mesh structure (S1906), and the process of determining the border (S1905) may be omitted. Alternatively, to enable the same reference as the decoding processing, in the encoding processing, these processes may be performed and the three-dimensional mesh structure may be reconstructed.

Furthermore, encoding device 100 and decoding device 200 according to the present disclosure may switch between a mode that encodes and decodes a CLERS character string in reverse order from the end of the CLERS character string and a mode that encodes and decodes the CLERS character string in order from the beginning of the CLERS character string, on, for example, a sequence, frame, or submesh basis. Each of the modes may be expressed as an application mode.

With regard to the mode switching, mode information indicating a mode may be notified using, for example, a header corresponding to a switching unit such as a sequence, a frame, or a submesh. Alternatively, one of the modes may be applied according to information for identifying an application tool such as profile information.

Moreover, encoding device 100 and decoding device 200 according to the present disclosure may always use the mode that encodes and decodes the CLERS character string in the reverse order from the end of the CLERS character string. When the mode that encodes and decodes the CLERS character string in the reverse order from the end of the CLERS character string is always used, the CLERS character string is encoded and decoded using a syntax structure including information indicating the number of symbols included in a connected component without notifying the mode information using, for example, the header.

Furthermore, the information indicating the number of the symbols included in the connected component is used in the above example. This information may be expressed as information indicating the length of the connected component. Additionally, the information may be information that makes it possible to derive the number of the symbols included in the connected component in combination with different information.

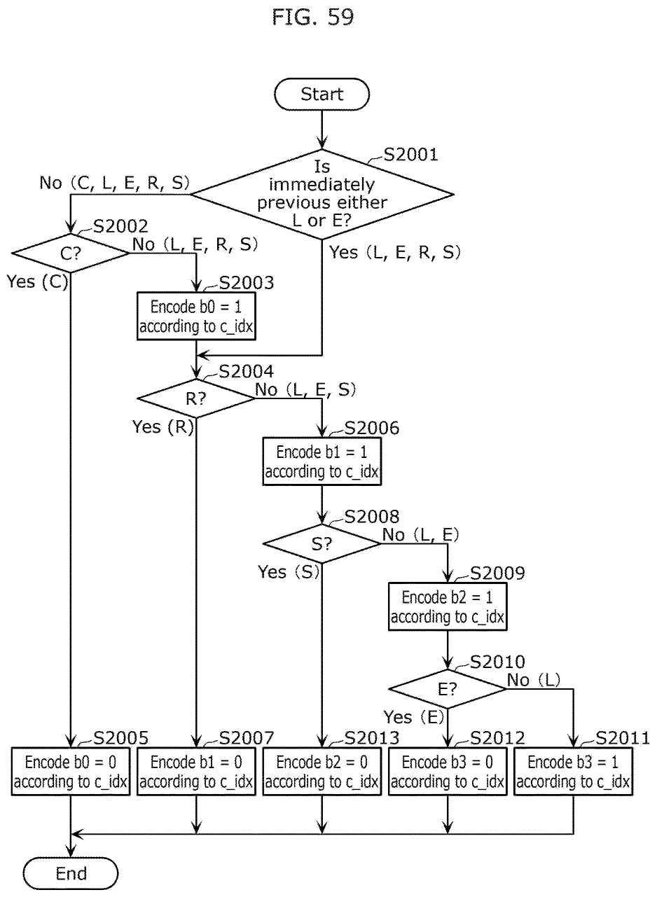

FIG. 59 is a flowchart illustrating a sixth specific example of encoding of the connection type according to the present embodiment. Specifically, FIG. 59 illustrates an example of the encoding processing (S603) in FIG. 36 and the encoding processing (S1103) in FIG. 44. In addition, the encoding processing in FIG. 59 may be applied to encoding processing corresponding to the decoding processing (S1602) in FIG. 50 or may be applied to encoding processing corresponding to the decoding processing (S1903) in FIG. 58.

In this example, a character string including types C, L, E, R, and S is encoded from the end to the beginning of the character string, that is, in reverse order. In other words, for each of a plurality of triangles forming a mesh, a connection type of the triangle is determined according to processing order, and the connection type is encoded in reverse order of the processing order used to determine the connection type. In this example, types C, R, E, S and L are assigned bit patterns 0, 10, 110, 1110, and 1111, respectively, and entropy encoding is performed starting from the most significant bit of each bit pattern.

To put it another way, this example corresponds to an example in which encoding processing is performed on a character string in the reverse order and Truncated Unary is used for bit patterns. Additionally, that type C does not occur immediately after type L or type E in the reverse order is reflected on the encoding processing.

Specifically, first, whether a connection type of a previously (immediately previously) encoded triangle is either type L or type E is determined (S2001).

When the connection type of the previously encoded triangle is type L or type E (Yes in S2001), a connection type of a triangle to be encoded is determined not to be type C. Then, whether the connection type of the triangle to be encoded is type R is determined without encoding a value of first bit b0 (S2004).

When the connection type of the previously encoded triangle is neither type L nor type E (No in S2001), whether the connection type of the triangle to be encoded is type C is determined (S2002). When the connection type of the triangle to be encoded is type C (Yes in S2002), 0 is encoded as the value of first bit b0 by entropy encoding according to c_idx (S2005).

When the connection type of the triangle to be encoded is not type C (No in S2002: the connection type is any of L, E, R, and S), 1 is encoded as the value of first bit b0 by entropy encoding according to c_idx (S2003). Then, whether the connection type of the triangle to be encoded is type R is determined (S2004).

When the connection type of the triangle to be encoded is type R (Yes in S2004), 0 is encoded as a value of second bit b1 by entropy encoding according to c_idx (S2007).

When the connection type of the triangle to be encoded is not type R (No in S2004: the connection type is L, E, or S), 1 is encoded as the value of second bit b1 by entropy encoding according to c_idx (S2006). Then, whether the connection type of the triangle to be encoded is type S is determined (S2008).

When the connection type of the triangle to be encoded is type S (Yes in S2008), 0 is encoded as a value of third bit b2 by entropy encoding according to c_idx (S2013).

When the connection type of the triangle to be encoded is not type S (No in S2008: the connection type is L or E), 1 is encoded as the value of third bit b2 by entropy encoding according to c_idx (S2009). Then, whether the connection type of the triangle to be encoded is type E is determined (S2010).

When the connection type of the triangle to be encoded is type E (Yes in S2010), 0 is encoded as a value of fourth bit b3 by entropy encoding according to c_idx (S2012).

When the connection type of the triangle to be encoded is not type E (No in S2010: the connection type is L), 1 is encoded as the value of fourth bit b3 by entropy encoding according to c_idx (S2011).

Note that when arithmetic encoding is used for entropy encoding, a context used for determining a predicted occurrence probability of information to be encoded is determined from among a plurality of contexts according to c_idx. When Huffman coding is used for entropy encoding, a codeword table used for encoding is determined from among a plurality of codeword tables according to c_idx.

Type C does not logically occur immediately after type L or type E. Therefore, immediately after type L or type E, by omitting the encoding of first bit b0 for identifying type C and by encoding only the three bits of second bit b1 to fourth bit b3, it may be possible to encode the connection type of the triangle with a smaller coding amount.

In addition, it may be possible to suppress the coding amount of the connection type of the triangle by, for example, always using the same context for encoding first bit b0 immediately after type L or type E instead of omitting the encoding of first bit b0.

In addition, in the above example, types C, R, S, E, and L are assigned bit patterns 0, 10, 110, 1110, and 1111, respectively. However, the types to be determined in the determination processes (S2002, S2004, S2008, and S2010) may be defined according to the way of assignment of bit patterns. By setting a bit omitted by the previous connection type determination process (S2001) to a bit relating to the determination of type C, it is possible to assign any bit pattern.

Furthermore, a type whose occurrence frequency is high may be assigned a short bit pattern. Accordingly, efficient encoding and a reduction of the coding amount may be possible. For this reason, bit patterns 0 and 10 or bit patterns 10 and 0 may be assigned to types C and R whose occurrence frequency is high, respectively. In addition, bit patterns 1110 and 1111 or bit patterns 1111 and 1110 may be assigned to types E and L whose occurrence frequency is low, respectively.

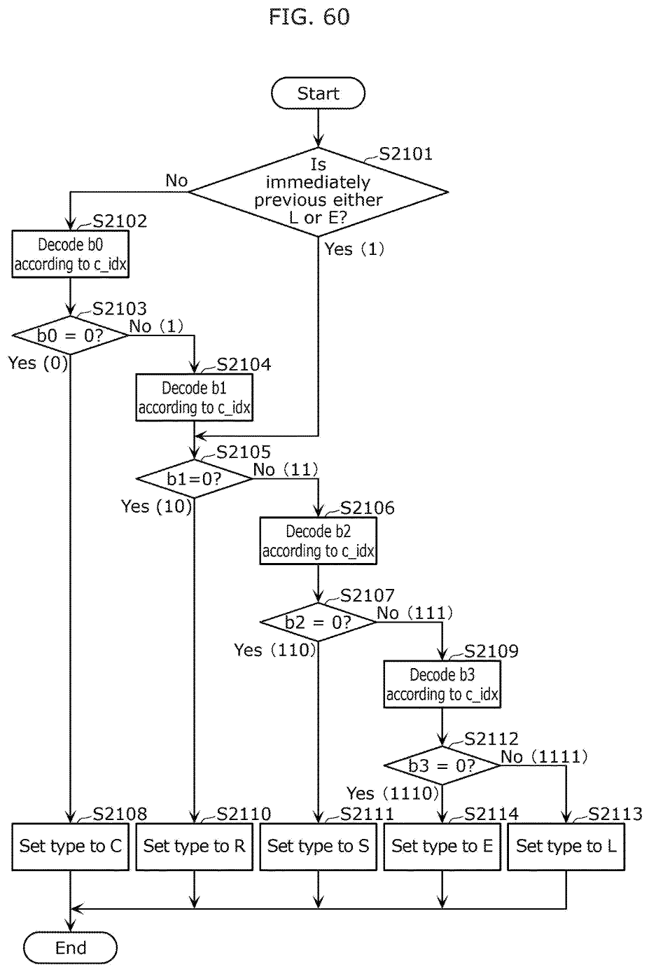

FIG. 60 is a flowchart illustrating a sixth specific example of decoding of the connection type according to the present embodiment. Specifically, FIG. 60 illustrates an example of the decoding processing (S603) in FIG. 36 and the decoding processing (S1103) in FIG. 44. In addition, the decoding processing in FIG. 60 may be applied to the decoding processing (S1602) in FIG. 50 or may be applied to the decoding processing (S1903) in FIG. 58.

In this example, a bit sequence encoded by the encoding method described with reference to FIG. 59 is entropy-decoded. In other words, entropy decoding of the bit sequence in which the character string including types C, L, E, R, and S is encoded from the end to the beginning of the character string (i.e., in reverse order) is performed in decoding order identical to the encoding order. Then, one of types C, L, E, R, and S is set to a connection type of a triangle to be decoded.

To put it another way, this example corresponds to an example in which decoding processing is performed on a character string in the reverse order and Truncated Unary is used for bit patterns. Additionally, that type C does not occur immediately after type L or type E in the reverse order is reflected on the decoding processing.

Specifically, first, whether a connection type of a previously (immediately previously) decoded triangle is either type L or type E is determined (S2101).

When the connection type of the previously decoded triangle is either type L or type E (Yes in S2101), a connection type of a triangle to be decoded is determined not to be type C. Next, a value of second bit b1 is decoded by entropy decoding according to c_idx without decoding a value of first bit b0 (S2104). It this case, the value of first bit b0 may be regarded as 1.

When the connection type of the previously decoded triangle is neither type L nor type E (No in S2101), the value of first bit b0 is decoded by entropy decoding according to c_idx (S2102). Then, whether the value of first bit b0 is 0 is determined (S2103).

When the value of first bit b0 is 0 (Yes in S2103), the connection type of the triangle to be decoded is set to type C (S2108). When the value of first bit b0 is not 0 (No in S2103), the value of second bit b1 is decoded by entropy decoding according to c_idx (S2104). Then, whether the value of second bit b1 is 0 is determined (S2105).

When the value of second bit b1 is 0 (Yes in S2105), the connection type of the triangle to be decoded is set to type R (S2110). When the value of second bit b1 is not 0 (No in S2105), a value of third bit b2 is decoded by entropy decoding according to c_idx (S2106). Then, whether the value of third bit b2 is 0 is determined (S2107).

When the value of third bit b2 is 0 (Yes in S2107), the connection type of the triangle to be decoded is set to type S (S2111). When the value of third bit b2 is not 0 (No in S2107), a value of fourth bit b3 is decoded by entropy decoding according to c_idx (S2109). Then, whether the value of fourth bit b3 is 0 is determined (S2112).

When the value of fourth bit b3 is 0 (Yes in S2112), the connection type of the triangle to be decoded is set to type E (S2114). When the value of fourth bit b3 is not 0 (No in S2112), the connection type of the triangle to be decoded is set to type L (S2113).

Note that when arithmetic decoding is used for the entropy decoding, the context used for determining the predicted occurrence probability of information to be decoded is determined from among a plurality of contexts according to c_idx. When Huffman decoding is used for the entropy decoding, the codeword table used for decoding is determined from among a plurality of codeword tables according to c_idx.

Type C does not logically occur immediately after type L or type E. Therefore, immediately after type L or type E, by omitting the decoding of first bit b0 for identifying type C and by decoding only the three bits of second bit b1 to fourth bit b3, it may be possible to decode the connection type of the triangle with a smaller coding amount.

In addition, it may be possible to suppress the coding amount of the connection type of the triangle by, for example, always using the same context for decoding first bit b0 immediately after type L or type E instead of omitting the decoding of first bit b0.

In addition, in the above example, types C, R, S, E, and Lare assigned bit patterns 0, 10, 110, 1110, and 1111, respectively. However, the types to be set in the setting processes (S2108, S2110, S2111, S2114, and S2113) may be defined according to the way of assignment of bit patterns. By setting a bit omitted by the previous connection type determination process (S2101) to a bit relating to the determination of type C, it is possible to assign any bit pattern.

Furthermore, a type whose occurrence frequency is high may be assigned a short bit pattern. Accordingly, it may be possible to reduce the coding amount. For this reason, bit patterns 0 and 10 or bit patterns 10 and 0 may be assigned to types C and R whose occurrence frequency is high, respectively. In addition, bit patterns 1110 and 1111 or bit patterns 1111 and 1110 may be assigned to types E and L whose occurrence frequency is low, respectively.

### Representative Examples

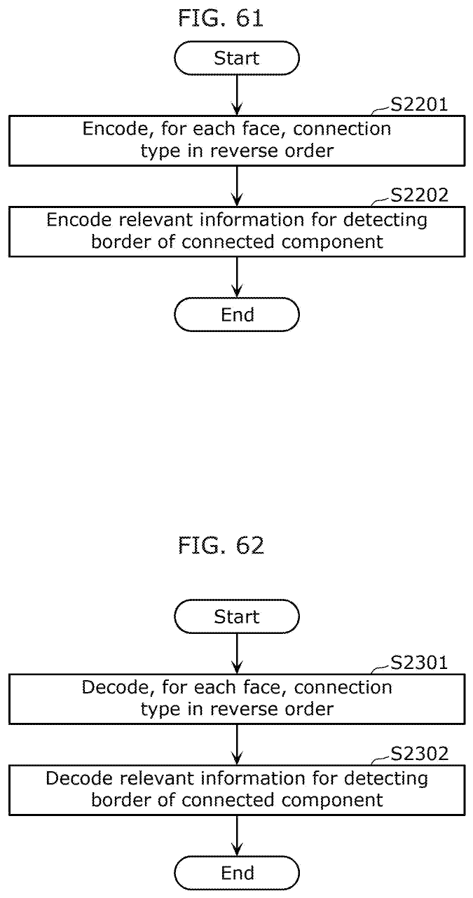

FIG. 61 is a flowchart illustrating an example of basic encoding processing according to the present embodiment. For example, in operation, circuit 151 of encoding device 100 shown in FIG. 24 performs the encoding processing shown in FIG. 61 using memory 152.

Specifically, circuit 151 encodes, for each of faces forming a three-dimensional mesh, a connection type regarding a connection relationship between the face to be processed and a face not yet processed, in reverse order of processing order in which the connection type is defined (S2201). Here, a plurality of examples of connection types regarding a connection relationship between the face to be processed and a face not yet processed may include a type in which the face to be processed is not connected to the face not yet processed (for example, type E described above).

Moreover, circuit 151 encodes relevant information for detecting a border of a connected component in a plurality of connection types each of which is encoded as the connection type in the reverse order (S2202). Here, the connected component corresponds to at least a portion of the three-dimensional mesh. The relevant information may be encoded before encoding the plurality of connection types or may be encoded while encoding the plurality of connection types.

As a result, it may be possible to appropriately detect the border of the connected component in the plurality of connection types encoded in the reverse order. Accordingly, it may be possible to efficiently identify the connected component and a connection relationship among the plurality of faces. In consequence, it may be possible to reduce processing delay in reconstructing the three-dimensional mesh.

For example, the relevant information may indicate whether a current connection type corresponds to an end of the connected component in the processing order, the current connection type being the connection type to be encoded. As a result, it may be possible to appropriately detect the connection type corresponding to the end of the connected component in the plurality of connection types encoded in the reverse order. Accordingly, it may be possible to efficiently identify the connected component and the connection relationship among the plurality of faces.

Furthermore, for example, circuit 151 may determine whether a condition that the current connection type is capable of corresponding to the end is satisfied. When circuit 151 determines that the condition is satisfied, circuit 151 may encode the relevant information. As a result, when the current connection type is not capable of corresponding to the end of the connected component, it may be possible to omit the encoding of the relevant information. Accordingly, it may be possible to suppress the increase in coding amount.

Moreover, for example, the condition may include a condition that the current connection type is an end type. Here, the end type is a type in which, along a path to the face to be processed in the processing order, a face not yet processed is connected to neither a left side nor a right side of the face to be processed. As a result, when the current connection type is not the end type, it may be possible to omit the encoding of the relevant information. Accordingly, it may be possible to suppress the increase in coding amount.

Furthermore, for example, the condition may include a condition that a stack on which push or pop is performed according to the connection type is empty. As a result, when the stack is not empty, it may be possible to omit the encoding of the relevant information. Accordingly, it may be possible to suppress the increase in coding amount.

Moreover, for example, the condition may include a condition that the connection type of a face at an end of at least one connected component is not encoded, the at least one connected component being included in one or more connected components each of which is defined as the connected component. As a result, when the connection type of the face at the end is already encoded for each of the connected components, it may be possible to omit the encoding of the relevant information. Accordingly, it may be possible to suppress the increase in coding amount.

Furthermore, for example, the relevant information may indicate a total number of connection types that is a total number of one or more connection types each of which is encoded for a corresponding one of one or more connected components each of which is defined as the connected component. As a result, it may be possible to efficiently identify each connected component according to the number of connection types, and identify the connection relationship among the plurality of faces. In consequence, it may be possible to reduce processing delay in reconstructing the three-dimensional mesh.

Moreover, for example, the border may be indicated by the total number of the connection types indicated by the relevant information, and a total number of one or more connection types encoded. More specifically, for example, when the number of the connection types indicated by the relevant information matches the number of the one or more connection types encoded, the encoding processing is assumed to have reached the border of the connected component. In other words, the border of the connected component may be indicted by the match between the number of the connection types indicated by the relevant information and the number of the one or more connection types encoded.

As a result, it may be possible to appropriately indicate the border of the connected component in the plurality of connection types encoded in the reverse order, according to a relationship between the number of the connection types indicated by the relevant information and the number of the one or more connection types encoded. Accordingly, it may be possible to efficiently identify each connected component and the connection relationship among the plurality of faces.

The above relevant information may be defined as information pertaining to the identification of the border of the connected component. The relevant information may correspond to end_of_connected_component[i] or num_clers_symbol[i].

Although circuit 151 of encoding device 100 performs each process in the above description, connection information encoder 102 or 145 of encoding device 100 may perform the process or another constituent element may perform the process.

FIG. 62 is a flowchart illustrating an example of basic decoding processing according to the present embodiment. For example, in operation, circuit 251 of decoding device 200 shown in FIG. 25 performs the decoding processing shown in FIG. 62 using memory 252.

Specifically, circuit 251 decodes, for each of faces forming a three-dimensional mesh, a connection type regarding a connection relationship between the face to be processed and a face not yet processed, in reverse order of processing order in which the connection type is defined (S2301). Here, a plurality of examples of connection types regarding a connection relationship between the face to be processed and a face not yet processed may include a type in which the face to be processed is not connected to the face not yet processed (for example, type E described above).

Moreover, circuit 251 decodes relevant information for detecting a border of a connected component in a plurality of connection types each of which is decoded as the connection type in the reverse order (S2302). Here, the connected component corresponds to at least a portion of the three-dimensional mesh. The relevant information may be decoded before decoding the plurality of connection types or may be decoded while decoding the plurality of connection types.

As a result, it may be possible to appropriately detect the border of the connected component in the plurality of connection types decoded in the reverse order. Accordingly, it may be possible to efficiently identify the connected component and a connection relationship among the plurality of faces. In consequence, it may be possible to reduce processing delay in reconstructing the three-dimensional mesh.

For example, the relevant information may indicate whether a current connection type corresponds to an end of the connected component in the processing order, the current connection type being the connection type to be decoded. As a result, it may be possible to appropriately detect the connection type corresponding to the end of the connected component in the plurality of connection types decoded in the reverse order. Accordingly, it may be possible to efficiently identify the connected component and the connection relationship among the plurality of faces.

Furthermore, for example, circuit 251 may determine whether a condition that the current connection type is capable of corresponding to the end is satisfied. When circuit 251 determines that the condition is satisfied, circuit 251 may decode the relevant information. As a result, when the current connection type is not capable of corresponding to the end of the connected component, it may be possible to omit the decoding of the relevant information. Accordingly, it may be possible to suppress the increase in coding amount.

Moreover, for example, the condition may include a condition that the current connection type is an end type. Here, the end type is a type in which, along a path to the face to be processed in the processing order, a face not yet processed is connected to neither a left side nor a right side of the face to be processed. As a result, when the current connection type is not the end type, it may be possible to omit the decoding of the relevant information. Accordingly, it may be possible to suppress the increase in coding amount.

Furthermore, for example, the condition may include a condition that a stack on which push or pop is performed according to the connection type is empty. As a result, when the stack is not empty, it may be possible to omit the decoding of the relevant information. Accordingly, it may be possible to suppress the increase in coding amount.

Moreover, for example, the condition may include a condition that the connection type of a face at an end of at least one connected component is not decoded, the at least one connected component being included in one or more connected components each of which is defined as the connected component. As a result, when the connection type of the face at the end is already decoded for each of the connected components, it may be possible to omit the decoding of the relevant information. Accordingly, it may be possible to suppress the increase in coding amount.

Furthermore, for example, the relevant information may indicate a total number of connection types that is a total number of one or more connection types each of which is decoded for a corresponding one of one or more connected components each of which is defined as the connected component. As a result, it may be possible to efficiently identify each connected component according to the number of connection types, and identify the connection relationship among the plurality of faces. In consequence, it may be possible to reduce processing delay in reconstructing the three-dimensional mesh.

Moreover, for example, the border may be indicated by the total number of the connection types indicated by the relevant information, and a total number of one or more connection types decoded. More specifically, for example, when the number of the connection types indicated by the relevant information matches the number of the one or more connection types decoded, the decoding processing is assumed to have reached the border of the connected component. In other words, the border of the connected component may be indicted by the match between the number of the connection types indicated by the relevant information and the number of the one or more connection types decoded.

As a result, it may be possible to appropriately indicate the border of the connected component in the plurality of connection types decoded in the reverse order, according to a relationship between the number of the connection types indicated by the relevant information and the number of the one or more connection types decoded. Accordingly, it may be possible to efficiently identify each connected component and the connection relationship among the plurality of faces.

The above relevant information may be defined as information pertaining to the identification of the border of the connected component. The relevant information may correspond to end_of_connected_component[i] or num_clers_symbol[i].

Although circuit 251 of decoding device 200 performs each process in the above description, connection information decoder 202 or 245 of decoding device 200 may perform the process or another constituent element may perform the process.

In the above description, “connection” may be expressed as “link”. Furthermore, “connection type” may be expressed as “connection information” or “link information”.

### Other Examples

Although the aspects of encoding device 100 and decoding device 200 have thus far been described according to the embodiment, the aspects of encoding device 100 and decoding device 200 are not limited to the embodiment. Modifications that may be conceived by a person skilled in the art may be applied to the embodiment, and a plurality of constituent elements in the embodiment may be combined in any manner.

For example, processing performed by a specific constituent element in the embodiment may be performed by a different constituent element instead of the specific constituent element. Moreover, the order of processes may be changed or processes may be performed in parallel.

Moreover, as stated above, it is possible to implement, as an integrated circuit, at least part of the plurality of constituent elements in the present disclosure. At least part of the processes in the present disclosure may be used as an encoding method or a decoding method. A program for causing a computer to execute the encoding method or the decoding method may be used. Furthermore, a non-transitory computer-readable recording medium on which the program is recorded may be used. In addition, a bitstream for causing decoding device 200 to perform decoding may be used.

Moreover, at least part of the plurality of constituent elements and the processes in the present disclosure may be used as a transmitting device, a receiving device, a transmitting method, and a receiving method. A program for causing a computer to execute the transmitting method or the receiving method may be used. Furthermore, a non-transitory computer-readable recording medium on which the program is recorded may be used.

Moreover, for example, the expression “at least one (or one or more) of a first element, a second element, or a third element” corresponds to the first element, the second element, and the third element or any combination of these elements.

Furthermore, in the present disclosure, setting the first element to a first value can mean setting a value of an element to the first value. Additionally, the expression “setting the first element to the first value” may be replaced with the expression “setting the first value to the first element”.

### INDUSTRIAL APPLICABILITY

The present disclosure is useful in, for example, an encoding device, a decoding device, a transmitting device, a receiving device, and the like related to a three-dimensional mesh and can be applied to a computer graphics system, a three-dimensional data display system, and the like.

1. An encoding device comprising:
memory; and
a circuit having access to the memory,
wherein in operation, the circuit:
for each of faces forming a three-dimensional mesh, encodes a connection type regarding a connection relationship between the face to be processed and a face not yet processed, in reverse order of processing order in which the connection type is defined; and
encodes relevant information for detecting a border of a connected component in a plurality of connection types each of which is encoded as the connection type in the reverse order, and
the connected component corresponds to at least a portion of the three-dimensional mesh.

2. The encoding device according to claim 1,
wherein the relevant information indicates whether a current connection type corresponds to an end of the connected component in the processing order, the current connection type being the connection type to be encoded.

3. The encoding device according to claim 2,
wherein the circuit:
determines whether a condition that the current connection type is capable of corresponding to the end is satisfied; and
encodes the relevant information when the condition is determined to be satisfied.

4. The encoding device according to claim 3,
wherein the condition includes a condition that the current connection type is an end type, and
the end type is a type in which, along a path to the face to be processed in the processing order, a face not yet processed is connected to neither a left side nor a right side of the face to be processed.

5. The encoding device according to claim 3,
wherein the condition includes a condition that a stack on which push or pop is performed according to the connection type is empty.

6. The encoding device according to claim 3,
wherein the condition includes a condition that the connection type of a face at an end of at least one connected component is not encoded, the at least one connected component being included in one or more connected components each of which is defined as the connected component.

7. The encoding device according to claim 1,
wherein the relevant information indicates a total number of connection types that is a total number of one or more connection types each of which is encoded for a corresponding one of one or more connected components each of which is defined as the connected component.

8. The encoding device according to claim 7,
wherein the border is indicated according to the total number of the connection types indicated by the relevant information, and a total number of one or more connection types encoded.

9. A decoding device comprising:
memory; and
a circuit having access to the memory,
wherein in operation, the circuit:
for each of faces forming a three-dimensional mesh, decodes a connection type regarding a connection relationship between the face to be processed and a face not yet processed, in reverse order of processing order in which the connection type is defined; and
decodes relevant information for detecting a border of a connected component in a plurality of connection types each of which is decoded as the connection type in the reverse order, and
the connected component corresponds to at least a portion of the three-dimensional mesh.

10. The decoding device according to claim 9,
wherein the relevant information indicates whether a current connection type corresponds to an end of the connected component in the processing order, the current connection type being the connection type to be decoded.

11. The decoding device according to claim 10,
wherein the circuit:
determines whether a condition that the current connection type is capable of corresponding to the end is satisfied; and
decodes the relevant information when the condition is determined to be satisfied.

12. The decoding device according to claim 11,
wherein the condition includes a condition that the current connection type is an end type, and
the end type is a type in which, along a path to the face to be processed in the processing order, a face not yet processed is connected to neither a left side nor a right side of the face to be processed.

13. The decoding device according to claim 11,
wherein the condition includes a condition that a stack on which push or pop is performed according to the connection type is empty.

14. The decoding device according to claim 11,
wherein the condition includes a condition that the connection type of a face at an end of at least one connected component is not decoded, the at least one connected component being included in one or more connected components each of which is defined as the connected component.

15. The decoding device according to claim 9,
wherein the relevant information indicates a total number of connection types that is a total number of one or more connection types each of which is decoded for a corresponding one of one or more connected components each of which is defined as the connected component.

16. The decoding device according to claim 15,
wherein the border is indicated according to the total number of the connection types indicated by the relevant information, and a total number of one or more connection types decoded.

17. An encoding method comprising:
for each of faces forming a three-dimensional mesh, encoding a connection type regarding a connection relationship between the face to be processed and a face not yet processed, in reverse order of processing order in which the connection type is defined; and
encoding relevant information for detecting a border of a connected component in a plurality of connection types each of which is encoded as the connection type in the reverse order,
wherein the connected component corresponds to at least a portion of the three-dimensional mesh.

18. A decoding method comprising:
for each of faces forming a three-dimensional mesh, decoding a connection type regarding a connection relationship between the face to be processed and a face not yet processed, in reverse order of processing order in which the connection type is defined; and
decoding relevant information for detecting a border of a connected component in a plurality of connection types each of which is decoded as the connection type in the reverse order,
wherein the connected component corresponds to at least a portion of the three-dimensional mesh.
